(19) United States
(12) Patent Application Publication
(10) Pub. No.: US 2025/0089924 A1
(43) Pub. Date: Mar. 20, 2025

(54) COOKING DEVICE FOR MAINTAINING HEAT RETENTION, METHOD FOR MAINTAINING HEAT RETENTION IN COOKING DEVICE, AND WIRELESS POWER TRANSMISSION DEVICE

(71) Applicant: SAMSUNG ELECTRONICS CO., LTD., Suwon-si (KR)

(72) Inventors: Jaejin KIM, Suwon-si (KR); Kanghoon KIM, Suwon-si (KR); Heejun KANG, Suwon-si (KR); Yongwook KIM, Suwon-si (KR); Sojeong YU, Suwon-si (KR); Jiwoong CHOI, Suwon-si (KR)

(73) Assignee: SAMSUNG ELECTRONICS CO., LTD., Suwon-si (KR)

(21) Appl. No.: 18/956,684

(22) Filed: Nov. 22, 2024

Related U.S. Application Data
(63) Continuation of application No. PCT/KR2023/004457, filed on Apr. 3, 2023.

(30) Foreign Application Priority Data
May 27, 2022 (KR) 10-2022-0065643
Oct. 26, 2022 (KR) 10-2022-0139676

(51) Int. Cl. A47J 27/21; H05B 6/06; H05B 6/12

(52) U.S. Cl. CPC A47J 27/21158; H05B 6/062; H05B 6/1236

(57) ABSTRACT

Provided is a cooking appliance configured to maintain heat retention of contents. The cooking appliance is configured to, when entering a heat retention mode, compare a temperature of the contents measured via a temperature sensor with a target heat retention temperature, and when the temperature of the contents is equal to or greater than the target heat retention temperature, transmit power control information to a wireless power transmission device, the power control information indicating to suspend transmission of first power and then to re-transmit the first power after an elapse of a preset time.

### CROSS-REFERENCE TO RELATED APPLICATIONS

This application is a by-pass continuation of International Application No. PCT/KR2023/004457, filed on Apr. 3, 2023, which is based on and claims priority to Korean Patent Application No. 10-2022-0065643, filed in the Korean Intellectual Property Office on May 27, 2022, and Korean Patent Application No. 10-2022-0139676, filed in the Korean Intellectual Property Office on Oct. 26, 2022, the disclosures of which are incorporated by reference herein in their entireties.

### BACKGROUND

### 1. Field

The present disclosure relates to a cooking appliance for maintaining heat retention of contents, a method of maintaining heat retention in the cooking appliance, and a wireless power transmission device capable of transmitting power to the cooking appliance.

### 2. Description of Related Art

Induction ranges are heating appliances for cooking using the principle of induction heating and are often called induction stoves. Compared to gas ranges, induction ranges do not consume oxygen and do not emit waste gas, and thus, indoor air pollution and an increase in indoor temperature may be reduced. In addition, induction ranges use an indirect heating method of inducing a to-be-heated object to generate heat by itself, and have high energy efficiency and stability. Because a contact surface is not heated even though the to-be-heated object generates heat by itself, the risk of burns is low, and accordingly, the demand for induction ranges has recently increased. Due to an increase in the supply of induction ranges, the development of cooking appliances usable in induction ranges has increased.

### SUMMARY

According to an aspect of the disclosure, a cooking appliance configured to maintain heat retention of contents includes: a wireless power receiver configured to receive power transmitted from a wireless power transmission device; a communication interface configured to communicate with the wireless power transmission device; a first temperature sensor configured to measure a temperature of the contents; at least one memory storing one or more instructions; and at least one processor configured to execute the one or more instructions, wherein the one or more instructions, when executed by the at least one processor, cause the cooking appliance to: based on entering a heat retention mode, compare the temperature of the contents measured via the first temperature sensor with a target heat retention temperature, and based on the temperature of the contents being equal to or greater than the target heat retention temperature, cause power control information to be transmitted to the wireless power transmission device, wherein the power control information is configured to cause the wireless power transmission device to suspend transmission of first power for driving the communication interface and to resume transmission of the first power after a preset time elapses.

The one or more instructions, when executed by the at least one processor, may cause the cooking appliance to: receive heat retention request information from the wireless power transmission device via the communication interface, wherein the heat retention request information may indicate that a heat retention request has been received from a user, enter the heat retention mode based on the received heat retention request information, and store, in the at least one memory, information indicating that an operation mode of the cooking appliance is the heat retention mode.

The one or more instructions, when executed by the at least one processor, may cause the cooking appliance to: determine a first communication interval, for communication with the wireless power transmission device, based on at least one of an amount of the contents and the target heat retention temperature, and transmit first power control information to the wireless power transmission device via the communication interface, wherein the first power control information causes the wireless power transmission device to suspend transmission of the first power and to resume transmission of the first power in a first wake-up time corresponding to the first communication interval.

The one or more instructions, when executed by the at least one processor, may cause the cooking appliance to: determine the first communication interval to be a first duration when the target heat retention temperature increases, and determine the first communication interval to be a second duration when the target heat retention temperature decreases, wherein the first duration may be less than the second duration.

The one or more instructions, when executed by the at least one processor, may cause the cooking appliance to: determine the first communication interval to be a first duration when the amount of the contents increases, and determine the first communication interval to be a second duration when the amount of the contents decreases, wherein the first duration may be greater than the second duration.

The one or more instructions, when executed by the at least one processor, may cause the cooking appliance to: identify the amount of the contents, based on a temperature variation rate when the contents are heated.

The one or more instructions, when executed by the at least one processor, may cause the cooking appliance to: determine a pan detection interval for checking whether the cooking appliance is located on a top plate of the wireless power transmission device while transmission of the first power is suspended, wherein the power control information may include the pan detection interval.

The one or more instructions, when executed by the at least one processor, may cause the cooking appliance to: transmit, to the wireless power transmission device, information about the temperature of the contents obtained via the first temperature sensor while the communication interface is driven.

The one or more instructions, when executed by the at least one processor, may cause the cooking appliance to: based on the first power being received from the wireless power transmission device in the first wake-up time, advertise variable identification information of the cooking appliance and unique identification information of the cooking appliance via the communication interface, wherein the variable identification information of the cooking appliance includes product type information of the cooking appliance and information indicating that a cooking zone in which the cooking appliance is currently located is unknown.

The one or more instructions, when executed by the at least one processor, may cause the cooking appliance to: after advertising the variable identification information of the cooking appliance and the unique identification information of the cooking appliance, identify a first power transmission pattern from among a plurality of different power transmission patterns transmitted from the wireless power transmission device via a plurality of cooking zones, determine a first cooking zone as a current location of the cooking appliance, wherein the first cooking zone corresponds to the first power transmission pattern, modify the variable identification information of the cooking appliance so as to include information about the first cooking zone, and transmit the modified variable identification information and the unique identification information of the cooking appliance to the wireless power transmission device via the communication interface.

The one or more instructions, when executed by the at least one processor, may cause the cooking appliance to: based on the first power being received from the wireless power transmission device, compare a first temperature of the contents with the target heat retention temperature, wherein the first temperature is measured by the first temperature sensor during the first wake-up time, and based on the first temperature being less than the target heat retention temperature, control the wireless power transmission device to maintain transmission of the first power until a current temperature of the contents reaches the target heat retention temperature.

The one or more instructions, when executed by the at least one processor, may cause the cooking appliance to: determine a power level value of the first power based on a difference between a first temperature of the contents and the target heat retention temperature, wherein the first temperature is measured by the first temperature sensor during the first wake-up time, and control the wireless power transmission device to maintain transmission of the first power, by transmitting second power control information including the power level value to the wireless power transmission device.

The one or more instructions, when executed by the at least one processor, may cause the cooking appliance to: determine a second communication interval for communication with the wireless power transmission device, based on the amount of the contents, the target heat retention temperature, and a difference between a first temperature of the contents and the target heat retention temperature, and transmit second power control information to the wireless power transmission device via the communication interface, wherein the second power control information causes the wireless power transmission device to suspend transmission of the first power when a current temperature of the contents reaches the target heat retention temperature and to resume transmission of the first power in a second wake-up time corresponding to the second communication interval.

The one or more instructions, when executed by the at least one processor, may cause the cooking appliance to: based on the first power being received from the wireless power transmission device in the first wake-up time, compare a first temperature of the contents with the target heat retention temperature, wherein the first temperature is measured by the first temperature sensor during the first wake-up time, adjust the pan detection interval based on a result of the comparison between the first temperature and the target heat retention temperature, and after an elapse of a preset time from the first wake-up time, transmit second power control information to the wireless power transmission device via the communication interface, wherein the second power control information may include the adjusted pan detection interval and a second wake-up time for re-transmission of the first power.

The one or more instructions, when executed by the at least one processor, may cause the cooking appliance to: based on a heat retention end condition being satisfied, receive information from the wireless power transmission device via the communication interface indicating to end the heat retention mode, and based on receiving the information indicating to end the heat retention mode, end the heat retention mode by deleting, from the at least one memory, the information indicating that the operation mode of the cooking appliance is the heat retention mode.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a diagram for describing a cooking system according to an embodiment of the present disclosure;

FIG. 2A is a diagram for describing a product type of a cooking appliance according to an embodiment of the present disclosure;

FIG. 2B is a diagram for describing a product type of a cooking appliance according to an embodiment of the present disclosure;

FIG. 3 is a block diagram for describing a function of a cooking appliance, according to an embodiment of the present disclosure;

FIG. 4A is a diagram for describing a structure of a kettle as an example of a cooking appliance;

FIG. 4B is a diagram for describing a structure of a smart pot as an example of a cooking appliance;

FIG. 5 is a block diagram for describing functions of a wireless power transmission device, according to an embodiment of the present disclosure;

FIG. 6A is a block diagram for describing functions of a wireless power transmission device, according to an embodiment of the present disclosure;

FIG. 6B is a diagram for describing a wireless power transmitter of a wireless power transmission device, according to an embodiment of the present disclosure:

FIG. 7 is a diagram for describing a smart table as an example of a wireless power transmission device:

FIG. 8 is a diagram for describing an operation of a wireless power transmission device in a case where a cooking appliance is placed on the wireless power transmission device, according to an embodiment of the present disclosure;

FIG. 9 is a flowchart for describing a method of maintaining heat retention, by a cooking appliance, according to an embodiment of the present disclosure;

FIG. 10 is a flowchart for describing a method by which a cooking appliance determines a communication interval, based on an amount of contents, according to an embodiment of the present disclosure;

FIG. 11 is a flowchart for describing a method by which a cooking appliance determines a communication interval, based on an amount of contents, according to an embodiment of the present disclosure;

FIG. 12 is a flowchart for describing a method by which cooking appliance determines a communication interval, based on a target heat retention temperature, according to an embodiment of the present disclosure;

FIG. 13A is a diagram for describing an operation in which a cooking appliance determines a communication interval, based on a target heat retention temperature, according to an embodiment of the present disclosure;

FIG. 13B is a diagram for describing an operation in which a cooking appliance determines a communication interval, based on a target heat retention temperature, according to an embodiment of the present disclosure;

FIG. 14 is a diagram for describing variation in a communication duration section, according to an embodiment of the present disclosure;

FIG. 15 is a flowchart for describing a method, performed by a cooking appliance, of adaptively controlling transmission of first power, based on a result of comparison between a temperature of contents and a target heat retention temperature, according to an embodiment of the present disclosure;

FIG. 16 is a diagram for describing temperature variation of contents while a cooking appliance operates in a heat retention mode, according to an embodiment of the present disclosure:

FIG. 17 is a flowchart for describing a method, performed by a cooking appliance, of determining a next communication interval, based on a difference between a temperature of contents in wake up and a target heat retention temperature, according to an embodiment of the present disclosure;

FIG. 18 is a diagram for describing an operation in which a cooking appliance determines a next communication interval, based on a difference between a temperature of contents in wake up and a target heat retention temperature, according to an embodiment of the present disclosure;

FIG. 19 is a flowchart for describing a method, performed by a cooking appliance, of determining a power level value, based on a difference between a temperature of contents in wake up and a target heat retention temperature, according to an embodiment of the present disclosure:

FIG. 20 is a flowchart for describing an operation in which a cooking determines a power level value, based on a difference between a temperature of contents in wake up and a target heat retention temperature, according to an embodiment of the present disclosure;

FIG. 21 is a flowchart for describing a method, performed by a cooking appliance, of adjusting a pan detection interval, based on a difference between a temperature of contents in wake up and a target heat retention temperature, according to an embodiment of the present disclosure;

FIG. 22 is a diagram for describing a pan detection interval and a power level value, according to an embodiment of the present disclosure;

FIG. 23 is a diagram for describing an operation in which a wireless power transmission device transmits power equal to or less than a threshold power level, according to an embodiment of the present disclosure;

FIG. 24 is a flowchart for describing a method, performed by a wireless power transmission device, of performing a heat retention mode, based on unique identification information of a cooking appliance, according to an embodiment of the present disclosure;

FIG. 25 is a diagram for describing a communication re-connection operation between a cooking appliance and a wireless power transmission device, according to an embodiment of the present disclosure;

FIG. 26 is a diagram for describing a communication re-connection operation between a cooking appliance and a wireless power transmission device, according to an embodiment of the present disclosure;

FIG. 27 is a diagram for describing a communication re-connection operation between a cooking appliance and a wireless power transmission device, according to an embodiment of the present disclosure;

FIG. 28 is a flowchart for describing a method by which a cooking appliance ends a heat retention mode, according to an embodiment of the present disclosure;

FIG. 29 is a diagram for describing an operation of identifying an empty heating state, according to an embodiment of the present disclosure;

FIG. 30 is a diagram for describing an operation performed when a cooking appliance operating in a heat retention mode is removed from a top plate of a wireless power transmission device, according to an embodiment of the present disclosure;

FIG. 31 is a flowchart for describing an operation of a cooking appliance in a case where the cooking appliance is placed on a wireless power transmission device, according to an embodiment of the present disclosure;

FIG. 32 is a diagram for describing an operation of a wireless power transmission device in a case where, after a cooking appliance is removed from the wireless power transmission device, the cooking appliance is placed again on the wireless power transmission device within a preset time, according to an embodiment of the present disclosure;

FIG. 33 is a flowchart for describing a method by which a wireless power transmission device adjusts power transmission to a cooking appliance by determining a communication interval, according to an embodiment of the present disclosure;

FIG. 34 is a flowchart for describing a method by which a wireless power transmission device adjusts power transmission to a cooking appliance including a battery, based on a temperature of contents and a target heat retention temperature, according to an embodiment of the present disclosure;

FIG. 35 is a flowchart for describing a method by which a cooking appliance adjusts power supply to a heater, according to an embodiment of the present disclosure;

FIG. 36 is a diagram for describing an operation in which a wireless power transmission device outputs information related to a cooking appliance, according to an embodiment of the present disclosure;

FIG. 37 is a diagram for describing an operation in which a cooking appliance and a wireless power transmission device interoperate with a server device, according to an embodiment of the present disclosure; and

FIG. 38 is a diagram for describing an operation in which a server device provides information about a cooking appliance via a user terminal, according to an embodiment of the present disclosure.

### DETAILED DESCRIPTION

The terms used in the present disclosure will be briefly defined, and an embodiment of the present disclosure will be described in detail.

All terms including descriptive or technical terms which are used in the present disclosure should be construed as having meanings that are understood by one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Therefore, the terms used in the present disclosure should not be interpreted based on only their names but have to be defined based on the meaning of the terms together with the descriptions throughout the specification.

Throughout the present disclosure, the expression “at least one of a, b or c” indicates only a, only b, only c, both a and b, both a and c, both b and c, all of a, b, and c, or variations thereof.

Throughout the present disclosure, when a part “includes” or “comprises” an element, unless there is a particular description contrary thereto, the part may further include other components, not excluding the other components. As used in the present disclosure, the term “unit” or “module” denotes an entity for performing at least one function or operation, and may be implemented as hardware, software, or a combination of hardware and software.

Hereinafter, the present disclosure will now be described more fully with reference to the accompanying drawings for one of ordinary skill in the art to be able to perform an embodiment of the present disclosure without difficulty. The present disclosure may, however, be embodied in many different forms and should not be construed as being limited to an embodiment of the present disclosure set forth herein. In the drawings, parts not related to an embodiment of the present disclosure are not illustrated for clarity of explanation, and like reference numerals denote like components throughout the present disclosure.

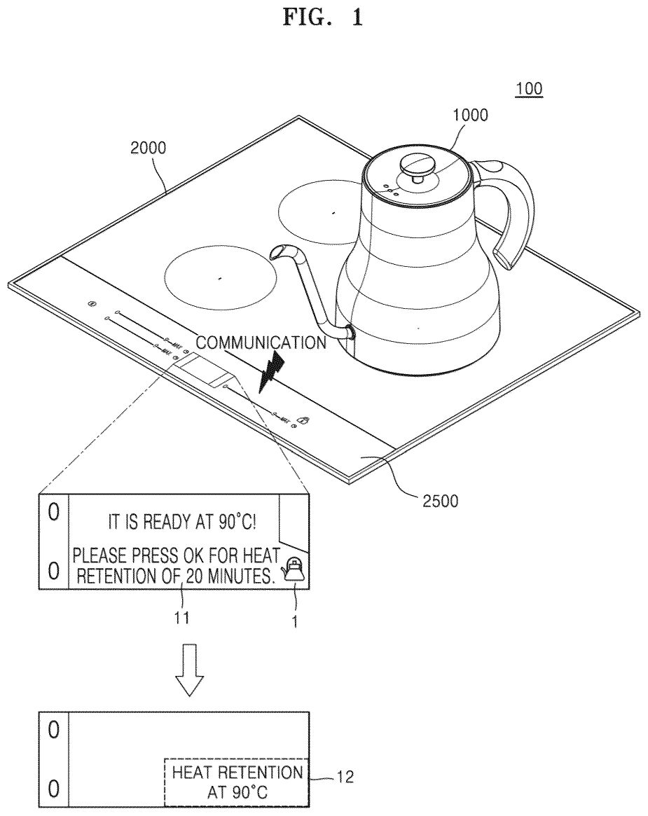

FIG. 1 is a diagram for describing a cooking system 100 according to an embodiment of the present disclosure.

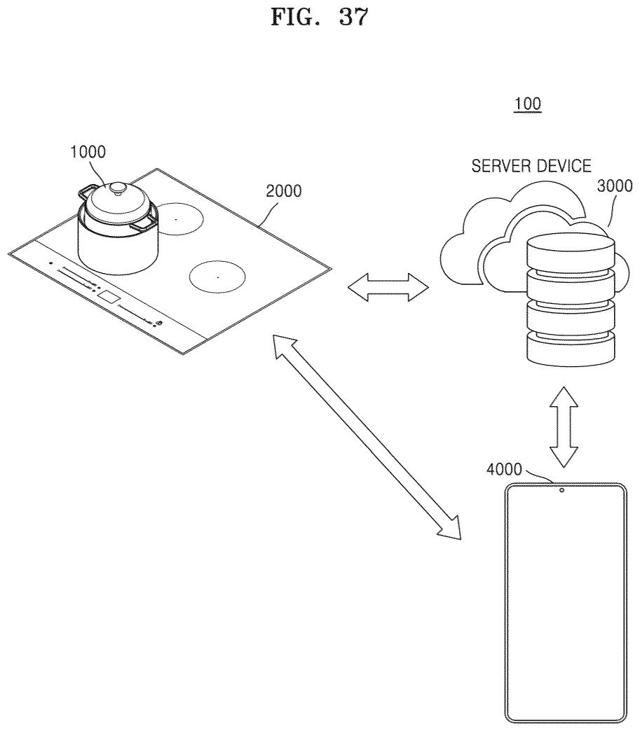

Referring to FIG. 1, the cooking system 100 according to an embodiment of the present disclosure may include a wireless power reception device (e.g., a cooking appliance 1000) and a wireless power transmission device 2000. However, not all the components shown in FIG. 1 are essential components. The cooking system 100 may be implemented by more components than the components shown in FIG. 1, or may be implemented by fewer components. For example, the cooking system 100 may be implemented with the wireless power reception device (e.g., the cooking appliance 1000), the wireless power transmission device 2000, and a server device. An embodiment in which the cooking system 100 includes the server device will be described below in detail with reference to FIG. 37. Hereinafter, each configuration of the cooking system 100 will now be described.

The wireless power reception device may be a device for heating up contents. The contents may include liquids, such as water, tea, coffee, soup, juice, wine, and oil, or may include solids, such as butter, meat, vegetables, bread, and rice, but the present disclosure is not limited thereto.

According to an embodiment of the present disclosure, the wireless power reception device may wirelessly receive power from the wireless power transmission device 2000 by using electromagnetic induction. Therefore, according to an embodiment of the disclosure, the wireless power reception device (e.g., the cooking appliance 1000) may not include a power line connected to a power outlet.

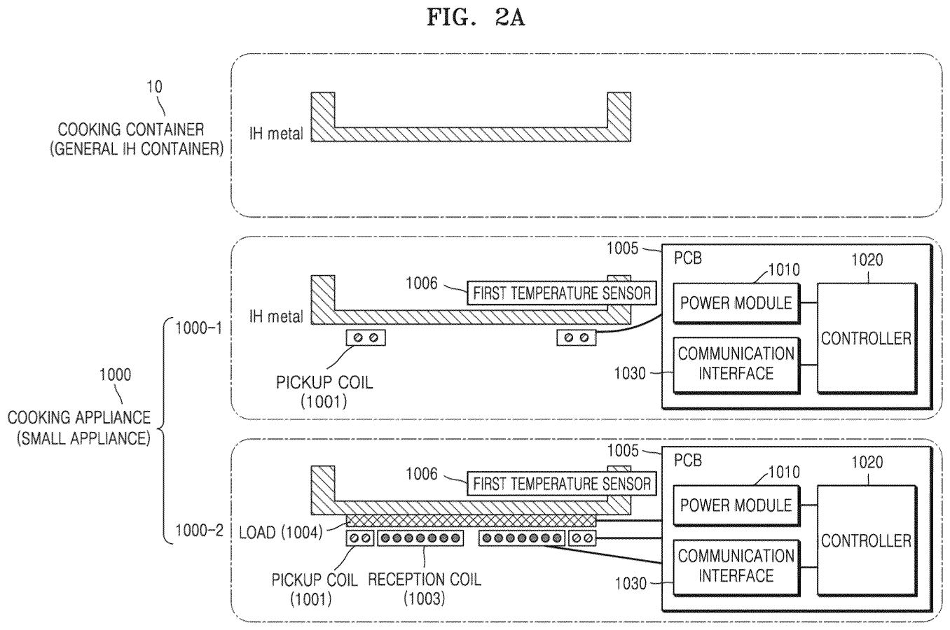

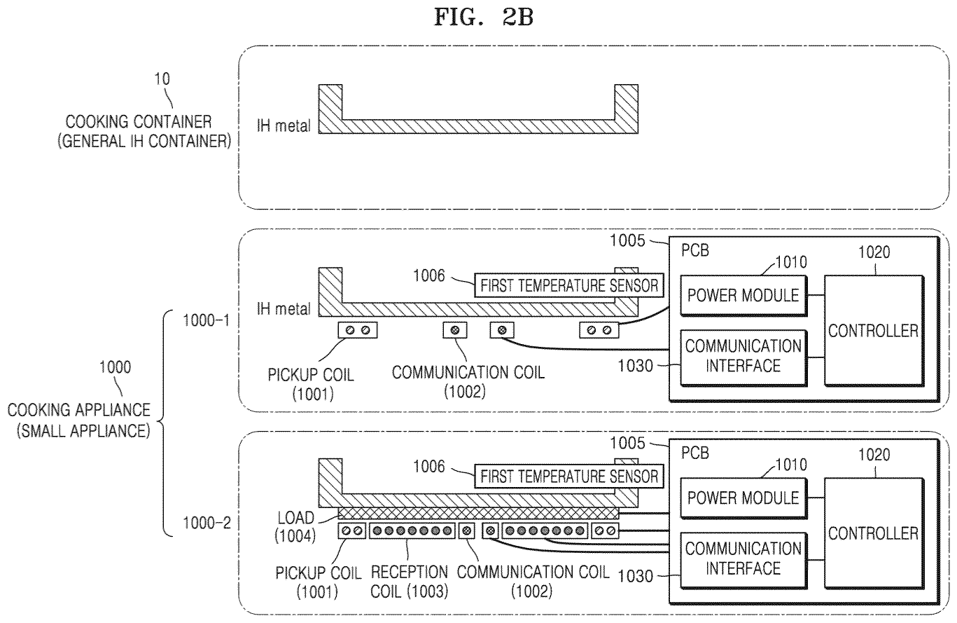

According to an embodiment of the present disclosure, there may be various types of wireless power reception devices that wirelessly receive power from the wireless power transmission device 2000. The wireless power reception device may include a general induction-heating (IH) container (the general IH container) (see FIG. 2A) including a magnetic material, or may include the cooking appliance 1000 including a communication interface. Hereinafter, the cooking appliance 1000 including the communication interface may be defined as a small appliance. According to an embodiment of the present disclosure, the cooking appliance 1000 may include a first type of cooking appliance including a magnetic material (IH metal) (e.g., an iron component), and a second type of cooking appliance including a reception coil. In the first type of cooking appliance, a magnetic field may be induced in a container (IH metal) itself, and in the second type of cooking appliance, a magnetic field may be induced in the reception coil. Types of the wireless power reception device will be further described below with reference to FIGS. 2A and 2B.

The wireless power reception device may include a general IH container, such as a pot, a frying pan, and a steamer, or may include a small appliance, such as an electric kettle, a teapot, a coffee maker (or coffee dripper), a toaster, a blender, an electric rice cooker, an oven, and an air fryer, but the present disclosure is not limited thereto. The wireless power reception device may include a cooker device. The cooker device may be a device into or from which a general IH container may be inserted or detached. According to an embodiment, the cooker device may be a device capable of automatically cooking contents according to a recipe. The cooker device may also be referred to as a pot, a rice cooker, or a steamer depending on an intended use thereof. For example, when an inner pot capable of cooking rice is inserted into the cooker device, the cooker device may be referred to as a rice cooker. Hereinafter, the cooker device may be defined as a smart pot.

According to an embodiment of the present disclosure, the cooking appliance 1000 may communicate with the wireless power transmission device 2000 via a communication interface. According to an embodiment of the present disclosure, when the cooking appliance 1000 is a small appliance including a communication interface, the cooking appliance 1000 may communicate with the wireless power transmission device 2000. The cooking appliance 1000 may be connected to the wireless power transmission device 2000, a mobile terminal, or the server device via a network. The network may include a local area network (LAN) established around a wide area network (WAN) such as Internet, and an access point (AP), and a wireless personal area network (WPAN) without accessing the AP. The WPAN may include Bluetooth™ (IEEE 802.15.1), Zigbee (IEEE 802.15.4), Wi-Fi Direct, near field communication (NFC), Z-Wave, etc. but the present disclosure is not limited thereto.

The AP may connect a LAN to which the cooking appliance 1000, the wireless power transmission device 2000, or a mobile terminal is connected to a WAN to which a server device is connected. The cooking appliance 1000, the wireless power transmission device 2000, or the mobile terminal may be connected to the server device via the WAN. The AP may communicate with the cooking appliance 1000, the wireless power transmission device 2000, or the mobile terminal by using wireless communication such as Wi-Fi™ (IEEE 802.11), etc., and may access the WAN by using wired communication.

The cooking appliance 1000 according to an embodiment of the present disclosure may transmit unique identification information and variable identification information of the cooking appliance 1000 to the wireless power transmission device 2000 via the communication interface. The unique identification information of the cooking appliance 1000 is unique information for identifying the cooking appliance 1000, and may include at least one of a MAC address, a model type, device type information (e.g., an IH type ID, a heater type ID, a motor type ID, or a small appliance type ID), manufacturer information (e.g., manufacturer ID), a serial number, and manufacture time information (year/month/day of the manufacture), but the present disclosure is not limited thereto. According to an embodiment of the present disclosure, the unique identification information of the cooking appliance 1000 may be expressed as identification numbers or a combination of numbers and alphabet letters. The variable identification information of the cooking appliance 1000 is information that varies according to a state of the cooking appliance 1000, and for example, may include information indicating a registration state of the cooking appliance 1000, location information of the cooking appliance 1000, product type information of the cooking appliance 1000, but the present disclosure is not limited thereto. The location information of the cooking appliance 1000 may include information of a cooking zone (also referred to as a burner) in which the cooking appliance 1000 is located. According to an embodiment of the present disclosure, the variable identification information of the cooking appliance 1000 may be expressed as identification numbers or a combination of numbers and alphabet letters. The variable identification information of the cooking appliance 1000 may be included in the form of a universally unique identifier (UUID) in an advertising packet.

According to an embodiment of the present disclosure, the cooking appliance 1000 may store recipe information for cooking contents. The recipe information may be different according to the type of the cooking appliance 1000 and may include a list of a plurality of recipes. For example, when the cooking appliance 1000 is a coffee maker, the recipe information may include a list of coffee bean recipes, when the cooking appliance 1000 is a smart pot, the recipe information may include a list of food recipes, and when the cooking appliance 1000 is a blender, the recipe information may include a list of beverage recipes.

According to an embodiment of the present disclosure, the wireless power transmission device 2000 may be a device that wirelessly transmits power to the wireless power reception device (e.g., the cooking appliance 1000) located on a top plate by using electromagnetic induction. The wireless power transmission device 2000 may also be expressed as an induction heating apparatus, an induction range, a cooktop, or an electric range. The wireless power transmission device 2000 may include a working coil that generates a magnetic field for inductively heating the cooking appliance 1000. When the cooking appliance 1000 is the second type of cooking appliance including the reception coil, the working coil may also be referred to as a transmission coil.

When power is wirelessly transmitted, it may mean that power is transmitted by using a magnetic field induced in a reception coil or an IH metal (e.g., an iron component) in a magnetic induction method. For example, the wireless power transmission device 2000 may cause a current to flow in the working coil (transmission coil) to form a magnetic field, and thus may generate an eddy current in the cooking appliance 1000 or induce a magnetic field in the reception coil of the cooking appliance 1000.

According to an embodiment of the present disclosure, the wireless power transmission device 2000 may include a plurality of working coils. For example, when the top plate of the wireless power transmission device 2000 includes a plurality of cooking zones, the wireless power transmission device 2000 may include a plurality of working coils respectively corresponding to the plurality of cooking zones. Also, the wireless power transmission device 2000 may include a high-power cooking zone in which a first working coil is provided inside thereof and a second working coil is provided outside thereof. The high-power cooking zone may include three or more working coils.

According to an embodiment of the present disclosure, the top plate of the wireless power transmission device 2000 may include tempered glass, such as ceramic glass, such that the top plate is not easily damaged. Also, a guide mark may be provided on the top plate of the wireless power transmission device 2000 to guide a cooking zone in which the cooking appliance 1000 needs to be located.

According to an embodiment of the present disclosure, the wireless power transmission device 2000 may detect that the wireless power reception device (e.g., the general IH container, the first type of cooking appliance) including the magnetic material is placed on the top plate. For example, based on a change in a current value (inductance) of the working coil due to approach of the wireless power reception device, the wireless power transmission device 2000 may detect that the wireless power reception device is located on the top plate of the wireless power transmission device 2000. Hereinafter, a mode in which the wireless power transmission device 2000 detects the wireless power reception device including the magnetic material (IH metal) is defined as an “IH container detection mode (pan detection mode)”.

According to an embodiment of the present disclosure, the wireless power transmission device 2000 may include a communication interface for communicating with an external apparatus. For example, the wireless power transmission device 2000 may communicate with the cooking appliance 1000 or the server device via the communication interface. The communication interface may include a short-range wireless communication interface (e.g., an NFC communication interface, a Bluetooth communication interface, a Bluetooth low energy (BLE) communication interface, etc.), a long-range wireless communication interface, etc.

According to an embodiment of the present disclosure, the wireless power transmission device 2000 may detect the cooking appliance 1000 located on the top plate via the communication interface. For example, the wireless power transmission device 2000 may detect the cooking appliance 1000 by receiving a packet transmitted from the cooking appliance 1000 located on the top plate by using short-range wireless communication (e.g., BLE or Bluetooth). As the cooking appliance 1000 including the communication interface may be defined as a small appliance (small object), hereinafter, a mode in which the wireless power transmission device 2000 detects the cooking appliance 1000 via the communication interface is defined as a “small appliance detection mode”. The wireless power transmission device 2000 may transmit power for activating the communication interface of the cooking appliance 1000 via the plurality of cooking zones in the small appliance detection mode.

According to an embodiment of the present disclosure, the wireless power transmission device 2000 may receive, from the cooking appliance 1000, the unique identification information (e.g., a MAC address) and the variable identification information of the cooking appliance 1000 via short-range wireless communication (e.g., BLE communication or Bluetooth communication) in the small appliance detection mode. In this regard, when the variable identification information of the cooking appliance 1000 includes information indicating that a current location is unknown, the wireless power transmission device 2000 outputs power according to different power transmission patterns for respective cooking zones, thereby allowing the cooking appliance 1000 to recognize a current location. Hereinafter, a mode in which the wireless power transmission device 2000 outputs power according to different power transmission patterns for the respective cooking zones may be defined as a “cooking zone determination mode”. When the wireless power transmission device 2000 operates in the cooking zone determination mode, the wireless power transmission device 2000 may receive information of a first cooking zone corresponding to a first power transmission pattern detected by the cooking appliance 1000 and variable identification information including product type information (e.g., a product type image, a product type text) of the cooking appliance 1000. In this case, the first cooking zone may be a cooking zone in which the cooking appliance 1000 is located, among the plurality of cooking zones included in the wireless power transmission device 2000. The product type information of the cooking appliance 1000 may be information indicating a product type of the cooking appliance 1000, and the product type may include a smart pot, a smart kettle, a coffee maker, a toaster, a blender, etc., but the present disclosure is not limited thereto.

When the wireless power transmission device 2000 receives the variable identification information including the location information of the cooking appliance 1000 and the product type information of the cooking appliance 1000, the wireless power transmission device 2000 may display the location information of the cooking appliance 1000 and the product type information of the cooking appliance 1000 on a user interface 2500, based on the variable identification information. For example, referring to FIG. 1, the wireless power transmission device 2000 may display a kettle icon 1 at a position of a display unit which corresponds to a right cooking zone, and thus, may provide a user with the product type information (e.g., kettle) of the cooking appliance 1000 and the location information (e.g., located in the right cooking zone) of the cooking appliance 1000. The user may identify the type and the location of the cooking appliance 1000 via the user interface 2500, and may input an operation with respect to the cooking appliance 1000. For example, the user may input a heat-up request of heating up contents in the cooking appliance 1000. The wireless power transmission device 2000 wirelessly supplies power corresponding to a heat-up operation to the cooking appliance 1000, thereby heating up contents in the cooking appliance 1000.

According to an embodiment of the present disclosure, the cooking appliance 1000 may support a heat retention function of maintaining a temperature of contents with a preset temperature by controlling power transmission of the wireless power transmission device 2000. For example, referring to FIG. 1, the user may input a heat retention request of maintaining a temperature of contents with a preset temperature (hereinafter, the target heat retention temperature) (e.g., 90° C.) after heating-up of the contents is completed. The wireless power transmission device 2000 may transmit, to the cooking appliance 1000, heat retention request information indicating that the heat retention request has been received from the user. The heat retention request information may include information about the target heat retention temperature, and information about a heat retention time set by the user, but the present disclosure is not limited thereto. When the cooking appliance 1000 receives the heat retention request information via the communication interface, the cooking appliance 1000 may monitor a temperature of the contents, and may compare the temperature of the contents with the target heat retention temperature. When the temperature of the contents is equal to or greater than the target heat retention temperature, the cooking appliance 1000 may transmit a control command indicating to suspend power transmission to the wireless power transmission device 2000 via the communication interface (e.g., the BLE communication interface). When the wireless power transmission device 2000 suspends power transmission to the cooking appliance 1000, in response to the control command, power supplied to the communication interface of the cooking appliance 1000 is suspended, and thus, a communication connection between the wireless power transmission device 2000 and the cooking appliance 1000 may be disconnected. Therefore, before the cooking appliance 1000 transmits the control command indicating to suspend power transmission to the wireless power transmission device 2000, the cooking appliance 1000 may previously determine an appropriate commutation interval, and may transmit power control information including a wake-up time corresponding to the determined commutation interval to the wireless power transmission device 2000. The wake-up time may indicate a time at which the communication interface of the cooking appliance 1000 is driven again (or wakes up), as the wireless power transmission device 2000 transmits again power to the cooking appliance 1000.

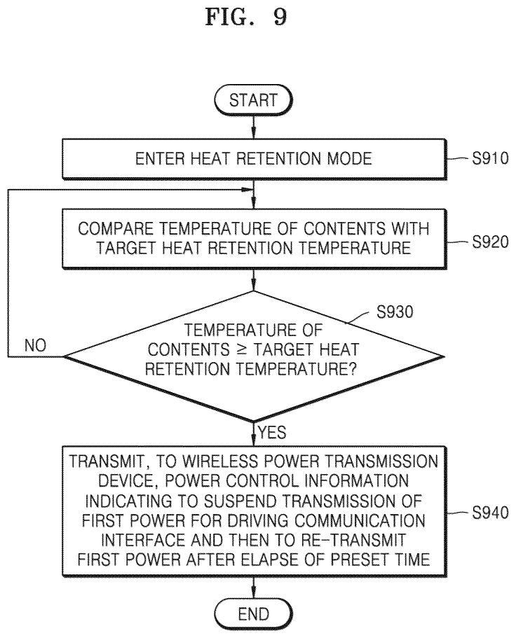

In order for the cooking appliance 1000 to continuously maintain the communication connection with the wireless power transmission device 2000, the cooking appliance 1000 needs to continuously receive power with preset level (e.g., 200 W) or higher from the wireless power transmission device 2000. In this case, as a temperature of contents in the cooking appliance 1000 continuously increases, the cooking appliance 1000 communicates with the wireless power transmission device 2000 with a preset interval during a heat retention mode. In this regard, when a communication interval between the cooking appliance 1000 and the wireless power transmission device 2000 decreases, an interval of power transmission from the wireless power transmission device 2000 decreases, and thus, a temperature of the contents may easily increase. On the other hand, when a communication interval between the cooking appliance 1000 and the wireless power transmission device 2000 increases, an interval of power transmission from the wireless power transmission device 2000 increases, and thus, a temperature of the contents may not easily increase. Therefore, the cooking appliance 1000 may adaptively adjust a communication interval by considering an amount of the contents, the target heat retention temperature, etc. so as to allow a temperature of the contents to be appropriately maintained around the target heat retention temperature. An operation in which the cooking appliance 1000 adjusts a communication interval will be described in detail below with reference to FIGS. 9 to 13B.

When the contents in the cooking appliance 1000 are heated according to a target heating temperature selected by the user, the wireless power transmission device 2000 may output a message 11 informing that a heat retention mode can be set. For example, when the target heating temperature is 90° C., the wireless power transmission device 2000 may output a message indicating “It is ready at 90° C. Please press OK for heat retention of 20 minutes”. When the user checks the message 11 and selects an OK button, the cooking appliance 1000 may operate in the heat retention mode.

The wireless power transmission device 2000 may output a notification 12 indicating that the cooking appliance 1000 operates in the heat retention mode. For example, when the cooking appliance 1000 operates in the heat retention mode in a right cooking zone, the wireless power transmission device 2000 may display information indicating “heat retention at 90° C.” at a position of the display which corresponds to the right cooking zone. When a heat retention time (e.g., 20 minutes) set by the user or a system expires, the wireless power transmission device 2000 may output a message inquiring whether to maintain heat retention setting.

Hereinafter, types of the wireless power reception device according to an embodiment of the present disclosure will now be further described with reference to FIGS. 2A and 2B.

FIGS. 2A and 2B are diagrams for describing types of the wireless power reception device, according to an embodiment of the present disclosure.

Referring to FIG. 2A, the wireless power reception device may include a cooking container 10 (general IH container) including a magnetic material (IH metal), and the cooking appliance 1000 communicative with the wireless power transmission device 2000. The cooking appliance 1000 communicative with the wireless power transmission device 2000 may be defined as a small appliance. According to an embodiment of the present disclosure, the cooking appliance 1000 may include a first type of cooking appliance 1000-1 including IH metal (e.g., an iron component), and a second type of cooking appliance 1000-2 including a reception coil 1003. Each of the types will now be described.

The cooking container 10 (general IH container) may be inductively heated by the wireless power transmission device 2000 and may include various types of containers including a magnetic material. IH is a method of heating an IH metal by using electromagnetic induction. For example, when an alternating current (AC) is supplied to a working coil of the wireless power transmission device 2000, a temporally changing magnetic field is induced inside the working coil. The magnetic field generated by the working coil passes through the bottom surface of the cooking container 10. When the temporarily changing magnetic field passes through the IH metal (e.g., iron, steel, nickel, or various types of alloys) included in the bottom surface of the cooking container 10, a current rotating around the magnetic field is generated in the IH metal. A rotating current is referred to as an eddy current, and a phenomenon in which a current is induced by a temporally changing magnetic field is referred to as electromagnetic induction. In a case of the cooking container 10 (general IH container), heat is generated at the bottom surface of the cooking container 10 by resistance of the eddy current and the IH metal (e.g., iron). Contents in the cooking container 10 may be heated by the generated heat.

The cooking appliance 1000 may include a pickup coil 1001, a first temperature sensor 1006, a power module 1010, a controller 1020, and a communication interface 1030. In this case, the power module 1010, the controller 1020, and the communication interface 1030 may be mounted on a printed circuit board (PCB) 1005. The pickup coil 1001 may be a low-power coil that generates power for operating the PCB 1005. When power is supplied to the PCB 1005 via the pickup coil 1001, components mounted on the PCB 1005 may be activated. For example, when power is supplied to the PCB 1005 via the pickup coil 1001, the controller 1020, the communication interface 1030, etc. may be activated. The power module 1010, the controller 1020, and the communication interface 1030 may be mounted on a single PCB or may be separately mounted on a plurality of PCBs. For example, the power module 1010 may be mounted on a first PCB, and the controller 1020 and the communication interface 1030 may be mounted on a second PCB.

Referring to FIG. 2B, the cooking appliance 1000 may further include a communication coil 1002. The communication coil 1002 may be a coil for performing short-range wireless communication with the wireless power transmission device 2000. For example, the communication coil 1002 may include an NFC antenna coil for NFC communication. In FIG. 2B, the number of windings of the communication coil 1002 is expressed as one, but the present disclosure is not limited thereto. The communication coil 1002 may be provided with a plurality of windings. For example, the communication coil 1002 may be wound in 5 or 6 turns. An NFC circuit connected to the NFC antenna coil may receive power via the pickup coil 1001.

In a case of the first type of cooking appliance 1000-1, as in the cooking container 10, an eddy current is generated in the IH metal, and accordingly, contents in the first type of the cooking appliance 1000-1 may be heated. The first type of cooking appliance 1000-1 may include a smart kettle, an electric rice cooker (smart pot), etc., but the present disclosure is not limited thereto.

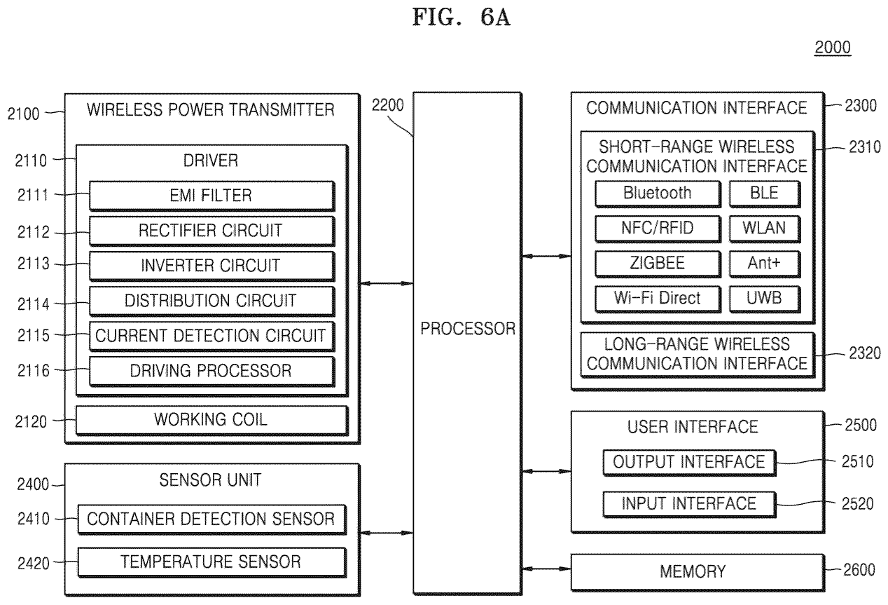

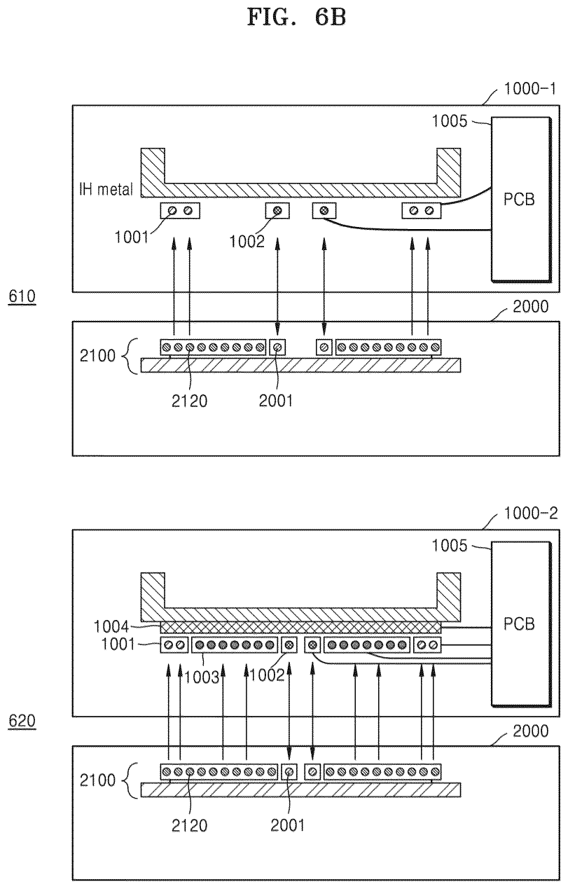

The second type of cooking appliance 1000-2 may further include more components, which are the reception coil 1003 and a load 1004, than the first type of cooking appliance 1000-1. The reception coil 1003 may be a coil that receives wireless power transmitted from the wireless power transmission device 2000 so as to drive the load 1004. For example, a magnetic field generated from a current flowing in a transmission coil (a working coil 2120 of FIG. 6A) of the wireless power transmission device 2000 passes through the reception coil 1003, and an induced current flows in the reception coil 1003, such that energy (power) may be supplied to the load 1004. Hereinafter, the induced current flowing in the reception coil 1003 by the magnetic field generated in the transmission coil (the working coil 2120) may be expressed as that the reception coil 1003 receives wireless power from the transmission coil (the working coil 2120). According to an embodiment of the present disclosure, the reception coil 1003 may have a concentric circle shape or an elliptical shape, but the present disclosure is not limited thereto. According to an embodiment of the present disclosure, the reception coil 1003 may be provided in plural. For example, the second type of cooking appliance 1000-2 may include a reception coil for a warming heater and a reception coil for a heating heater. In this case, the reception coil for the heating heater may drive the heating heater, and the reception coil for the warming heater may drive the warming heater.

According to an embodiment of the present disclosure, in the second type of cooking appliance 1000-2, the pickup coil 1001, the communication coil 1002, and the reception coil 1003 may be arranged on the same layer. For example, referring to FIG. 2B, the communication coil 1002 may be arranged on the innermost side, the reception coil 1003 may be arranged in the middle, and the pickup coil 1001 may be arranged on the outermost side, but the present disclosure is not limited thereto. For example, the reception coil 1003 may be arranged on the innermost side, the pickup coil 1001 may be arranged in the middle, and the communication coil 1002 may be arranged on the outermost side. Also, the reception coil 1003 may be arranged on the innermost side, the communication coil 1002 may be arranged in the middle, and the pickup coil 1001 may be arranged on the outermost side. The coils may be arranged in the following order from the innermost side.
1) Pickup coil 1001—Reception coil 1003—Communication coil 1002
2) Pickup coil 1001—Communication coil 1002—Reception coil 1003
3) Communication coil 1002—Pickup coil 1001—Reception coil 1003

According to an embodiment of the present disclosure, in the second type of cooking appliance 1000-2, the pickup coil 1001, the communication coil 1002, and the reception coil 1003 may be arranged in a stacked structure. For example, the pickup coil 1001 and the communication coil 1002, which do not have many windings, form one layer, and the reception coil 1003 forms another layer, such that two layers may be stacked.

The load 1004 may include a heater, a motor, or a battery to be recharged, but the present disclosure is not limited thereto. The heater is to heat the contents in the second type of cooking appliance 1000-2. The heater may have various shapes, and an external cover of the heater may also have various materials (e.g., iron, stainless steel, copper, aluminum, Incoloy, Inconel, etc.). According to an embodiment of the present disclosure, the second type of cooking appliance 1000-2 may also include a plurality of heaters. For example, the second type of cooking appliance 1000-2 may include a warming heater and a heating heater. The warming heater and the heating heater may produce different levels of heating output. For example, a heating level of the warming heater may be lower than a heating level of the heating heater.

According to an embodiment of the present disclosure, the second type of cooking appliance 1000-2 may further include a resonance capacitor between the reception coil 1003 and the load 1004. In this case, a resonance value may be differently set according to an amount of power required by the load 1004. Also, according to an embodiment of the present disclosure, the second type of cooking appliance 1000-2 may further include a switch unit (e.g., a relay switch or a semiconductor switch) for turning on/off the operation of the load 1004.

According to an embodiment of the present disclosure, the second type of cooking appliance 1000-2 may include a heater-applied product (e.g., a coffee maker (coffee dripper) and a toaster), a motor-applied product (e.g., a blender), etc., but the present disclosure is not limited thereto.

According to an embodiment of the present disclosure, as the cooking container 10 includes an IH metal, detection is possible in an IH container detection mode (pan detection mode) of the wireless power transmission device 2000, but the cooking container 10 is unable to communicate with the wireless power transmission device 2000, and thus, detection may not be possible in a small appliance detection mode of the wireless power transmission device 2000. As the first type of cooking appliance 1000-1 includes an IH metal, detection is possible in the IH container detection mode of the wireless power transmission device 2000, and the first type of cooking appliance 1000-1 is also able to communicate with the wireless power transmission device 2000, and thus, detection may be possible even in the small appliance detection mode of the wireless power transmission device 2000. As the second type of cooking appliance 1000-2 does not include an IH metal, detection is not performed in the IH container detection mode of the wireless power transmission device 2000, but the second type of cooking appliance 1000-2 is able to communicate with the wireless power transmission device 2000, and thus, detection may be possible in the small appliance detection mode of the wireless power transmission device 2000.

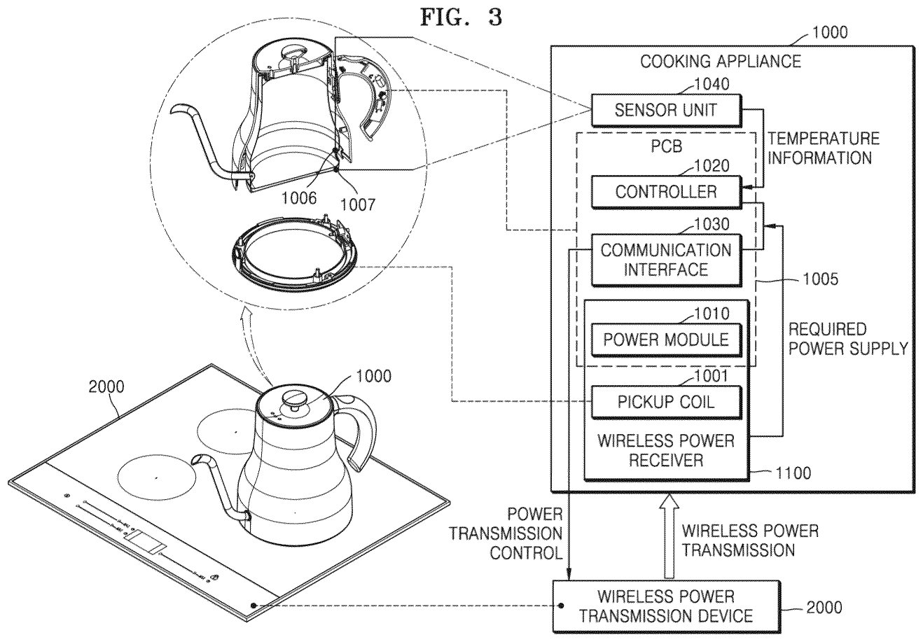

Hereinafter, with reference to FIG. 3, a configuration of the cooking appliance 1000 will now be further described.

FIG. 3 is a block diagram for describing a function of the cooking appliance 1000, according to an embodiment of the present disclosure.

The cooking appliance 1000 according to an embodiment of the present disclosure may include a wireless power receiver 1100, the controller 1020, the communication interface 1030, and a sensor unit 1040, and the wireless power receiver 1100 may include the pickup coil 1001 and the power module 1010. According to an embodiment of the present disclosure, the power module 1010, the controller 1020, and the communication interface 1030 may be mounted on the PCB 1005. When the power module 1010, the controller 1020, and the communication interface 1030 are mounted on the PCB 1005, the PCB 1005 may be defined as a printed circuit assembly (PCA). Hereinafter, the above components will now be sequentially described.

The wireless power receiver 1100 may be configured to receive power wirelessly transmitted from the wireless power transmission device 2000, and supply the received power to the controller 1020 and the communication interface 1030, and may include the pickup coil 1001 and the power module 1010.

The pickup coil 1001 may be a low-power coil that generates power for operating the PCB 1005. When power is supplied to the PCB 1005 through the pickup coil 1001, components mounted on the PCB 1005 may be activated. For example, when power is supplied to the PCB 1005 via the pickup coil 1001, the power module 1010, the controller 1020, and the communication interface 1030 may be activated.

The power module 1010 may be a power control circuit configured to receive AC power from the pickup coil 1001 and supply direct current (DC) power to the controller 1020 or the communication interface 1030. For example, the power module 1010 may convert AC power with 7 to 30 V input from the pickup coil 1001 into DC power with 3.3 V and may supply the DC power with 3.3 V to the controller 1020 and the communication interface 1030. Also, when the controller 1020, the communication interface 1030, and other components in the cooking appliance 1000 require AC power or DC power in forms other than commercial AC power, the power module 1010 may include an inverter and/or a converter that supplies the AC power or the DC power.

The power module 1010 may include an AC-DC converter and a DC-DC converter. The AC-DC converter may include a power transformer, a rectifier (rectifying circuit), and a smoothing circuit. The rectifier may convert an AC voltage of which magnitude and polarity (a positive voltage or a negative voltage) change over time into a DC voltage with a constant magnitude and polarity, and may convert an AC of which magnitude and direction (a positive current or a negative current) change over time into a DC with a constant magnitude. The rectifier may include a bridge diode. The bridge diode may convert an AC voltage of which polarity changes over time into a positive voltage with a constant polarity, and may convert an AC of which direction changes over time into a positive current with a constant direction. The smoothing circuit may include a DC link capacitor. The DC link capacitor may convert a positive voltage of which magnitude changes over time into a DC voltage with a constant magnitude. The inverter connected to the DC link capacitor may generate AC power of various frequencies and magnitudes required by the cooking appliance 1000, and the DC-DC converter may generate DC power of various magnitudes required by the cooking appliance 1000.

The controller 1020 may include at least one processor, and the at least one processor controls all operations of the cooking appliance 1000. For example, the at least one processor included in the controller 1020 may control the power module 1010 and the communication interface 1030. The controller 1020 may include one processor or a plurality of processors. For example, the controller 1020 may include only a main processor, or may include the main processor and at least one sub processor.

The at least one processor according to the present disclosure may include at least one of a central processing unit (CPU), a graphics processing unit (GPU), an accelerated processing unit (APU), a many integrated core (MIC), a digital signal processor (DSP), and a neural processing unit (NPU). The at least one processor may be implemented in the form of system on chip (SoC) in which one or more electronic parts are integrated. Each of the at least one processor may be implemented as separate hardware (H/W). The at least one processor may be referred to as a micro-computer/microprocessor computer/microprocessor controller (MICOM), a micro-processor unit (MPU), a micro-controller Unit).

The at least one processor according to the present disclosure may be implemented as a single core processor or a multicore processor.

According to an embodiment of the present disclosure, the controller 1020 may identify a current location of the cooking appliance 1000 by detecting a power transmission pattern of power received from the wireless power transmission device 2000 via the power module 1010. For example, the controller 1020 may compare the detected power transmission pattern with pre-stored power transmission patterns for respective cooking zones, and determine from which cooking zone the power transmission pattern is detected.

The controller 1020 may control the communication interface 1030 to transmit or receive data. For example, the controller 1020 may control the communication interface 1030 to transmit, to the wireless power transmission device 2000, at least one of the unique identification information of the cooking appliance 1000, the variable identification information of the cooking appliance 1000, or communication connection information of the cooking appliance 1000. The controller 1020 may change the variable identification information, according to a state of the cooking appliance 1000. For example, the controller 1020 may generate or change the variable identification information, according to a registration state of the cooking appliance 1000, a cooking zone in which the cooking appliance 1000 is located, and a product type of the cooking appliance 1000.

According to an embodiment of the present disclosure, the controller 1020 may measure a temperature of contents by using the first temperature sensor 1006. For example, the controller 1020 may measure a temperature of the contents according to a change in a sensor value (e.g., a change in resistance) of the first temperature sensor 1006. The controller 1020 may monitor a temperature of the contents at regular intervals (e.g., 1 second) by using the first temperature sensor 1006. In addition, the controller 1020 may control the communication interface 1030 to transmit temperature information of the contents to the wireless power transmission device 2000 via short-range wireless communication. Also, the controller 1020 may control the communication interface 1030 to transmit, to the wireless power transmission device 2000, power control information for control of a power level or a power duration time. For example, when the cooking appliance 1000 operates in a heat retention mode for maintaining a temperature of the contents with a preset temperature, the controller 1020 may determine a communication interval with the wireless power transmission device 2000 or a pan detection interval of the wireless power transmission device 2000, and may transmit, to the wireless power transmission device 2000, power control information including a wake-up time corresponding to the determined communication interval, a power level value, or the pan detection interval. The wireless power transmission device 2000 may transmit power for driving the communication interface 1030 of the cooking appliance 1000, at regular intervals according to the power control information, and may perform a pan detection operation, according to the pan detection interval.

The communication interface 1030 may include one or more components to enable communication between the cooking appliance 1000 and the wireless power transmission device 2000, between the cooking appliance 1000 and a server device, or between the cooking appliance 1000 and a mobile terminal. Hereinafter, the communication interface 1030 of the cooking appliance 1000 may be expressed as a first communication interface. The communication interface 1030 may include a short-range wireless communication interface and a long-range wireless communication interface.

The short-range wireless communication interface may include a Bluetooth communication interface, a BLE communication interface, an NFC interface, a WLAN (Wi-Fi) communication interface, a Zigbee communication interface, an infrared data association (IrDA) communication interface, a Wi-Fi Direct (WFD) communication interface, an ultra-wideband (UWB) communication interface, an Ant+ communication interface, etc., but the present disclosure is not limited thereto. When the cooking appliance 1000 is remotely controlled by the server device in an Internet of Things (IoT) environment, the long-range wireless communication interface may be used to communicate with the server device. The long-range wireless communication interface may include the Internet, a computer network (e.g., a LAN or a WAN), a mobile communication interface, etc. The mobile communication interface may include a 3G module, a 4G module, a 5G module, an LTE module, an NB-IoT module, an LTE-M module, etc., but the present disclosure is not limited thereto.

According to an embodiment of the present disclosure, the cooking appliance 1000 may transmit information to the server device via the wireless power transmission device 2000. For example, the cooking appliance 1000 may transmit information (e.g., temperature information of contents, etc.) obtained from the cooking appliance 1000 to the wireless power transmission device 2000 via short-range wireless communication (e.g., Bluetooth, BLE, etc.). The wireless power transmission device 2000 may access the server device via the WLAN (Wi-Fi) communication interface or the long-range wireless communication interface (Internet), and may transmit the information (e.g., temperature information of the contents) obtained from the cooking appliance 1000 to the server device. The server device may provide the information obtained from the cooking appliance 1000, received from the wireless power transmission device 2000, to a user via the mobile terminal connected to the server device. According to an embodiment of the present disclosure, the wireless power transmission device 2000 may directly transmit the information obtained from the cooking appliance 1000 to the user's mobile terminal via device-to-device (D2D) communication (e.g., WFD communication or BLE communication).

The sensor unit 1040 may include at least one temperature sensor. For example, the sensor unit 1040 may include the first temperature sensor 1006 (hereinafter, also referred to as the water temperature sensor) for measuring a temperature of the contents in the cooking appliance 1000 and a second temperature sensor 1007 (hereinafter, also referred to as an outer container temperature sensor or a pot temperature sensor) for measuring the temperature of the outer container of the cooking appliance 1000, but the present disclosure is not limited thereto. The sensor unit 1040 may include a third temperature sensor for detecting abnormal overheating.

At least one temperature sensor included in the sensor unit 1040 may be a contact-type temperature sensor, and may include a thermistor of which electrical resistance value changes according to temperature. For example, the first temperature sensor 1006 and the second temperature sensor 1007 may be negative temperature coefficient (NTC) temperature sensors, or may be positive temperature coefficient (PTC) temperature sensors.

The first temperature sensor 1006 may be provided at a location where it may directly contact the contents, but the present disclosure is not limited thereto. The first temperature sensor 1006 may be provided to measure a temperature of a container inserted into the cooking appliance 1000. In this case, the controller 1020 may predict a temperature of the contents, based on the temperature of the container. Hereinafter, for convenience of descriptions, a main example will be a case where the first temperature sensor 1006 is a sensor configured to measure a temperature of contents by directly contacting the contents.

However, not all the components shown in FIG. 3 are essential components. The cooking appliance 1000 may be implemented by more components than the components shown in FIG. 3, or may be implemented by fewer components than the components shown in FIG. 3. For example, the cooking appliance 1000 may be implemented with the wireless power receiver 1100, the communication interface 1030, the first temperature sensor 1006, and at least one processor. Also, the cooking appliance 1000 may further include a user interface, a memory, a battery, etc., as well as the wireless power receiver 1100, the controller 1020, and the communication interface 1030. In this case, the user interface may include an input interface configured to receive a user input, and an output interface configured to output information. The output interface is configured to output a video signal or an audio signal. The output interface may include a display unit, a sound output unit, a vibration motor, etc. When the display unit and a touch pad form a layered structure and constitute a touch screen, the display unit may be used as both the input interface and the output interface. The sound output unit may output an audio signal received via the communication interface 1030 or stored in a memory.

According to an embodiment of the present disclosure, when the cooking appliance 1000 includes a battery, the power received via the pickup coil 1001 may be used not only to operate the controller 1020, the communication interface 1030, and the first temperature sensor 1006 but also to charge the battery. When the battery is charged, the cooking appliance 1000 may use the power of the battery as auxiliary power. Accordingly, even when the cooking appliance 1000 does not receive power from the wireless power transmission device 2000, the cooking appliance 1000 may drive the controller 1020 and the communication interface 1030 by using the power of the battery. For example, when the cooking appliance 1000 provides a heat retention function, the cooking appliance 1000 may monitor a temperature of the contents by using the power of the battery even when power transmission from the wireless power transmission device 2000 is suspended. The cooking appliance 1000 may maintain a communication connection with the wireless power transmission device 2000 by using the power of the battery, and may continuously transmit information about the temperature of the contents to the wireless power transmission device 2000 at regular intervals. At this time, when a temperature of the contents falls below a threshold heat retention temperature while being monitored, the wireless power transmission device 2000 may transmit power (hereinafter, also referred to as the first power) for driving the controller 1020 and the communication interface 1030 of the cooking appliance 1000. Accordingly, when the cooking appliance 1000 includes a battery, the cooking appliance 1000 may determine a longer communication interval with the wireless power transmission device 2000 in a heat retention mode.

According to an embodiment of the present disclosure, before the cooking appliance 1000 receives power from the wireless power transmission device 2000, the cooking appliance 1000 may drive the communication interface 1030 by using the power of the battery and may transmit a wireless communication signal to the wireless power transmission device 2000, so that the wireless power transmission device 2000 may recognize the cooking appliance 1000 in advance. The battery may include a secondary battery (e.g., a lithium ion battery, a nickel-cadmium battery, a polymer battery, a nickel hydride battery, etc.), a super-capacitor, etc., but the present disclosure is not limited thereto. The super-capacitor is a capacitor with significantly large capacitance and is referred to as an ultra-capacitor or an ultra-high-capacity capacitor.

According to an embodiment of the present disclosure, when the cooking appliance 1000 includes a memory, the memory may store a program for processing and controlling by a processor, and may store input/output data (e.g., power transmission pattern information for each cooking zone, the unique identification information of the cooking appliance 1000, the variable identification information of the cooking appliance 1000, recipe information, operation mode information (e.g., a heat retention mode, a standby mode, and a heating mode), etc.

The memory may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc. The programs stored in the memory may be classified into a plurality of modules depending on functions thereof. At least one artificial intelligence model may be stored in the memory.

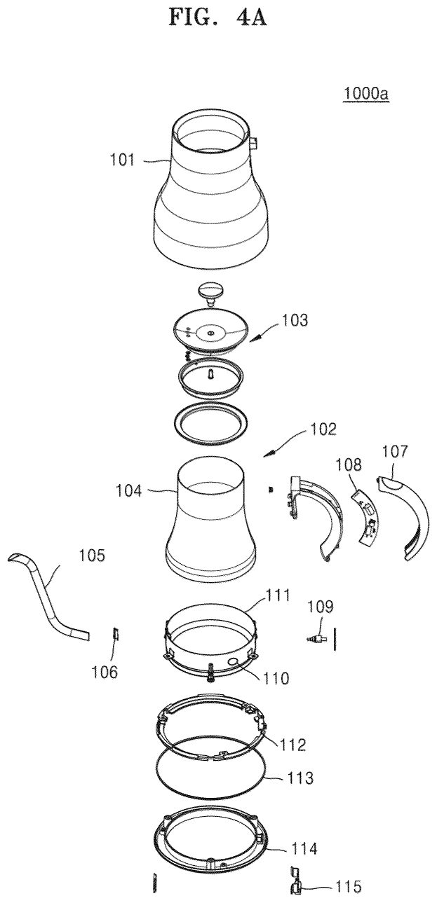

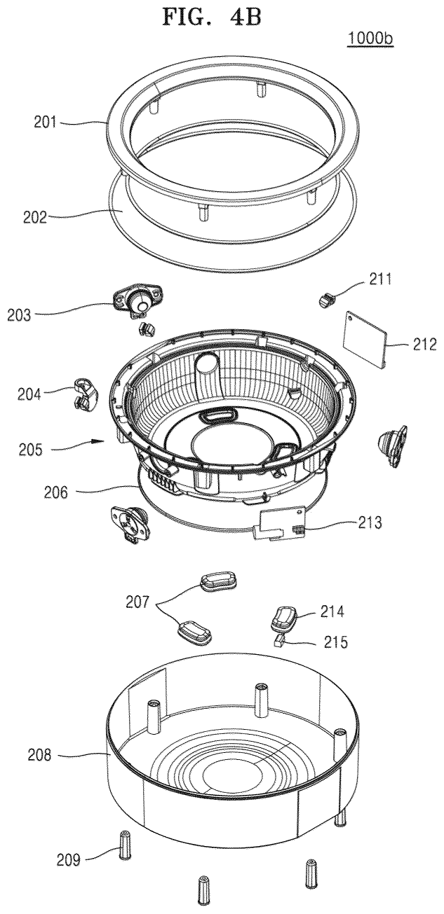

Hereinafter, with reference to FIGS. 4A and 4B, an example of the cooking appliance 1000 will now be described.

FIG. 4A is a diagram for describing a structure of a kettle 1000a as an example of the cooking appliance 1000.

Referring to FIG. 4A, the kettle 1000a may include an outer container 101 and an inner container 102. The kettle 1000a may include a lid 103, a water tank 104, a spout 105, a spout guide 106, a handle 107, a PCB 108, a water temperature sensor 109, an outer container temperature sensor 110, a case cover 111, a pickup coil cover 112, a pickup coil 113, a bottom case 114, and a silicone leg 115, but the present disclosure is not limited thereto. Each configuration will now be described.

The outer container 101 may be arranged to surround a lateral surface portion of the inner container 102. The inner container 102 may be composed of an upper portion and a lower portion, and the upper portion of the inner container 102 may include a material different from a material used to form the lower portion of the inner container 102. For example, the upper portion of the inner container 102 may include a non-magnetic material, and the lower portion of the inner container 102 may include a magnetic material.

The lid 103 may be attached to and detached from the inner container 102. While the kettle 1000a operates in a heat retention mode, when the lid 103 covers the inner container 102, a temperature of contents may decrease slowly, and, when the lid 103 does not cover the inner container 102, the temperature of the contents may decrease quickly.

The water tank 104 may be a space for accommodating contents.

The spout 105 may be a pipe for flowing contents in the water tank 104 to the outside. The spout 105 may be connected to the water tank 104 via the spout guide 106, and may be exposed to the outside via the outer container 101.

The handle 107 may be attached to the outer container 101. The handle 107 may include a waterproof member to prevent water from penetrating into the handle 107. The PCB 108 may be arranged in the handle 107.

The PCB 108 may correspond to the PCB 1005 of FIG. 3. The PCB 108 may include the power module 1010, the controller 1020, and the communication interface 1030. The PCB 108 may include an output interface (e.g., a buzzer).

An electric line connected from the PCB 108 may be connected to the water temperature sensor 109, the outer container temperature sensor 110, and the pickup coil 113 via a space between the outer container 101 and the inner container 102. As the electric line may be in contact with the inner container 102 of a high temperature, the electric line may be surrounded by a heat-resistant glass fiber. When the electric line connected from the PCB 108 is connected via the space between the outer container 101 and the inner container 102, an instrument guide (e.g., a holder) protruding from the outer container 101 may be closely fixed to the outer container 101 in order to minimize a contact between the electric line and the inner container 102.

The water temperature sensor 109 may be arranged while passing through the inner container 102. The water temperature sensor 109 may be arranged to pass through the inner container 102 in parallel to a bottom surface of the kettle 1000a, or may be arranged to pass through the inner container 102 at an angle toward the lower surface. The water temperature sensor 109 may be in contact with contents (e.g., water) in the water tank 104. The water temperature sensor 109 is configured to measure a temperature of contents, and may correspond to the first temperature sensor 1006 of FIG. 3. The outer container temperature sensor 110 is configured to measure a temperature of the outer container 101, and may be arranged on a lateral surface of the lower portion of the inner container 102. The outer container temperature sensor 110 may correspond to the second temperature sensor 1007 of FIG. 3. The outer container temperature sensor 110 may be arranged to be lower than the water temperature sensor 109, but the present disclosure is not limited thereto. According to an embodiment of the present disclosure, a plurality of outer container temperature sensors 110 may be arranged in a circumferential direction of the inner container 102.

The pickup coil cover 112 may be arranged to surround the pickup coil 113. The pickup coil 113 may be arranged between the inner container 102 and the outer container 101. The pickup coil 113 may be arranged to surround the lower portion of the inner container 102. The pickup coil 113 may be arranged between the outer container temperature sensor 110 and the outer container 101. The pickup coil 113 may correspond to the pickup coil 1001 of FIG. 3, and thus, detailed descriptions thereof are not provided here.

The bottom case 114 may include a material that is prone to generate an eddy current that rotates about an electromagnetic field formed by the wireless power transmission device 2000.

The silicon leg 115 may be arranged in a lower portion of the bottom case 114. The silicon leg 115 may be a component for relieving impact when the kettle 1000a is placed on a top plate of the wireless power transmission device 2000 and preventing the kettle 1000a from slipping.

According to an embodiment of the disclosure, the kettle 1000a may wirelessly receive power from the wireless power transmission device 2000 via the pickup coil 113 so as to drive the communication interface 1030 included in the PCB 108 in the handle 107. The kettle 1000a may perform short-range wireless communication with the wireless power transmission device 2000 via the communication interface 1030. In particular, the kettle 1000a may transmit, to the wireless power transmission device 2000 via the communication interface 1030, power control information for control of power transmission from the wireless power transmission device 2000 so as to allow a temperature of contents in the water tank 104 to be maintained around a target heat retention temperature.

FIG. 4B is a diagram for describing a structure of a smart pot 1000b as an example of the cooking appliance 1000.

Referring to FIG. 4B, the smart pot 1000b may include a top cover 201, inner/outer sealing 202, a side sensor module 203, a buzzer module 204, an inner case 205, a pickup coil 206, rubber legs 207, a body 208, a screw cover 209, a guide rubber 211, a BLE PBA module 212, a power PBA module 213, a sensor leg 214, and a bottom sensor 215, but the present disclosure is not limited thereto. Each configuration will now be described.

The top cover 201 forms an outer appearance of the smart pot 1000b, and seats the cooking container 10.

The inner/outer sealing 202 is compressed during assembly of the smart pot 1000b to block a moisture infiltration path, and thus, enhances water resistance of the smart pot 1000b.

The side sensor module 203 may include a side temperature sensor for measuring a temperature of the cooking container 10, a fixing member for fixing the side temperature sensor, and an elastic member (e.g., a spring) that is compressed and deformed when the cooking container 10 is seated, but the present disclosure is not limited thereto.

The side temperature sensor is coupled with the elastic member, and the elastic member may be compressed and deformed as the cooking container 10 is accommodated in an internal space of the smart pot 1000b. For example, when the cooking container 10 is not seated in the smart pot 1000b, the side sensor module 203 protrudes inward, and, as the cooking container 10 is seated in the smart pot 1000b, the side sensor module 203 may be pressed. In this case, as a size of the cooking container 10 increases, a compression rate of the side sensor module 203 may increase. Therefore, the smart pot 1000b according to an embodiment of the present disclosure may accommodate various sizes of the cooking container 10.

According to an embodiment of the present disclosure, the side sensor module 203 including a side temperature sensor may be disposed at a predetermined height or more apart from the bottom surface of the smart pot 1000b. As the side temperature sensor is also an electrical component, the side sensor module 203 may be affected by induction heating of the wireless power transmission device 2000. Therefore, in order to minimize an influence of induction heating of the wireless power transmission device 2000 (e.g., overheating of the side temperature sensor itself and noise occurrence due to induction heating), the side sensor module 203 may be disposed a predetermined height or more from the bottom surface of the smart pot 1000b. For example, in order to increase the accuracy of temperature data of the cooking container 10, the side sensor module 203 including a side temperature sensor may be disposed at a height that meets a straight surface of the cooking container 10 rather than an inclined surface of the cooking container 10.

According to an embodiment of the present disclosure, the side sensor module 203 including a side temperature sensor may be provided in plural in the smart pot 1000b so as to prevent eccentricity (e.g., the cooking container 10 is seated biased to one side) due to a difference between sizes of the cooking container 10. For example, three side sensor modules 203 may be arranged at 120° angular intervals in an inner circumferential direction of the smart pot 1000b.

The buzzer module 204 may include a buzzer configured to output a notification signal in abnormal heating of the cooking container 10, a fixing member, and a protective cover.

The inner case 205 may be a component configured to support the cooking container 10, and the side sensor module 203, the pickup coil 206, the BLE PBA module 212, the power PBA module 213, etc. may be assembled in the inner case 205.

The pickup coil 206 is a component configured to receive wireless power from the wireless power transmission device 2000. For example, the pickup coil 206 may be a low-power coil that generates power for operating the BLE PBA module 212. As the pickup coil 206 corresponds to the pickup coil 1001 of FIG. 3, redundant descriptions are not provided here.

The rubber legs 207 is a component configured to alleviate an impact between the cooking container 10 and the smart pot 1000b when the cooking container 10 is seated, and to prevent the cooking container 10 from slipping.

The body 208 may serve to form the outer appearance of the smart pot 1000b and cover the internals thereof. The body 208 may prevent heat conduction to the outside during a cooking operation. According to an embodiment of the present disclosure, the body 208 may include a part (handle part) that a user holds together with the cooking container 10 seated in the smart pot 1000b when the smart pot 1000b is moved.

The screw cover 209 may cover a screw. The screw cover 209 may alleviate the impact of the smart pot 1000b when the smart pot 1000b is placed on the wireless power transmission device 2000, and may prevent the smart pot 1000b from slipping.

The guide rubber 211 may prevent eccentricity when the cooking container 10 is seated, may alleviate the impact of the cooking container 10, and may prevent the cooking container 10 from slipping.

The BLE PBA module 212 may perform wireless communication (e.g., BLE communication) with the wireless power transmission device 2000 so as to control an output (e.g., a power level value) of the wireless power transmission device 2000. Also, the BLE PBA module 212 may include a microcontroller unit (MCU). The MCU may receive an input of temperature data from the cooking container 10, and may store an algorithm or recipe information for automatic cooking. The BLE PBA module 212 may include the communication interface 1030 and the controller 1020.

The power PBA module 213 may convert the power received from the pickup coil 206 into a use voltage of the BLE PBA module 212. For example, the power PBA module 213 may be a power converter configured to receive AC power from the pickup coil 206 and then to supply DC power to the MCU or a BLE module included in the BLE PBA module 212. As the power PBA module 213 corresponds to the power module 1010 of FIG. 3, redundant descriptions are not provided here.

The sensor leg 214 may be a component to which the bottom sensor 215 is assembled, among the rubber legs 207. As the sensor leg 214 is a type of rubber leg 207, the sensor leg 214 may alleviate the impact between the cooking container 10 and the smart pot 1000b and prevent the cooking container 10 from slipping, when the cooking container 10 is seated.

The bottom sensor 215 may be a temperature sensor configured to detect abnormal overheating of the cooking container 10. The bottom sensor 215 may be arranged at a different position from the side sensor module 203 including a side temperature sensor for measuring a temperature of the cooking container 10. For example, the bottom sensor 215 may be arranged on the bottom surface of the smart pot 1000b, and three side sensor modules 203 may be arranged on the lateral side of the smart pot 1000b. According to an embodiment of the present disclosure, when abnormal overheating occurs in the cooking container 10, a temperature of the bottom surface of the cooking container 10 rises most rapidly, and thus the bottom sensor 215 may be assembled to the sensor leg 214, which is one of the rubber legs 207, so that abnormal overheating of the cooking container 10 may be quickly detected.

According to an embodiment of the present disclosure, the smart pot 1000b may wirelessly receive power from the wireless power transmission device 2000 via the pickup coil 113 so as to drive the communication interface 1030 included in the BLE PBA module 212. The smart pot 1000b may perform short-range wireless communication with the wireless power transmission device 2000 via the communication interface 1030. In particular, the smart pot 1000b may transmit, to the wireless power transmission device 2000 via the communication interface 1030, power control information for control of power transmission from the wireless power transmission device 2000 so as to allow a temperature of contents in the cooking container 10 to be maintained around a target heat retention temperature.

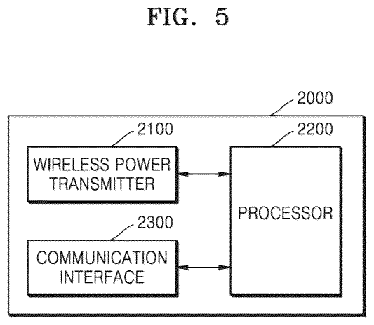

Hereinafter, with reference to FIGS. 5, 6A, and 6B, the wireless power transmission device 2000 configured to perform communication with the cooking appliance 1000 will now be described in detail.

FIGS. 5 and 6A are block diagrams for describing functions of the wireless power transmission device 2000, according to an embodiment of the present disclosure.

As shown in FIG. 5, the wireless power transmission device 2000 according to an embodiment of the present disclosure may include a wireless power transmitter 2100, a processor 2200, and a communication interface 2300. However, not all the components shown in FIG. 5 are essential components. The wireless power transmission device 2000 may be implemented by more components than the components shown in FIG. 5, or may be implemented by fewer components. As shown in FIG. 6A, the wireless power transmission device 2000 according to an embodiment of the present disclosure may include the wireless power transmitter 2100, the processor 2200, the communication interface 2300, a sensor unit 2400, a user interface 2500, and a memory 2600.

Hereinafter, the above components will now be sequentially described.

The wireless power transmitter 2100 may include a driver 2110 and a working coil 2120, but the present disclosure is not limited thereto. The driver 2110 may receive power from an external source, and may supply a current to the working coil 2120 according to a driving control signal of the processor 2200. The driver 2110 may include an electromagnetic interference (EMI) filter 2111, a rectifier circuit 2112, an inverter circuit 2113, a distribution circuit 2114, a current detection circuit 2115, and a driving processor 2116, but the present disclosure is not limited thereto.

The EMI filter 2111 may block high-frequency noise included in AC power supplied from the external source, and may transmit an AC voltage and an AC current of a predetermined frequency (e.g., 50 Hz or 60 Hz). A fuse and a relay may be provided between the EMI filter 2111 and the external source so as to block overcurrent. AC power of which high-frequency noise has been blocked by the EMI filter 2111 may be supplied to the rectifier circuit 2112.

The rectifier circuit 2112 may convert the AC power to DC power. For example, the rectifier circuit 2112 may convert an AC voltage whose a magnitude and a polarity (positive voltage or negative voltage) change over time into a DC voltage whose a magnitude and a polarity are constant, and may convert an AC current whose a magnitude and a polarity (positive current or negative current) change over time to a DC current having a constant magnitude. The rectifier circuit 2112 may include a bridge diode. For example, the rectifier circuit 2112 may include four diodes. The bridge diode may convert an AC voltage whose polarity changes over time to a positive voltage whose polarity is constant, and may convert an AC current whose direction changes over time to a positive current whose direction is constant. The rectifier circuit 2112 may include a DC link capacitor. The DC link capacitor may convert a positive voltage whose magnitude changes over time to a DC voltage having a constant magnitude.

The inverter circuit 2113 may include a switching circuit that supplies or blocks a driving current to or from the working coil 2120, and a resonance circuit that causes resonance together with the working coil 2120. The switching circuit may include a first switch and a second switch. The first switch and the second switch may be connected in series between a plus line and a minus line output by the rectifier circuit 2112. The first switch and the second switch may be turned on or off according to a driving control signal of the driving processor 2116.

The inverter circuit 2113 may control a current that is supplied to the working coil 2120. For example, the magnitude and direction of the current flowing in the working coil 2120 may change according to turning on/off of the first switch and the second switch included in the inverter circuit 2113. In this case, an AC current may be supplied to the working coil 2120. An AC current in the form of a sine wave is supplied to the working coil 2120 according to switching operations of the first switch and the second switch. The longer respective switching periods of the first switch and the second switch (e.g., the smaller respective switching frequencies of the first switch and the second switch are), the larger the current supplied to the working coil 2120 may be, and the larger the intensity of a magnetic field output by the working coil 2120 (output of the wireless power transmission device 2000) may be.

When the wireless power transmission device 2000 includes a plurality of working coils 2120, the driver 2110 may include the distribution circuit 2114. The distribution circuit 2114 may include a plurality of switches that pass or block a current supplied to the plurality of working coils 2120, and the plurality of switches included in the distribution circuit 2114 may be turned on or off, in response to a distribution control signal of the driving processor 2116.

The current detection circuit 2115 may include a current sensor configured to measure the current output from the inverter circuit 2113. The current sensor may transmit an electrical signal corresponding to a value of the measured current to the driving processor 2116.

The driving processor 2116 may determine a switching frequency (turn-on/turn-off frequency) of the switching circuit included in the inverter circuit 2113, based on the output intensity (power level) of the wireless power transmission device 2000. The driving processor 2116 may generate a driving control signal for turning on/off the switching circuit according to the determined switching frequency.

The working coil 2120 may generate a magnetic field for heating the cooking appliance 1000. For example, when a driving current is supplied to the working coil 2120, a magnetic field may be induced around the working coil 2120. When a current whose magnitude and direction change over time, that is, an AC current, is supplied to the working coil 2120, a magnetic field whose magnitude and direction change over time may be induced around the working coil 2120. The magnetic field around the working coil 2120 may pass through a top plate including tempered glass, and may reach the cooking appliance 1000 placed on the top plate. Due to the magnetic field whose magnitude and direction change over time, an eddy current rotating about the magnetic field may occur in the cooking appliance 1000, and electrical resistance heat may be generated in the cooking appliance 1000 due to the eddy current. The electrical resistance heat is heat generated in a resistor when a current flows in the resistor, and is referred to as Joule heat. While the cooking appliance 1000 is being heated by the electric resistance heat, contents in the cooking appliance 1000 may be heated. When the cooking appliance 1000 is the second type of cooking appliance 1000-2 including the reception coil 1003, the magnetic field around the working coil 2120 may be induced in the reception coil 1003. A structure of the wireless power transmitter 2100 will be further described below with reference to FIG. 6B.

The processor 2200 controls all operations of the wireless power transmission device 2000. The processor 2200 may execute programs stored in the memory 2600 to control the wireless power transmitter 2100, the communication interface 2300, the sensor unit 2400, the user interface 2500, and the memory 2600. The wireless power transmission device 2000 may include at least one processor. The processor 2200 may include one or more processor. The wireless power transmission device 2000 may include only a main processor, or may include the main processor and at least one subprocessor.

According to an embodiment of the present disclosure, the wireless power transmission device 2000 may include an artificial intelligence (AI) processor. The AI processor may be manufactured in the form of a dedicated hardware chip for AI, or may be manufactured as a part of an existing general-purpose processor (for example, a CPU or an AP) or a graphic-dedicated processor (for example, a GPU) and may be mounted on the wireless power transmission device 2000.

According to an embodiment of the present disclosure, the processor 2200 may control the inverter circuit 2113 to supply power of a preset level (e.g., 200 W) to the cooking appliance 1000 so as to drive the communication interface 1030 of the cooking appliance 1000, and may receive a first wireless communication signal transmitted from the communication interface 1030 of the cooking appliance 1000, when the communication interface 1030 of the cooking appliance 1000 is driven. The first wireless communication signal may include unique identification information (e.g., a MAC address) or variable identification information (e.g., information indicating that a current location of the cooking appliance 1000 is unknown, information indicating that the cooking appliance 1000 is a registered appliance or an unregistered appliance) of the cooking appliance 1000, but the present disclosure is not limited thereto.

When the processor 2200 detects the first wireless communication signal transmitted from the cooking appliance 1000, the processor 2200 may control the inverter circuit 2113 to drive the plurality of working coils 2120 to generate a magnetic field according to a plurality of different power transmission patterns. The plurality of power transmission patterns may be set differently based on at least one of a duration time of a power transmission section, a duration time of a power-suspension section, a power level, or an operating frequency. For example, the processor 2200 may control the inverter circuit 2113 to transmit power by differently combining the duration time of the power transmission section, the duration time of the power-suspension section, or the power level (operating frequency) for each cooking zone.

The processor 2200 may receive, from the cooking appliance 1000 via the communication interface 2300, a second wireless communication signal including information about a first cooking zone corresponding to a first power transmission pattern detected at the location of the cooking appliance 1000 among the plurality of power transmission patterns and variable identification information including product type information of the cooking appliance 1000, and based on the second wireless communication signal, the processor 2200 may output, via the output interface 2510, the information about the first cooking zone where the cooking appliance 1000 is located among the plurality of cooking zones and the product type information of the cooking appliance 1000.

According to an embodiment of the disclosure, when the processor 2200 does not receive a first wireless communication signal from a wireless power reception device within a preset time after detecting that the wireless power reception device is located on the top plate of the wireless power transmission device 2000, the processor 2200 may recognize the wireless power reception device as the cooking container 10. As the processor 2200 detects the first wireless communication signal transmitted from the cooking appliance 1000 via the communication interface 1030, the processor 2200 may recognize the wireless power reception device as the cooking appliance 1000 capable of performing communication.

According to an embodiment of the present disclosure, the processor 2200 may detect that the location of the cooking appliance 1000 is changed from the first cooking zone to the second cooking zone.

For example, in response to release of a communication connection with the cooking appliance 1000 that has been located in the first cooking zone among the plurality of cooking zones, the processor 2200 may control the inverter circuit 2113 to transmit power for driving the communication interface 1030 of the cooking appliance 1000. When the first wireless communication signal including the unique identification information and the variable identification information of the cooking appliance 1000 is received via the communication interface 2300 within a preset time after the communication connection is released, the processor 2200 may control the inverter circuit 2113 to drive the plurality of working coils to generate a magnetic field according to the plurality of different power transmission patterns. The processor 2200 may receive, from the cooking appliance 1000 via the communication interface 2300, a second wireless communication signal including the variable identification information including product type information of the cooking appliance 1000 and information about the second cooking zone corresponding to a power transmission pattern detected at a location of the cooking appliance 1000, among the plurality of power transmission patterns, and may output, based on the second wireless communication signal, via the output interface 2510, the information about the second cooking zone in which the cooking appliance 1000 is currently located, among the plurality of cooking zones. Hereinafter, for convenience of descriptions, the communication interface 2300 of the wireless power transmission device 2000 may be defined as a second communication interface, and the communication interface 1030 of the cooking appliance 1000 may be defined as a first communication interface.

The processor 2200 may control the output interface 2510 to display the product type information (e.g., a product type icon) of the cooking appliance 1000 at a first location indicating the first cooking zone in a GUI screen while the cooking appliance 1000 is located in the first cooking zone, and to display the product type information (e.g., the product type icon) of the cooking appliance 1000 at a second location indicating the second cooking zone in the GUI screen when the cooking appliance 1000 is moved from the first cooking zone to the second cooking zone.

The communication interface 2300 may include one or more components to enable communication between the wireless power transmission device 2000 and the cooking appliance 1000 or between the wireless power transmission device 2000 and the server device. For example, the communication interface 2300 may include a short-range wireless communication interface 2310 and a long-range wireless communication interface 2320. The short-range wireless communication interface 2310 may include a Bluetooth communication interface, a BLE communication interface, an NFC interface, a WLAN (Wi-Fi) communication interface, a Zigbee communication interface, an IrDA communication interface, a WFD communication interface, an UWB communication interface, an Ant+ communication interface, etc., but the present disclosure is not limited thereto. When the cooking appliance 1000 is remotely controlled by the server device in an IoT environment, the long-range wireless communication interface 2320 may be used to communicate with the server device. The long-range wireless communication interface 2320 may include the Internet, a computer network (e.g., a LAN or a WAN), a mobile communication interface, etc. The mobile communication interface transmits or receives wireless signals to or from at least one of a base station, an external terminal, or a server, via a mobile communication network. The mobile communication interface may include a 3G module, a 4G module, an LTE module, a 5G module, a 6G module, an NB-IoT module, an LTE-M module, etc., but the present disclosure is not limited thereto.

The sensor unit 2400 may include a container detection sensor 2410 and a temperature sensor 2420, but the present disclosure is not limited thereto.

The container detection sensor 2410 may be a sensor configured to detect that the cooking container 10 or the cooking appliance 1000 is placed on the top plate. For example, the container detection sensor 2410 may be implemented as a current sensor, but the present disclosure is not limited thereto. The container detection sensor 2410 may be implemented as at least one of a proximity sensor, a touch sensor, a weight sensor, a temperature sensor, an illuminance sensor, and a magnetic sensor.

The temperature sensor 2420 may detect a temperature of the cooking appliance 1000 (or, the cooking container 10) placed on the top plate or a temperature of the top plate. The cooking appliance 1000 may be inductively heated by the working coil 2120 and may be overheated depending on a material thereof. Accordingly, the wireless power transmission device 2000 may detect the temperature of the cooking appliance 1000 placed on the top plate or the temperature of the top plate, and when the cooking appliance 1000 is overheated, may block the operation of the working coil 2120. The temperature sensor 2420 may be mounted in the vicinity of the working coil 2120. For example, the temperature sensor 2420 may be located at the center of the working coil 2120.

According to an embodiment of the present disclosure, the temperature sensor 2420 may include a thermistor of which electrical resistance value changes according to temperature. For example, the temperature sensor may include an NTC temperature sensor, but the present disclosure is not limited thereto. The temperature sensor may also include a PTC temperature sensor.

The user interface 2500 may include the output interface 2510 and an input interface 2520. The output interface 2510 is configured to output an audio signal or a video signal, and may include a display unit and a sound output unit.

When the display unit and a touch pad form a layered structure and constitute a touch screen, the display unit may be used as both the input interface and the output interface. The display unit may include at least one of a liquid crystal display, a thin film transistor-liquid crystal display, a light-emitting diode (LED), an organic light-emitting diode (OLED), a flexible display, a three-dimensional (3D) display, and an electrophoretic display. In addition, the wireless power transmission device 2000 may include two or more display units according to an implementation type of the wireless power transmission device 2000.

The sound output unit may output audio data received from the communication interface 2300 or stored in the memory 2600. Also, the sound output unit may output a sound signal related to a function performed by the wireless power transmission device 2000. The sound output unit may include a speaker, a buzzer, etc.

According to an embodiment of the present disclosure, the output interface 2510 may display information regarding the cooking appliance 1000. For example, the output interface 2510 may output a GUI corresponding to the identification information or the product type information of the cooking appliance 1000. Also, the output interface 2510 may output information of the current location of the cooking appliance 1000.

According to an embodiment of the present disclosure, the output interface 2510 may display information related to a heat retention operation of the cooking appliance 1000. For example, the output interface 2510 may output a target heat retention temperature, a notification indicating heat retention, a notification indicating completion of heat retention, a message inquiring whether to extend a heat retention time, etc.

The input interface 2520 is configured to receive an input from a user. For example, the input interface 2520 may include at least one of a key pad, a dome switch, a touch pad (using a touch capacitance method, a pressure-resistive layer method, an infrared sensing method, a surface ultrasonic conductive method, an integral tension measuring method, a piezo effect method, etc.), a jog wheel, and a jog switch, but the present disclosure is not limited thereto. According to an embodiment of the present disclosure, the input interface 2520 may receive an input related to heat retention mode setting (e.g., selection of a target heat retention temperature, adjustment of a heat retention time, etc.) of the cooking appliance 1000.

The input interface 2520 may include a speech recognition module. For example, the wireless power transmission device 2000 may receive a speech signal, which is an analog signal, via a microphone and may convert a speech part into computer-readable text by using an automatic speech recognition (ASR) model. The wireless power transmission device 2000 may obtain a user's intention to speak by interpreting the converted text using a natural language understanding (NLU) model. In this case, the ASR model or the NLU model may be an AI model. The AI model may be processed by an AI-only processor that is designed in a hardware structure specialized for processing the AI model. The AI model may be created through learning. Generating the AI model through learning means that a basic AI model is trained using a plurality of pieces of training data by a learning algorithm such that a predefined operation rule or AI model set to perform a desired characteristic (or purpose) is created. The AI model may include a plurality of neural network layers. Each of the plurality of neural network layers has a plurality of weight values, and may perform a neural network operation through an operation between an operation result of a previous layer and the plurality of weight values.

Linguistic understanding is a technique that identifies and applies/processes human language/characters, and includes natural language processing, machine translation, a dialog system, question answering, speech recognition/synthesis, etc.

The memory 2600 may store programs for processing and controlling the processor 2200 or may store pieces of input/output data (e.g., the unique identification information of the cooking appliance 1000, the variable identification information of the cooking appliance 1000, a plurality of power transmission patterns, cooking progress information of the cooking appliance 1000, etc.). The memory 2600 may also store the AI model.

The memory 2600 may include at least one type of storage medium including a flash memory, a hard disk-type memory, a multimedia card micro-type memory, a card-type memory (e.g., an SD or XD memory), RAM, SRAM, ROM, EEPROM, PROM, a magnetic memory, a magnetic disk, and an optical disk. Also, the wireless power transmission device 2000 may run a web storage or a cloud server that performs a storage function on the Internet.

FIG. 6B is a diagram for describing the wireless power transmitter 2100 of the wireless power transmission device 2000, according to an embodiment of the present disclosure.

Referring to FIG. 6B, the wireless power transmission device 2000 may further include a communication coil 2001 on the same plane as a transmission coil (the working coil 2120). In this case, the communication coil 2001 may include an NFC antenna coil for NFC communication. In FIG. 6B, the number of windings of the communication coil 2001 is expressed as one, but the present disclosure is not limited thereto. The communication coil 2001 may be provided with a plurality of windings. For example, the communication coil 2001 may be wound in 5 or 6 turns.

According to an embodiment of the present disclosure, the communication coil 2001 included in the wireless power transmission device 2000 and the communication coil 1002 included in the cooking appliance 1000 may be arranged at locations corresponding to each other. For example, when the communication coil 2001 included in the wireless power transmission device 2000 is arranged at the center of each cooking zone, the communication coil 1002 included in the cooking appliance 1000 may be arranged at the bottom center of the cooking appliance 1000.

Referring to 610 of FIG. 6B, when the first type of cooking appliance 1000-1 is placed on the wireless power transmission device 2000, the wireless power transmission device 2000 may supply power to the pickup coil 1001 via the transmission coil 2120. Also, when the wireless power transmission device 2000 wirelessly transmits power via the transmission coil 2120, an eddy current is generated in the first type of cooking appliance 1000-1, and accordingly, contents in the first type of cooking appliance 1000-1 may be heated.

Referring to 620 of FIG. 6B, when the second type of cooking appliance 1000-2 is placed on the wireless power transmission device 2000, the wireless power transmission device 2000 may supply power to the pickup coil 1001 via the transmission coil 2120. Also, when the wireless power transmission device 2000 wirelessly transmits power via the transmission coil 2120, an induced current flows in the reception coil 1003 of the second type of cooking appliance 1000-2, such that energy (power) may be supplied to the load 1004. The load 1004 may include a motor or a heater, and may be arranged at a location spaced apart from the reception coil 1003. For example, power generated by the induced current may drive a motor of a blender or may be supplied to a heater of a coffee dripper.

In FIG. 6B, a case in which the wireless power transmission device 2000 includes the communication coil 2001 is described as an example, but when the cooking appliance 1000 does not include the communication coil 1002 (see FIG. 2A), the wireless power transmission device 2000 may also not include the communication coil 2001.

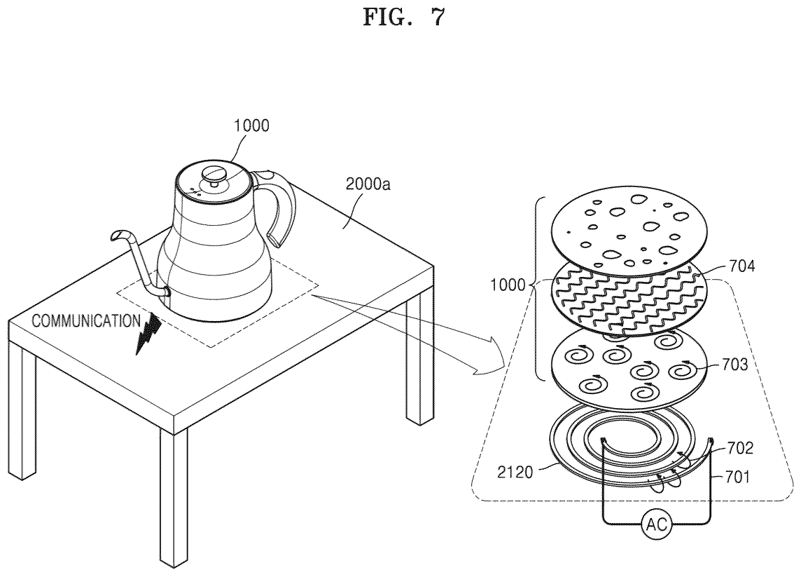

According to an embodiment of the present disclosure, the wireless power transmission device 2000 may be an induction range (see FIGS. 1 and 3), but the present disclosure is not limited thereto. For example, the wireless power transmission device 2000 may be a smart table. The smart table will now be described in detail with reference to FIG. 7.

FIG. 7 is a diagram for describing a smart table 2000a as an example of the wireless power transmission device 2000.

Referring to FIG. 7, the smart table 2000a may include the working coil 2120. Accordingly, the smart table 2000a may cause an AC current 701 to flow in the working coil 2120 to form a magnetic field 702, and thus may generate an eddy current 703 in a bottom surface of the cooking appliance 1000. In this regard, the cooking appliance 1000 may be the first type of cooking appliance 1000-1. Due to resistance of the eddy current 703 and an IH metal (e.g., iron), heat is generated in the bottom surface of the cooking appliance 1000. Contents 704 in the cooking appliance 1000 may be heated by the generated heat.

While not illustrated in FIG. 7, when the cooking appliance 1000 is the second type of cooking appliance 1000-2, the smart table 2000a may induce a magnetic field in the reception coil of is the second type of cooking appliance 1000-2.

According to an embodiment of the present disclosure, the smart table 2000a may include the communication interface 2300. The smart table 2000a may perform communication with the cooking appliance 1000 via the communication interface 2300. For example, the smart table 2000a may transmit information related to a current operation mode to the cooking appliance 1000, and may periodically information related to a temperature of contents from the cooking appliance 1000.

Hereinafter, for convenience of descriptions, a main example will be a case where the wireless power transmission device 2000 is an induction range.

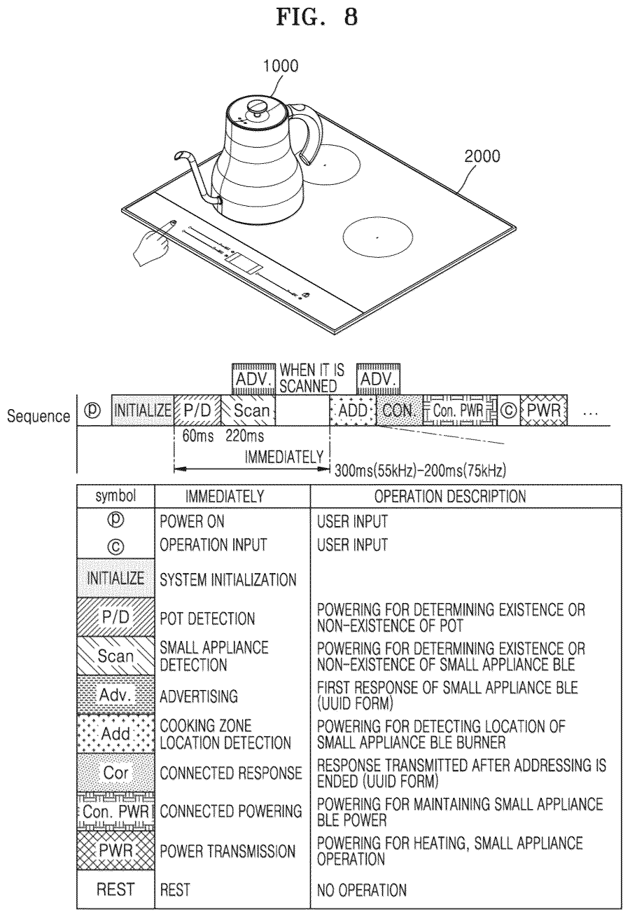

FIG. 8 is a diagram for describing an operation of the wireless power transmission device 2000 in a case where the cooking appliance 1000 is placed on the wireless power transmission device 2000, according to an embodiment of the present disclosure.

Referring to FIG. 8, when a user turns on power of the wireless power transmission device 2000 while the cooking appliance 1000 is placed on the top plate, the wireless power transmission device 2000 may initialize a system and may perform an IH container detection operation (pan detection operation). In this regard, when the cooking appliance 1000 is the first type of cooking appliance 1000-1 including a magnetic material, the wireless power transmission device 2000 may detect that the first type of cooking appliance 1000-1 is placed on the top, by using a current sensor. When the cooking appliance 1000 is the second type of cooking appliance 1000-2 including the reception coil 1003, the wireless power transmission device 2000 may detect that the second type of cooking appliance 1000-2 is placed on the top, by using the current sensor.

The wireless power transmission device 2000 may perform an IH container detection operation and then may perform a small appliance detection operation (small object detection operation). For example, the wireless power transmission device 2000 may transmit power of a first level (e.g., 200 W) for driving the communication interface 1030 of the cooking appliance 1000 to the cooking appliance 1000, and may perform in a scan mode. When the cooking appliance 1000 receives power of the first level, the cooking appliance 1000 may drive the communication interface 1030 and may advertise a first packet including unique identification information (e.g., MAC address) and variable identification information of the cooking appliance 1000. The variable identification information may include, in the form of a UUID, product type information of the cooking appliance 1000 and information indicating that a cooking zone in which the cooking appliance 1000 is currently located is unknown. The variable identification information may also include, in the form of a UUID, information indicating whether the cooking appliance 1000 is a registered appliance.

The wireless power transmission device 2000 operating in the scan mode may identify that the cooking appliance 1000 is placed on the top, by receiving the first packet advertised by the cooking appliance 1000. When the first packet does not include information about a cooking zone in which the cooking appliance 1000 is located, the wireless power transmission device 2000 may operate in a cooking zone determination mode for checking a location of the cooking appliance 1000. For example, the wireless power transmission device 2000 may output (e.g., addressing) power according different power transmission patterns for respective cooking zones. For example, the wireless power transmission device 2000 may set a duration time of maintaining a low operating frequency (e.g., 55 kHz) and a duration time of maintaining a high operating frequency (e.g., 75 kHz) differently for the respective cooking zones. In this case, induced power may be large in a low operating frequency (e.g., 55 kHz) interval, and induced power may be small in a high operating frequency (e.g., 75 kHz) interval.

According to an embodiment of the present disclosure, as the cooking appliance 1000 is placed in the cooking zone in the lower left corner, the cooking appliance 1000 may detect a specific power transmission pattern corresponding to the cooking zone in the lower left corner. The cooking appliance 1000 may identify that the cooking appliance 1000 is located in the cooking zone in the lower left corner, by comparing the specific power transmission pattern with a plurality of pre-stored power transmission patterns of the cooking appliance 1000. In this case, the cooking appliance 1000 may transmit (e.g., advertise), to the wireless power transmission device 2000, a second packet including information indicating that the cooking appliance 1000 is located in the cooking zone in the lower left corner and product type information of the cooking appliance 1000. The variable identification information including current location information of the cooking appliance 1000 and product type information of the cooking appliance 1000 may be inserted into the second packet, in the form of a UUID. Also, the second packet may further include the unique identification information (e.g., a MAC address) of the cooking appliance 1000 and communication connection information.

The wireless power transmission device 2000 may perform a communication connection with the cooking appliance 1000 based on the communication connection information included in the second packet. When the wireless power transmission device 2000 has been previously paired with the cooking appliance 1000, the communication connection information may include pairing information. According to an embodiment of the present disclosure, the wireless power transmission device 2000 may establish a short-range wireless communication channel (e.g., a Bluetooth communication channel or a BLE communication channel) with the cooking appliance 1000. When the Bluetooth communication channel is established, it may refer to causing the cooking appliance 1000 and the wireless power transmission device 2000 to be in a state in which data may be transmitted or received using a Bluetooth communication method. The BLE communication channel may be a non-connected virtual communication channel for transmitting or receiving advertising packets via mutual scanning between the cooking appliance 1000 and the wireless power transmission device 2000, or may be a connected communication channel in which a session is generated in response to a BLE connection request of the wireless power transmission device 2000.

When the wireless power transmission device 2000 is connected to be in communication with the cooking appliance 1000, the wireless power transmission device 2000 may control the inverter circuit 2113 to transmit power (low power) with a first level for maintaining the communication connection with the cooking appliance 1000 to the pickup coil 1001 of the cooking appliance 1000. In this case, when an operation command (e.g., start brewing coffee, start automatic cooking, heat, or keep warm) for the cooking appliance 1000 is received from a user, the wireless power transmission device 2000 may control the inverter circuit 2113 to transmit, to the cooking appliance 1000, power with second level for operating the cooking appliance 1000. The power with second level may be power (high power) for driving a load (e.g., a heater, a motor, and a battery) of the cooking appliance 1000 or inductively heating contents in the cooking appliance 1000.

According to an embodiment of the present disclosure, when the cooking appliance 1000 is a small appliance configured to provide a heat retention function after completion of a heating operation of the cooking appliance 1000, the wireless power transmission device 2000 may output a message inquiring whether to perform a heat retention operation. When a user inputs a heat retention request via the wireless power transmission device 2000, the wireless power transmission device 2000 may transmit heat retention request information to the cooking appliance 1000 via short-range wireless communication (e.g., BLE communication).

The cooking appliance 1000 may enter a heat retention mode according to the heat retention request information, and may control a power transmission interval of the wireless power transmission device 2000 so as to allow a temperature of contents to be maintained around a target heat retention temperature. Here, a transmission interval of the power with first level (low power) may be controlled. The power with first level (low power) is power for driving the communication interface 1030 of the cooking appliance 1000, and may be referred to as the first power below. While the power with first level (low power) is transmitted, a communication connection between the cooking appliance 1000 and the wireless power transmission device 2000 may be maintained, and when transmission of the power with first level (low power) is suspended, the communication connection between the cooking appliance 1000 and the wireless power transmission device 2000 may also be suspended. Therefore, the power transmission interval may also be referred to as a communication interval.

Hereinafter, with reference to FIG. 9, an operation in which the cooking appliance 1000 controls power transmission by the wireless power transmission device 2000 so as to maintain a temperature of contents at a target heat retention temperature will now be described in detail.

FIG. 9 is a flowchart for describing a method of maintaining heat retention, by the cooking appliance 1000, according to an embodiment of the present disclosure.

In operation S910, the cooking appliance 1000 may enter a heat retention mode. The heat retention mode may indicate a mode in which a temperature of contents in the cooking appliance 1000 is maintained around a target heat retention temperature selected by a user.

According to an embodiment of the present disclosure, the cooking appliance 1000 may receive heat retention request information including a target heat retention temperature selected by a user from the wireless power transmission device 2000. For example, when the wireless power transmission device 2000 receives an input of a heat retention request for the cooking appliance 1000 from the user via the user interface 2500, the wireless power transmission device 2000 may transmit heat retention request information to the cooking appliance 1000 via short-range wireless communication (e.g., BLE communication). The heat retention request information may further include information about a heat retention time set by the user. For example, when the user sets the heat retention time to 1 hour, the wireless power transmission device 2000 may transmit the heat retention request information including the heat retention time (1 hour) to the cooking appliance 1000.

According to an embodiment of the present disclosure, when the cooking appliance 1000 receives the heat retention request information from the wireless power transmission device 2000, the cooking appliance 1000 may change an operation mode of the cooking appliance 1000 to a heat retention mode. Then, the cooking appliance 1000 may store, in a memory, information (e.g., a heat retention flag) indicating that the operation mode of the cooking appliance 1000 is the heat retention mode. Here, the wireless power transmission device 2000 may also operate in a heat retention mode, and may store mapping information with respect to the unique identification information of the cooking appliance 1000 and the heat retention mode, in the memory 2600.

In operation S920, when entering the heat retention mode, the cooking appliance 1000 may compare a temperature of contents with a target heat retention temperature.

According to an embodiment of the present disclosure, the processor of the cooking appliance 1000 may measure the temperature of contents via the first temperature sensor 1006 at preset intervals. For example, the cooking appliance 1000 may measure the temperature of contents via the first temperature sensor 1006 at intervals of 1 second, but the preset intervals are not limited to 1 second. When the cooking appliance 1000 measures the temperature of contents, the cooking appliance 1000 may compare the target heat retention temperature selected by the user with the temperature of contents. Every time the cooking appliance 1000 measures a temperature of contents, the cooking appliance 1000 may compare the target heat retention temperature with a temperature of the contents. The cooking appliance 1000 may compare the target heat retention temperature with a temperature of the contents, at intervals different from a temperature measurement interval for the contents. For example, the cooking appliance 1000 may compare a temperature of contents once at every 1 second, and may compare a temperature of the contents with the target heat retention temperature once at every 10 seconds.

According to an embodiment of the present disclosure, the cooking appliance 1000 may continuously compare a temperature of the contents with the target heat retention temperature while the first power is supplied. The first power may be power for driving the controller 1020 and the communication interface 1030 of the cooking appliance 1000. For example, the first power may be power equal to or greater than 200 W, but the present disclosure is not limited thereto. When the first power is supplied, the communication interface 1030 of the cooking appliance 1000 may be activated, and thus, the cooking appliance 1000 may transmit data about a temperature of contents to the wireless power transmission device 2000 via short-range wireless communication (e.g., BLE communication).

In operation S930, as a result of comparing the temperature of contents with the target heat retention temperature, the cooking appliance 1000 may determine whether the temperature of contents is equal to or greater than the target heat retention temperature.

According to an embodiment of the present disclosure, when the temperature of contents is less than the target heat retention temperature, the cooking appliance 1000 may continuously compare a temperature of contents with the target heat retention temperature while monitoring a temperature of the contents. When the temperature of the contents is less than the target heat retention temperature, the cooking appliance 1000 may continuously receive the first power from the wireless power transmission device 2000, and the temperature of the contents may rise up to the target heat retention temperature by the first power.

In operation S940, when the temperature of the contents is equal to or greater than the target heat retention temperature, the cooking appliance 1000 may transmit, to the wireless power transmission device 2000, power control information indicating to suspend transmission of the first power for driving the communication interface 1030 of the cooking appliance 1000 and then to re-transmit the first power after an elapse of a preset time.

When the wireless power transmission device 2000 maintains transmission of the first power, a temperature of contents may continuously rise, and thus, may exceed the target heat retention temperature. Therefore, when a temperature of contents is equal to or greater than the target heat retention temperature, the cooking appliance 1000 may control the wireless power transmission device 2000 to suspend transmission of the first power. However, when the wireless power transmission device 2000 keeps suspension of transmission of the first power, a temperature of contents may falls to a temperature further less than the target heat retention temperature. Therefore, the cooking appliance 1000 may control the wireless power transmission device 2000 to suspend transmission of the first power during a preset time and then to re-transmit the first power at an appropriate time, thereby allowing the temperature of content to be maintained around the target heat retention temperature.

While the wireless power transmission device 2000 suspends transmission of the first power, the communication interface 1030 is inactivated, and thus, communication between the cooking appliance 1000 and the wireless power transmission device 2000 is not available. Therefore, when the cooking appliance 1000 transmits power control information indicating to suspend transmission of the first power to the wireless power transmission device 2000, the cooking appliance 1000 may also transmit information about a time to start transmission of the first power (hereinafter, referred to as the wake-up time).

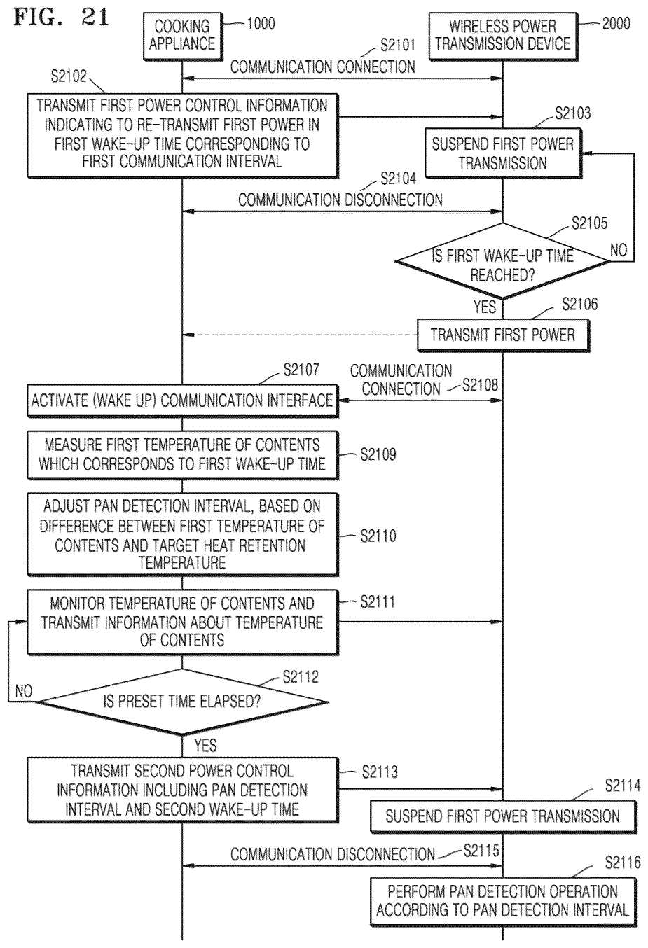

According to an embodiment of the present disclosure, the power control information may further include information about a power level of the first power, a temperature of contents, and information about a pan detection interval, in addition to the wake-up time for retransmission o the first power. For example, the cooking appliance 1000 may determine a power level of the first power or additionally determine the pan detection interval for the wireless power transmission device 2000 to detect existence of the cooking appliance 1000, and may transmit the power control information including the power level of the first power and the pan detection interval to the wireless power transmission device 2000. When the wireless power transmission device 2000 performs a pan detection operation, power for pan detection is transmitted to the cooking appliance 1000, and thus, contents in the cooking appliance 1000 may be heated. Therefore, it is necessary to appropriately adjust the pan detection interval. An operation in which the cooking appliance 1000 adjusts the pan detection interval will be described in detail below with reference to FIG. 21.

According to an embodiment of the present disclosure, the cooking appliance 1000 may appropriately determine a preset time in which transmission of the first power is suspended to maintain a temperature of contents around the target heat retention temperature. When transmission of the first power is suspended, communication between the wireless power transmission device 2000 and the cooking appliance 1000 is suspended, and thus, the preset time in which transmission of the first power is suspended may correspond to a communication interval. Therefore, that the cooking appliance 1000 determines the preset time in which transmission of the first power is suspended may indicate that the cooking appliance 1000 determines the communication interval.

According to an embodiment of the present disclosure, the cooking appliance 1000 may determine the communication interval (the power transmission interval) by considering at least one of an amount of contents and a temperature value of the target heat retention temperature, so that a temperature of the contents may be maintained around (e.g., ±2 of the target heat retention temperature) the target heat retention temperature. Then, the cooking appliance 1000 may transmit the power control information including the wake-up time corresponding to the determined communication interval to the wireless power transmission device 2000. For example, when the determined communication interval is 300 seconds, the cooking appliance 1000 may transmit power control information indicating to re-transmit the first power in 300 seconds to the wireless power transmission device 2000, and when the determined communication interval is 30 seconds, the cooking appliance 1000 may transmit power control information indicating to re-transmit the first power in 30 seconds to the wireless power transmission device 2000.

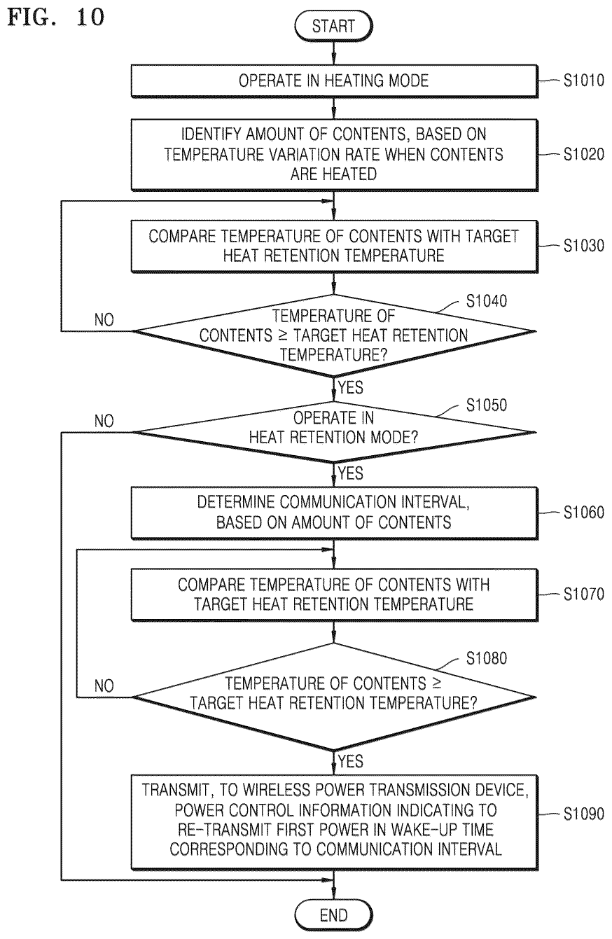

Therefore, according to an embodiment of the present disclosure, when the cooking appliance 1000 operates in a heat retention mode, the cooking appliance 1000 may control transmission of the first power at preset intervals, so that a temperature of contents may be maintained around the target heat retention temperature. Hereinafter, with reference to FIGS. 10 to 13B, an operation in which the cooking appliance 1000 determines a communication interval (a power transmission interval) so as to allow a temperature of contents to be maintained around a target heat retention temperature will now be described in detail.

FIG. 10 is a flowchart for describing a method by which the cooking appliance 1000 determines a communication interval, based on an amount of contents, according to an embodiment of the present disclosure.

In operation S1010, the cooking appliance 1000 may operate in a heating mode. The heating mode may indicate a mode in which contents are heated until a temperature of the contents in the cooking appliance 1000 reaches a target heating temperature.

According to an embodiment of the present disclosure, when a user places the cooking appliance 1000 on the wireless power transmission device 2000 and selects a heating function via the user interface 2500 of the wireless power transmission device 2000 (e.g., selection of a power level for heating, etc.), the wireless power transmission device 2000 may transmit, to the cooking appliance 1000, heating request information indicating that a heating request is input from the user. The heating request information may include a target heating temperature selected by the user. For example, when the target heating temperature is set to 90° C., the wireless power transmission device 2000 may transmit the heating request information including the target heating temperature of 90° C. to the cooking appliance 1000. The wireless power transmission device 2000 may transmit the heating request information to the cooking appliance 1000 via short-range wireless communication (e.g., BLE communication or WFD).

According to an embodiment of the present disclosure, the wireless power transmission device 2000 may transmit power (hereinafter, referred to as the heating power) having a power level value corresponding to the heating mode to the cooking appliance 1000. When the heating power is received from the wireless power transmission device 2000, contents in the cooking appliance 1000 may be heated. According to an embodiment of the present disclosure, the wireless power transmission device 2000 may transmit information about the power level value of the heating power to the cooking appliance 1000 via short-range wireless communication.

In operation S1020, when the heating request information is received, the cooking appliance 1000 may identify an amount of contents, based on a temperature variation rate of the contents.

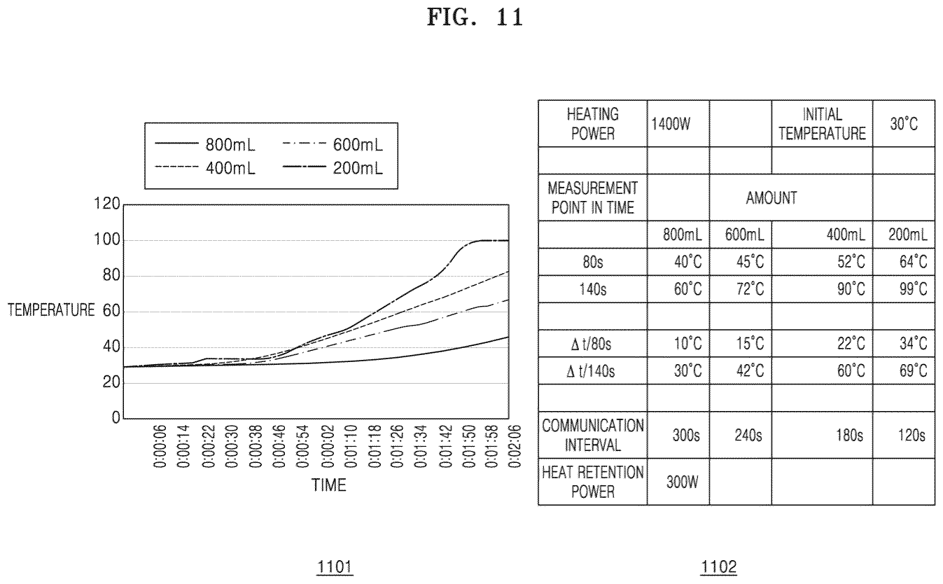

According to an embodiment of the present disclosure, when the cooking appliance 1000 operates in the heating mode, the cooking appliance 1000 may calculate the temperature variation rate of the contents, based on a temperature of the contents which is measured via the first temperature sensor 1006. Then, the cooking appliance 1000 may identify a current amount of the contents by comparing the temperature variation rate of the content per unit time with a pre-stored table or graph. The pre-stored table or graph may be a table or graph in which a correlation between an amount of contents and a temperature variation rate of the contents is defined. FIG. 11 will now be referenced.

Referring to a graph 1101 of FIG. 11, the more the amount of contents is, the lower the temperature variation rate is, and the fewer the amount of contents is, the higher the temperature variation rate is. For example, it is apparent that, when an amount of water is 800 ml, a temperature slowly increases, and when an amount of water is 200 ml, a temperature rapidly increases.

Referring to a table 1102 of FIG. 11, in a case where heating power is 1400 W, and an initial temperature is 30° C., when contents correspond to 800 ml, a temperature of the contents may increase by 10° C. in 80 seconds, and a temperature of the contents may increase by 20° C. in 140 seconds. When contents correspond to 600 ml, a temperature of the contents may increase by 15° C. in 80 seconds, and a temperature of the contents may increase by 42° C. in 140 seconds. When contents correspond to 400 ml, a temperature of the contents may increase by 22° C. in 80 seconds, and a temperature of the contents may increase by 60° C. in 140 seconds. When contents correspond to 200 ml, a temperature of the contents may increase by 34° C. in 80 seconds, and a temperature of the contents may increase by 69° C. in 140 seconds.

Therefore, in a case where the heating power is 1400 W, and the initial temperature is 30° C., when a temperature of contents increases by 10° C. in 80 seconds, and the temperature of the contents increases by 30° C. in 140 seconds, the cooking appliance 1000 may identify an amount of the contents as 800 ml.

In operation S1030, the cooking appliance 1000 may compare the temperature of the contents with the target heating temperature.

According to an embodiment of the present disclosure, the processor of the cooking appliance 1000 may measure the temperature of the contents via the first temperature sensor 1006 at preset intervals. For example, the cooking appliance 1000 may measure the temperature of contents via the first temperature sensor 1006 at intervals of 1 second, but the preset intervals are not limited to 1 second. When the temperature of the contents is measured, the cooking appliance 1000 may compare the temperature of the contents with the target heating temperature selected by a user.

According to an embodiment of the present disclosure, the user may select the target heating temperature. For example, when the user desires to drink tea, the user may select the target heating temperature as 70° C., and when the user desires to drink coffee, the user may select the target heating temperature as 90° C. When the user selects the heating function without setting the target heating temperature, the target heating temperature may be set to 100° C. as default.

In operation S1040, as a result of comparing the temperature of the contents with the target heating temperature, the cooking appliance 1000 may determine whether the temperature of the contents is equal to or greater than the target heating temperature.

According to an embodiment of the present disclosure, when the temperature of the contents is less than the target heating temperature, the cooking appliance 1000 may continuously compare a temperature of the contents with the target heating temperature while monitoring a temperature of the contents. When the temperature of the contents is less than the target heating temperature, the cooking appliance 1000 may continuously receive the heating power (e.g., 1000 W or higher) from the wireless power transmission device 2000, and the temperature of the contents may increase up to the target heating temperature, by the heating power.

In operation S1050, when the temperature of the contents is equal to or greater than the target heating temperature, the cooking appliance 1000 may determine whether to operate in a heat retention mode.

According to an embodiment of the present disclosure, when heat retention request information is received from the wireless power transmission device 2000, the cooking appliance 1000 may enter the heat retention mode. For example, when the wireless power transmission device 2000 outputs, via the user interface 2500, a notification indicating that heating to the target heating temperature is completed, a user may select a heat retention function via the user interface 2500. Here, the user may set a target heat retention temperature. According to an embodiment of the present disclosure, the user may select the heat retention function while contents is heated, or may select the heat retention function after heating of the contents is completed. When the user selects the heat retention function, the wireless power transmission device 2000 may transmit heat retention request information including the target heat retention temperature to the cooking appliance 1000. The cooking appliance 1000 may operate in the heat retention mode, according to the heat retention request information.

According to an embodiment of the present disclosure, when the heat retention request information is not received from the wireless power transmission device 2000, the cooking appliance 1000 may transmit power control information indicating to end the heating mode and suspend transmission of the heating power, to the wireless power transmission device 2000.

In operation S1060, when the cooking appliance 1000 operates in the heat retention mode, the cooking appliance 1000 may determine a communication interval (a power transmission interval), based on an amount of contents.

According to an embodiment of the present disclosure, the processor of the cooking appliance 1000 may determine a long communication interval when the amount of contents is great, and may determine a short communication interval when the amount of contents is small. As a temperature variation rate decreases when the amount of contents increases, even when a section in which power transmission from the wireless power transmission device 2000 is suspended is long, a temperature of contents does not significantly fall below the target heat retention temperature. On the other hand, as a temperature variation rate increases when the amount of contents decreases, when a section in which power transmission from the wireless power transmission device 2000 is suspended is long, a temperature of contents may significantly fall below the target heat retention temperature. Therefore, the cooking appliance 1000 may determine the communication interval, based on the amount of contents, so that the temperature of contents may be maintained around the target heat retention temperature.

For example, referring to the table 1102 of FIG. 11, when an amount of contents is 800 ml, the cooking appliance 1000 may determine the communication interval as 300 seconds, when an amount of contents is 600 ml, the cooking appliance 1000 may determine the communication interval as 240 seconds, when an amount of contents is 400 ml, the cooking appliance 1000 may determine the communication interval as 180 seconds, and when an amount of contents is 200 ml, the cooking appliance 1000 may determine the communication interval as 120 seconds, but the present disclosure is not limited thereto.

In operation S1070, while operating in the heat retention mode, the cooking appliance 1000 may compare a temperature of contents with the target heat retention temperature.

According to an embodiment of the present disclosure, the processor of the cooking appliance 1000 may measure a temperature of contents via the first temperature sensor 1006. For example, the cooking appliance 1000 may measure the temperature of contents via the first temperature sensor 1006 at intervals of 1 second, but the preset intervals are not limited to 1 second. When the cooking appliance 1000 measures the temperature of the contents, the cooking appliance 1000 may compare the target heat retention temperature selected by the user with the temperature of the contents. As operation S1070 corresponds to operation S920 of FIG. 9, redundant descriptions are not provided here.

In operation S1080, as a result of comparing the temperature of the contents with the target heat retention temperature, the cooking appliance 1000 may determine whether the temperature of the contents is equal to or greater than the target heat retention temperature.

According to an embodiment of the present disclosure, when the temperature of the contents is less than the target heating temperature, the cooking appliance 1000 may continuously compare a temperature of the contents with the target heating temperature while monitoring a temperature of the contents. When the temperature of the contents is less than the target heating temperature, the cooking appliance 1000 may continuously receive the first power (hereinafter, also referred to as the heat retention power) from the wireless power transmission device 2000, and the temperature of the contents may increase up to the target heating temperature, by the first power.

In operation S1090, when the temperature of the contents is equal to or greater than the target heat retention temperature, the cooking appliance 1000 may transmit, to the wireless power transmission device 2000, power control information indicating to suspend transmission of the first power and then to re-transmit the first power in a wake-up time corresponding to the communication interval. In this regard, the wake-up time may be a time in which contents are inductively re-heated by re-transmitting the first power to the pickup coil 1001 of the cooking appliance 1000, and the controller 1020 and the communication interface 1030 of the cooking appliance 1000 are woken up.

According to an embodiment of the present disclosure, when a temperature of contents is equal to or greater than the target heat retention temperature, the cooking appliance 1000 may suspend transmission of the first power for a preset time, thereby allowing the temperature of contents to fall below the target heat retention temperature. As inductive heating by a magnetic field generated in the working coil 2120 of the wireless power transmission device 2000 and power transmission to the pickup coil 1001 are simultaneously performed, when a temperature of contents is equal to or greater than the target heat retention temperature, only the inductive heating with respect to the cooking appliance 1000 cannot be selectively suspended. When power transmission to the pickup coil 1001 is suspended, operations of the communication interface 1030 and the first temperature sensor 1006 of the cooking appliance 1000 are suspended, and thus, communication between the cooking appliance 1000 and the wireless power transmission device 2000 is disconnected.

The cooking appliance 1000 may control the wireless power transmission device 2000 to re-transmit the first power in the wake-up time corresponding to the communication interval determined according to an amount of contents so as to allow a temperature of the contents not to be greatly less than the target heat retention temperature. When the wireless power transmission device 2000 re-transmits the first power, the contents may be inductively re-transmitted, and communication between the wireless power transmission device 2000 and the cooking appliance 1000 may be reconnected. For example, when the cooking appliance 1000 determines the communication interval to be 300 seconds, according to an amount of contents, the cooking appliance 1000 may transmit power control information indicating to suspend transmission of the first power and then to re-transmit the first power in 300 seconds, to the wireless power transmission device 2000. Also, when the cooking appliance 1000 determines the communication interval to be 30 seconds, according to an amount of contents, the cooking appliance 1000 may transmit power control information indicating to suspend transmission of the first power and then to re-transmit the first power in 30 seconds, to the wireless power transmission device 2000.

Therefore, according to an embodiment of the present disclosure, the cooking appliance 1000 may appropriately adjust a communication interval, according to an amount of contents, so that a temperature of the contents may be maintained within a threshold range (e.g., ±3° C.) of the target heat retention temperature.

While an example of FIG. 10 is described, in which the cooking appliance 1000 identifies an amount of contents according to a temperature variation rate, the cooking appliance 1000 may identify the amount of contents by using a water level detection sensor.

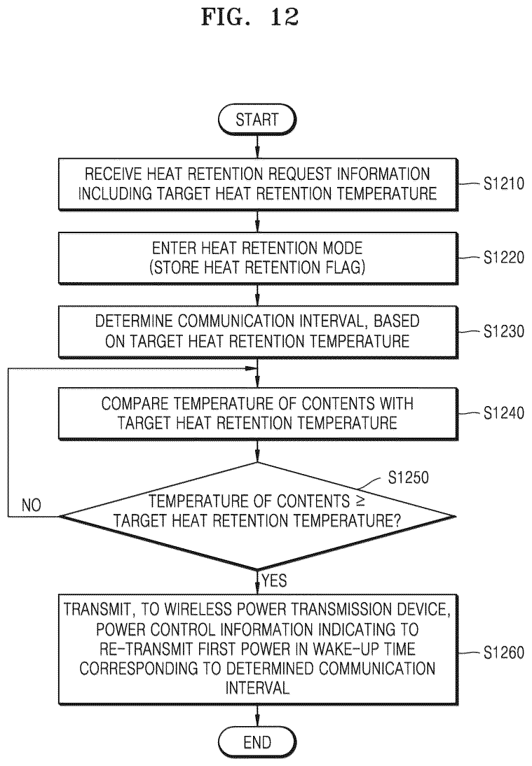

FIG. 12 is a flowchart for describing a method by which the cooking appliance 1000 determines a communication interval, based on a target heat retention temperature, according to an embodiment of the present disclosure.

In operation S1210, the cooking appliance 1000 may receive heat retention request information including a target heat retention temperature from the wireless power transmission device 2000.

For example, when a user selects a target heat retention temperature and inputs a heat retention request via the user interface 2500 of the wireless power transmission device 2000, the wireless power transmission device 2000 may transmit heat retention request information including the target heat retention temperature to the cooking appliance 1000 via short-range wireless communication (e.g., BLE communication or WFD).

In operation S1220, the cooking appliance 1000 may enter a heat retention mode, according to the heat retention request information.

According to an embodiment of the present disclosure, when the cooking appliance 1000 receives the heat retention request information from the wireless power transmission device 2000, the cooking appliance 1000 may change an operation mode of the cooking appliance 1000 to the heat retention mode. Then, the cooking appliance 1000 may store, in the memory, information (e.g., a heat retention flag) indicating that the operation mode of the cooking appliance 1000 is the heat retention mode.

In operation S1230, the cooking appliance 1000 may determine the communication interval (power transmission period), based on the target heat retention temperature.

According to an embodiment of the present disclosure, the cooking appliance 1000 may determine a short communication interval when the target heat retention temperature is high, and may determine a long communication interval when the target heat retention temperature is low. When the wireless power transmission device 2000 suspends first power transmission to the cooking appliance 1000, a speed that a temperature of contents exceeds a threshold range of the target heat retention temperature may increase as the target heat retention temperature is high. For example, a time taken to fall from 90° C. by 3° C. may be shorter than a time taken to fall from 90° C. by 3° C. Therefore, the cooking appliance 1000 may determine the communication interval according to a temperature value of the target heat retention temperature, so that a temperature of contents may be maintained within the threshold range of the target heat retention temperature.

For example, when the target heat retention temperature is 40° C., 60° C., 80° C., the cooking appliance 1000 may determine the communication interval to be 300 seconds, and when the target heat retention temperature is 90° C., the cooking appliance 1000 may determine the communication interval to be 30 seconds.

In operation S1240, when entering the heat retention mode, the cooking appliance 1000 may compare a temperature of contents with the target heat retention temperature.

According to an embodiment of the present disclosure, the cooking appliance 1000 may measure a temperature of contents via the first temperature sensor 1006 at preset intervals. When the cooking appliance 1000 measures the temperature of contents, the cooking appliance 1000 may compare the temperature of contents with the target heat retention temperature selected by a user.

In operation S1250, as a result of comparing the temperature of contents with the target heat retention temperature, the cooking appliance 1000 may determine whether the temperature of contents is equal to or greater than the target heat retention temperature.

According to an embodiment of the present disclosure, when the temperature of contents is less than the target heat retention temperature, the cooking appliance 1000 may continuously compare the temperature of contents with the target heat retention temperature while monitoring the temperature of contents. When the temperature of contents is less than the target heat retention temperature, the cooking appliance 1000 may continuously receive the first power (hereinafter, also referred to as the heat retention power) from the wireless power transmission device 2000, and a temperature of contents may increase up to the target heat retention temperature.

In operation S1260, when the temperature of contents is equal to or greater than the target heat retention temperature, the cooking appliance 1000 may transmit, to the wireless power transmission device 2000, power control information indicating to suspend transmission of the first power and then to re-transmit the first power in a wake-up time corresponding to the communication interval.

According to an embodiment of the present disclosure, when a temperature of contents is equal to or greater than the target heat retention temperature, the cooking appliance 1000 may suspend transmission of the first power for a preset time, thereby allowing the temperature of contents to fall below the target heat retention temperature. The cooking appliance 1000 may control the wireless power transmission device 2000 to re-transmit the first power in a wake-up time corresponding to the communication interval determined according to a temperature value of the target heat retention temperature so as to allow a temperature of the contents not to exceed a threshold range of the target heat retention temperature. When the wireless power transmission device 2000 re-transmits the first power, contents may be inductively reheated, and communication between the wireless power transmission device 2000 and the cooking appliance 1000 may be reconnected.

As operations S1240 to S1260 correspond to operations S1070 to S1090 of FIG. 10, detailed descriptions are not provided here.

Therefore, according to an embodiment of the present disclosure, the cooking appliance 1000 may appropriately adjust a communication interval, according to the target heat retention temperature, so that a temperature of the contents may be maintained within a threshold range (e.g., ±3° C.) of the target heat retention temperature.

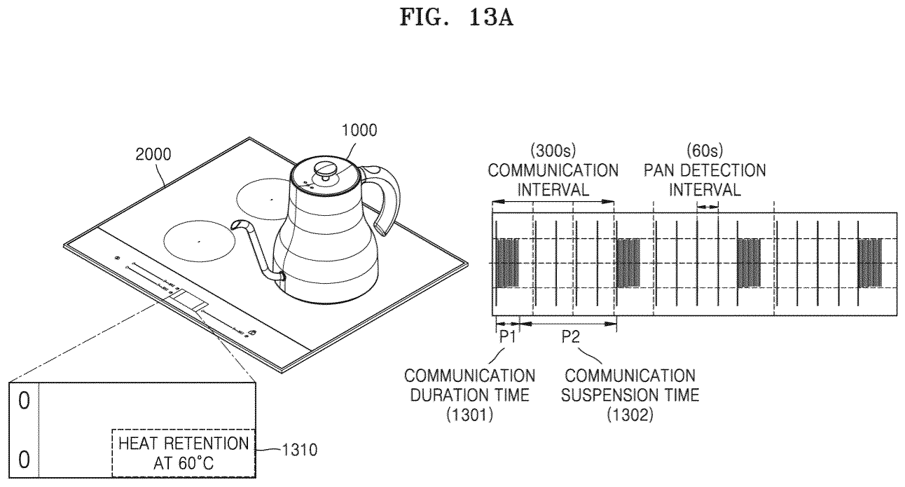

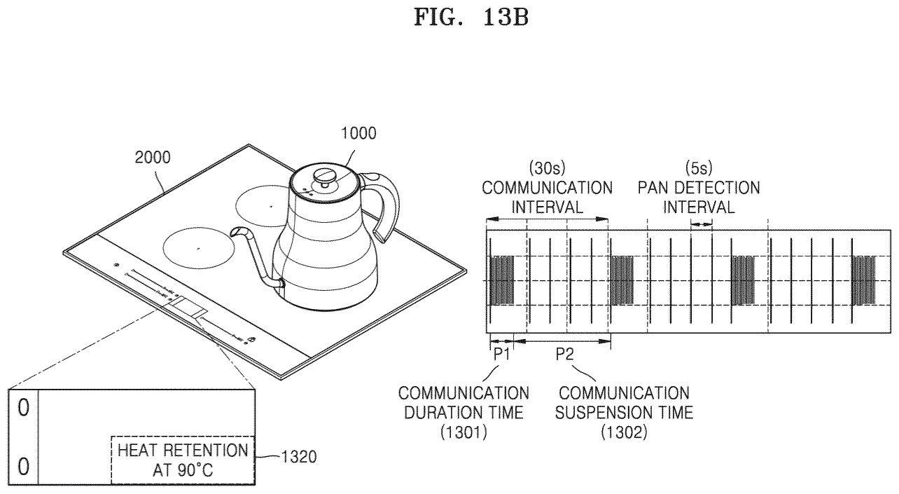

FIG. 13A is a diagram for describing an operation in which the cooking appliance 1000 determines a communication interval, based on a target heat retention temperature, according to an embodiment of the present disclosure.

Referring to FIG. 13A, a user may set the target heat retention temperature to 60° C. Here, a GUI 1310 indicating that contents in the cooking appliance 1000 are in heat retention at 60° C. may be displayed on a display of the wireless power transmission device 2000.

When the cooking appliance 1000 receives information indicating that the target heat retention temperature is set to 60° C., from the wireless power transmission device 2000, the cooking appliance 1000 may determine the communication interval to be 300 seconds. Therefore, when a temperature of contents is equal to or greater than 60° C., the cooking appliance 1000 may transmit, to the wireless power transmission device 2000, power control information indicating to suspend transmission of the first power (heat retention power) and then to re-transmit the first power (the heat retention power) after a preset time. Here, the preset time may be a time obtained by subtracting a communication duration time 1301 from 300 seconds. For example, when the communication duration time 1301 is 5 seconds, the wireless power transmission device 2000 may transmit power control information indicating to re-transmit the first power in 295 seconds. Alternatively, the cooking appliance 1000 may transmit, to the wireless power transmission device 2000, power control information indicating to re-transmit the first power in 300 seconds from a time when the first power has been transmitted.

According to an embodiment of the present disclosure, the cooking appliance 1000 may determine a pan detection interval, according to the target heat retention temperature. For example, when the target heat retention temperature is 60° C., the cooking appliance 1000 may determine the pan detection interval to be 60 seconds. The pan detection interval may indicate an interval at which the wireless power transmission device 2000 performs a pan detection operation. The pan detection operation indicates an operation in which the wireless power transmission device 2000 detects, by the container detection sensor 2410, whether the cooking appliance 1000 including an IH metal is placed on the top plate. The pan detection operation may be performed while the first power is transmitted or may be performed while the first power is suspended. During a time in which transmission of the first power is suspended (communication suspension time 1302), the wireless power transmission device 2000 may intermittently transmit power for performing the pan detection operation according to the pan detection interval. The power for performing the pan detection operation may have a power level equal to the first power, or may have a power level lower than the first power. Contents may be inductively heated by power the wireless power transmission device 2000 transmits to perform the pan detection operation. Therefore, the cooking appliance 1000 may determine the pan detection interval, in addition to the communication interval, so as to allow a temperature of contents to be maintained within the threshold range of the target heat retention temperature.

FIG. 13B is a diagram for describing an operation in which the cooking appliance 1000 determines a communication interval, based on a target heat retention temperature.

Referring to FIG. 13B, a user may set the target heat retention temperature to 90° C. Here, a GUI 1320 indicating that contents in the cooking appliance 1000 are in heat retention at 90° C. may be displayed on the display of the wireless power transmission device 2000.

When the cooking appliance 1000 receives, from the wireless power transmission device 2000, information indicating that the target heat retention temperature is set to 90° C., the cooking appliance 1000 may determine a communication interval to be 30 seconds. Therefore, when a temperature of contents is equal to or greater than 90° C., the cooking appliance 1000 may transmit, to the wireless power transmission device 2000, power control information indicating to suspend transmission of the first power (heat retention power) and then to re-transmit the first power (the heat retention power) after a preset time. Here, the preset time may be a time obtained by subtracting the communication duration time 1301 from 30 seconds. For example, when the communication duration time 1301 is 5 seconds, the wireless power transmission device 2000 may transmit power control information indicating to re-transmit the first power in 25 seconds. Alternatively, the cooking appliance 1000 may transmit, to the wireless power transmission device 2000, power control information indicating to re-transmit the first power in 30 seconds from a time when the first power has been transmitted.

According to an embodiment of the present disclosure, the cooking appliance 1000 may determine a pan detection interval, according to the target heat retention temperature. For example, when the target heat retention temperature is 90° C., the cooking appliance 1000 may determine the pan detection interval to be 5 seconds. According to an embodiment of the present disclosure, when the communication interval increases, the pan detection interval may also increase, and when the communication interval decreases, the pan detection interval may also decrease.

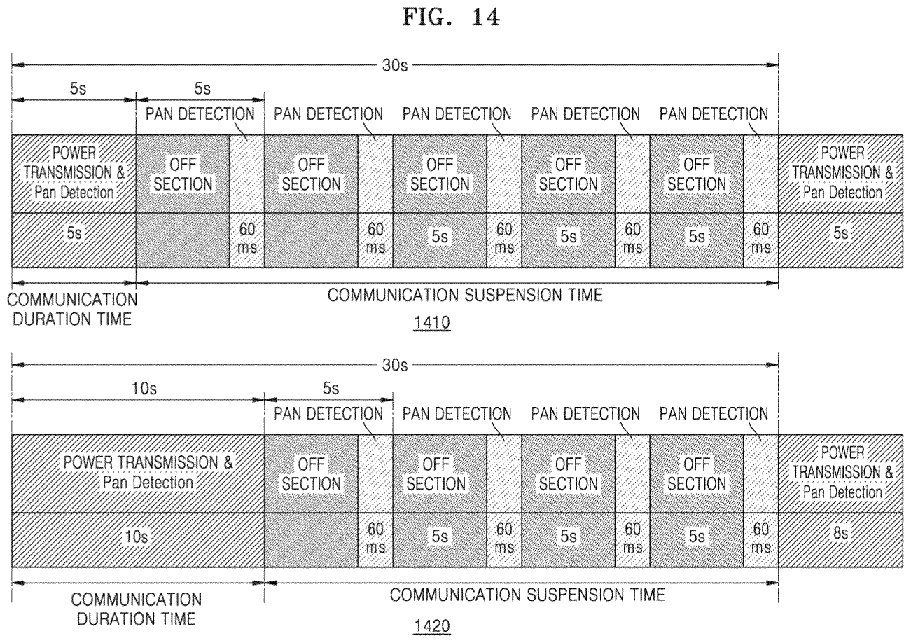

Hereinafter, the communication duration time 1301 and the communication suspension time 1302 will now be further described with reference to FIG. 14.

FIG. 14 is a diagram for describing variation in a communication duration section, according to an embodiment of the present disclosure.

Referring to FIG. 14, a communication duration time and a communication suspension time in a single interval of a communication interval determined by the cooking appliance 1000 may vary.

According to an embodiment of the present disclosure, a temperature of contents at a time when the communication interface 1030 of the cooking appliance 1000 is activated by re-receiving the first power (the heat retention power) from the wireless power transmission device 2000 may be lower than the target heat retention temperature. When a time in which a temperature of contents increases to reach the target heat retention temperature by the first power (the heat retention power) is large, a communication duration time may increase. However, when a time in which a temperature of contents increases to reach the target heat retention temperature by the first power (the heat retention power) is small, a communication duration time may decrease.

When the communication duration time increases in a single communication interval, the communication suspension time may decrease. For example, referring to a first diagram 1410, when the communication duration time is 5 seconds in the single communication interval (30 seconds), the communication suspension time may be 25 seconds. Then, 5 pan detection operations may be performed in the communication suspension time. The pan detection operation may be performed for 60 ms, but the present disclosure is not limited thereto. Referring to a second diagram 1420, when the communication duration time is 10 seconds in the single communication interval (30 seconds), the communication suspension time may be 20 seconds. Then, 4 pan detection operations may be performed in the communication suspension time.

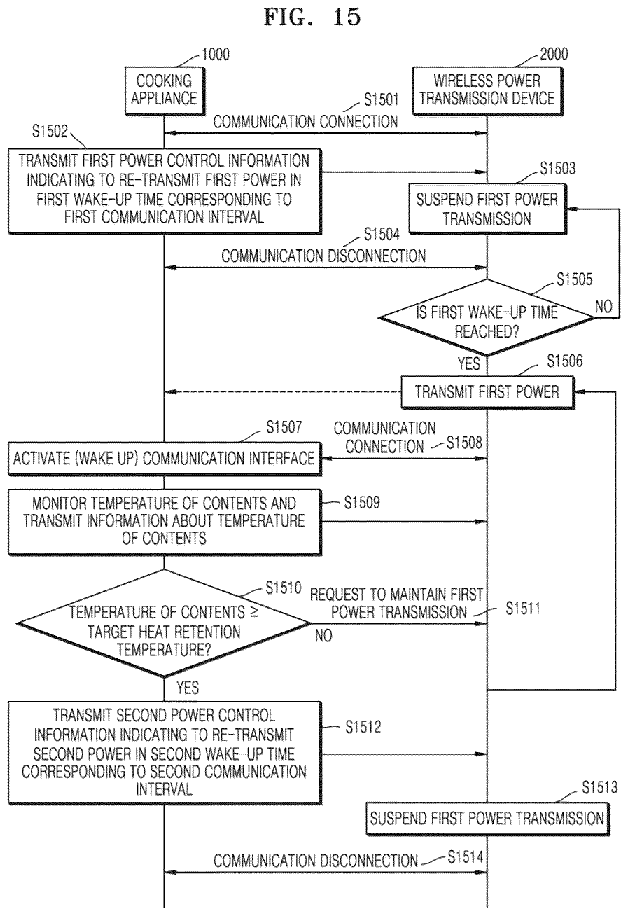

FIG. 15 is a flowchart for describing a method, performed by the cooking appliance 1000, of adaptively controlling transmission of first power, based on a result of comparison between a temperature of contents and a target heat retention temperature, according to an embodiment of the present disclosure.

In operation S1501, the cooking appliance 1000 and the wireless power transmission device 2000 may be connected for communication. For example, the cooking appliance 1000 and the wireless power transmission device 2000 may be connected for communication via short-range wireless communication (e.g., BLE communication).

According to an embodiment of the present disclosure, when a heat retention request is input from a user after the cooking appliance 1000 and the wireless power transmission device 2000 are connected for communication, the cooking appliance 1000 and the wireless power transmission device 2000 may operate in a heat retention mode.

When the wireless power transmission device 2000 transmits the first power (the heat retention power) to the cooking appliance 1000 so as to allow a temperature of contents to reach the target heat retention temperature, communication connection between the cooking appliance 1000 and the wireless power transmission device 2000 may be maintained, and the contents in the cooking appliance 1000 may be inductively heated.

In operation S1502, when a temperature of contents is equal to or greater than the target heat retention temperature, the cooking appliance 1000 may transmit, to the wireless power transmission device 2000, first power control information indicating to suspend transmission of the first power and then to re-transmit the first power in a first wake-up time corresponding to a first communication interval.

According to an embodiment of the present disclosure, the cooking appliance 1000 may determine the first communication interval, based on at least one of an amount of contents and a temperature value of the target heat retention temperature. The first communication interval may be determined so that a temperature of contents does not exceed a threshold range of the target heat retention temperature in the first wake-up time, but the present disclosure is not limited thereto.

As operation S1502 may correspond to S940 of FIG. 9, detailed descriptions are not provided here.

In operation S1503, the wireless power transmission device 2000 may suspend transmission of the first power, based on the first power control information. The first power is power capable of driving the communication interface 1030 of the cooking appliance 1000, and for example, the first power may be 200 W to 500 W, but the present disclosure is not limited thereto.

When the wireless power transmission device 2000 suspends transmission of the first power, a temperature of contents in the cooking appliance 1000 may slowly decrease.

In operation S1504, when the wireless power transmission device 2000 suspends transmission of the first power, communication between the wireless power transmission device 2000 and the cooking appliance 1000 may be disconnected When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

In operation S1505, the wireless power transmission device 2000 may determine whether the first wake-up time included in the first power control information has come.

According to an embodiment of the present disclosure, the wireless power transmission device 2000 may suspend transmission of the first power for driving the communication interface 1030 of the cooking appliance 1000 until the first power control information is received and then the first wake-up time comes. The wireless power transmission device 2000 may perform a pan detection operation while transmission of the first power is suspended. For example, the wireless power transmission device 2000 may perform the pan detection operation according to a pan detection interval included in the first power control information. That is, while communication between the wireless power transmission device 2000 and the cooking appliance 1000 is suspended, the wireless power transmission device 2000 may monitor whether the cooking appliance 1000 is removed from the wireless power transmission device 2000.

In operation S1506, when the first wake-up time has come, the wireless power transmission device 2000 may transmit, to the cooking appliance 1000, the first power for driving the communication interface 1030 of the cooking appliance 1000.

According to an embodiment of the present disclosure, the wireless power transmission device 2000 may transmit the first power to the cooking appliance 1000, based on the first power control information. For example, the wireless power transmission device 2000 may transmit the first power to the cooking appliance 1000, based on a power level value of the first power included in the first power control information. For example, when the power level value of the first power included in the first power control information is 250 W, the wireless power transmission device 2000 may transmit the first power with 250 W to the cooking appliance 1000.

In operation S1507, when the cooking appliance 1000 receives the first power from the wireless power transmission device 2000 via the pickup coil 1001, the cooking appliance 1000 may activate the communication interface 1030. In operation S1508, the wireless power transmission device 2000 and the cooking appliance 1000 may re-perform communication connection.

According to an embodiment of the present disclosure, the wireless power transmission device 2000 may the first power (e.g., 200 W) for driving the communication interface 1030 of the cooking appliance 1000 to the cooking appliance 1000, and may perform in a scan mode. When the cooking appliance 1000 receives the first power, the cooking appliance 1000 may drive the communication interface 1030 and may advertise a first packet including unique identification information (e.g., MAC address) and variable identification information of the cooking appliance 1000. The variable identification information may include, in the form of a UUID, product type information of the cooking appliance 1000 and information indicating that a cooking zone in which the cooking appliance 1000 is currently located is unknown.

The wireless power transmission device 2000 operating in the scan mode may receive the first packet advertised by the cooking appliance 1000, and when the first packet does not include information about a cooking zone in which the cooking appliance 1000 is located, the wireless power transmission device 2000 may operate in a cooking zone determination mode for checking a location of the cooking appliance 1000. For example, the wireless power transmission device 2000 may output (e.g., addressing) power according different power transmission patterns for respective cooking zones.

According to an embodiment of the present disclosure, the cooking appliance 1000 may detect a particular power transmission pattern, and may transmit (e.g., advertising) a second packet to the wireless power transmission device 2000, the second packet including information (current location information) about a cooking zone corresponding to the particular power transmission pattern and product type information. Varying identification information including the current location information and the product type information of the cooking appliance 1000 may be inserted into the second packet, in the form of a UUID. Also, the second packet may further include the unique identification information (e.g., a MAC address) of the cooking appliance 1000 and communication connection information.

The wireless power transmission device 2000 having received the second packet may transmit a connection request to the cooking appliance 1000, and when the cooking appliance 1000 accepts the connection request, the wireless power transmission device 2000 and the cooking appliance 1000 may be connected for connection. A short-range wireless communication channel (e.g., a BLE communication channel) may be established between the wireless power transmission device 2000 and the cooking appliance 1000.

In operation S1509, when the cooking appliance 1000 is connected for communication with the wireless power transmission device 2000, the cooking appliance 1000 may monitor a temperature of contents and may transmit information about the temperature of contents to the wireless power transmission device 2000.

According to an embodiment of the present disclosure, as transmission of the first power is suspended until the first wake-up time comes, a temperature of contents at a time when the cooking appliance 1000 is re-connected with the wireless power transmission device 2000 for communication may be less than the target heat retention temperature. When the first power is re-transmitted from the wireless power transmission device 2000, contents are inductively heated by the first power, and thus, a temperature of contents may gradually increase.

According to an embodiment of the present disclosure, when the first power is received again from the wireless power transmission device 2000, the cooking appliance 1000 may monitor a temperature of contents via the first temperature sensor 1006. The cooking appliance 1000 may transmit information about a temperature of contents to the wireless power transmission device 2000 via the short-range wireless communication channel (e.g., the BLE communication channel).

According to an embodiment of the present disclosure, the information about a temperature of contents may include temperature data of the contents, a temperature variation rate of the contents, an amount of contents identified based on a temperature variation rate when contents are heated, a temperature variation speed of the contents, etc., but the present disclosure is not limited thereto.

In operation S1510, the cooking appliance 1000 may determine whether a temperature of contents is equal to or greater than the target heat retention temperature. In operation S1511, when the temperature of contents is less than the target heat retention temperature, the cooking appliance 1000 may request the wireless power transmission device 2000 for maintenance of the first power. For example, when the temperature of contents is less than the target heat retention temperature, the cooking appliance 1000 may request maintenance of first power transmission while periodically communicating with the wireless power transmission device 2000.

In operation S1512, when a temperature of contents is equal to or greater than the target heat retention temperature, the cooking appliance 1000 may transmit second power control information indicating to suspend transmission of the first power and then to re-transmit the first power in a second wake-up time corresponding to a second communication interval.

According to an embodiment of the present disclosure, when a temperature of contents increases by the first power transmitted from the wireless power transmission device 2000 and then becomes the target heat retention temperature or higher, the cooking appliance 1000 may request the wireless power transmission device 2000 for suspension of first power transmission so as to allow a temperature of contents not to be higher than a threshold range (e.g., ±3) of the target heat retention temperature. Then, the cooking appliance 1000 may transmit, to the wireless power transmission device 2000, the second power control information indicating to re-transmit the first power in the second wake-up time corresponding to the second communication interval so as to prevent a temperature of contents from falling below the threshold range of the target heat retention temperature.

According to an embodiment of the present disclosure, the cooking appliance 1000 may determine the second communication interval, based on at least one of an amount of contents, the target heat retention temperature, and a difference between a first temperature of contents measured in the first wake-up time and the target heat retention temperature. For example, when the first temperature of contents measured in the first wake-up time is within the threshold range of the target heat retention temperature, the cooking appliance 1000 may determine the second communication interval to be equal to the first communication interval. However, when the first temperature of contents measured in the first wake-up time exceeds the threshold range of the target heat retention temperature, the cooking appliance 1000 may determine the second communication interval to be different from the first communication interval.

When an amount of contents decrease or the target heat retention temperature is adjusted to be high, compared to determination of the first communication interval, the cooking appliance 1000 may determine the second communication interval to be shorter than the first communication interval. On the contrary, when an amount of contents increase or the target heat retention temperature is adjusted to be low, compared to determination of the first communication interval, the cooking appliance 1000 may determine the second communication interval to be longer than the first communication interval.

In operation S1513, the wireless power transmission device 2000 may suspend transmission of the first power, according to the second power control information. When the wireless power transmission device 2000 suspends transmission of the first power, a temperature of contents in the cooking appliance 1000 may slowly decrease.

In operation S1514, communication between the cooking appliance 1000 and the wireless power transmission device 2000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

According to an embodiment of the present disclosure, when the cooking appliance 1000 wakes up as the wireless power transmission device 2000 re-transmits the first power, the cooking appliance 1000 may request the wireless power transmission device 2000 for transmission of the first power until a temperature of contents reaches again the target heat retention temperature, and may request suspension of first power transmission when a temperature of contents is equal to or greater than the target heat retention temperature. Accordingly, the cooking appliance 1000 may allow a temperature of contents to be maintained within a threshold range of the target heat retention temperature.

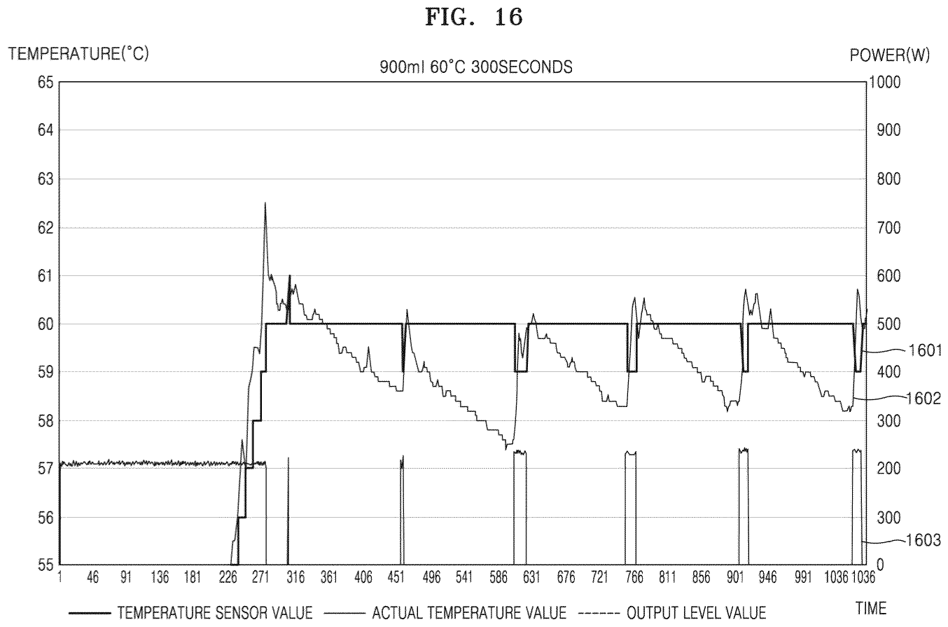

FIG. 16 is a diagram for describing temperature variation of contents while the cooking appliance 1000 operates in a heat retention mode, according to an embodiment of the present disclosure. With reference to FIG. 16, an example will now be described, in which an amount of contents in the cooking appliance 1000 is 900 ml, a target heat retention temperature is 60° C., and a communication interval is 300 seconds.

A first graph 1601 is a graph indicating temperature values measured by the cooking appliance 1000 via the first temperature sensor 1006. A second graph 1602 is a graph indicating temperature values of actual contents. A third graph 1603 is a graph indicating a first power value output from the wireless power transmission device 2000.

According to an embodiment of the present disclosure, when a temperature of contents is less than the target heat retention temperature, the wireless power transmission device 2000 may transmit first power (e.g., 230 W) to drive the PCB 1005 of the cooking appliance 1000 until a temperature of the contents reaches the target heat retention temperature. Afterward, when a temperature of the contents reaches the target heat retention temperature, the cooking appliance 1000 may allow the wireless power transmission device 2000 to suspend transmission of the first power. When the wireless power transmission device 2000 suspends transmission of the first power, a temperature of the contents may naturally decrease, and the cooking appliance 1000 cannot measure a temperature of the contents.

The wireless power transmission device 2000 may first output first power during a minimum time for measurement of a temperature of the contents in a next communication interval (wake-up time). When the first power is output from the wireless power transmission device 2000, the controller 1020 and the communication interface 1030 included in the PCB 1005 may be woken up. Here, the controller 1020 may check a temperature of contents via the first temperature sensor 1006, and may determine whether it is necessary to additionally transmit the first power, according to the temperature of contents. For example, when a temperature of contents reaches the target heat retention temperature by first power transmission during a minimum time for measurement of a temperature of contents, the controller 1020 of the cooking appliance 1000 may determine that it is not necessary to additionally transmit the first power, and may request the wireless power transmission device 2000 for suspension of the first power. On the other hand, when a temperature of contents does not reach the target heat retention temperature by first power transmission during a minimum time for measurement of a temperature of contents, the cooking appliance 1000 may determine that it is necessary to additionally transmit the first power, and may not request the wireless power transmission device 2000 for suspension of the first power. Therefore, when it is necessary to additionally transmit the first power for the cooking appliance 1000 to increase a temperature of contents, the wireless power transmission device 2000 may maintain transmission of the first power.

Referring to the third graph 1603, it is apparent that a length of a time for the wireless power transmission device 2000 to supply the first power to the cooking appliance 1000 varies. For example, in a first wake-up time (X-axis value 301) and a second wake-up time (X-axis value 451), the wireless power transmission device 2000 outputs the first power during a short time, thereby performing inductive heating for heat retention of contents. As a temperature of contents is measured, by the cooking appliance 1000, as 60° C. that is the target heat retention temperature, the wireless power transmission device 2000 suspends transmission of the first power.

On the other hand, in a third wake-up time (X-axis value 601) and a fourth wake-up time (X-axis value 751), the wireless power transmission device 2000 outputs the first power during a longer time, thereby performing inductive heating for heat retention of contents. As a temperature of contents is measured, by the cooking appliance 1000, as 60° C. that is the target heat retention temperature, the wireless power transmission device 2000 suspends transmission of the first power.

Referring to the first graph 1610, when the cooking appliance 1000 determines a communication interval to be 300 seconds, based on an amount (900 ml) of contents and the target heat retention temperature (60° C.), and allows the wireless power transmission device 2000 to output the first power once in every 300 seconds for heat retention and communication connection, a temperature of contents may be maintained within a threshold range (e.g., 60±3) of the target heat retention temperature.

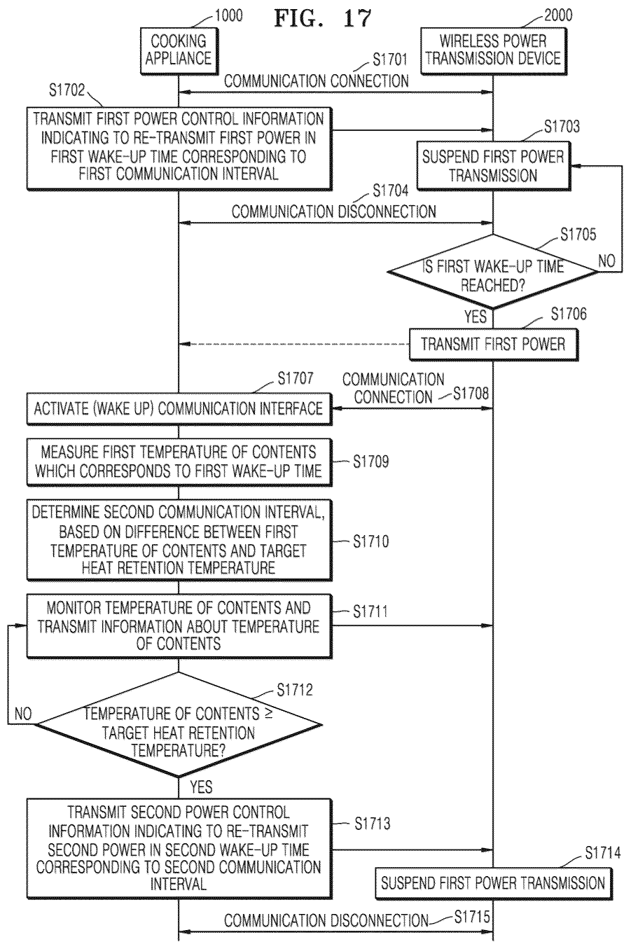

FIG. 17 is a flowchart for describing a method, performed by the cooking appliance 1000, of determining a next communication interval, based on a difference between a temperature of contents in wake up and a target heat retention temperature, according to an embodiment of the present disclosure.

In operation S1701, the cooking appliance 1000 and the wireless power transmission device 2000 may be connected for communication. For example, the cooking appliance 1000 and the wireless power transmission device 2000 may be connected for communication via short-range wireless communication (e.g., BLE communication).

According to an embodiment of the present disclosure, when a heat retention request is input from a user after the cooking appliance 1000 and the wireless power transmission device 2000 are connected for communication, the cooking appliance 1000 and the wireless power transmission device 2000 may operate in a heat retention mode.

When the wireless power transmission device 2000 transmits the first power (the heat retention power) to the cooking appliance 1000 so as to allow a temperature of contents to reach the target heat retention temperature, communication connection between the cooking appliance 1000 and the wireless power transmission device 2000 may be maintained, and the contents in the cooking appliance 1000 may be inductively heated.

In operation S1702, when a temperature of contents is equal to or greater than the target heat retention temperature, the cooking appliance 1000 may transmit, to the wireless power transmission device 2000, first power control information indicating to suspend transmission of the first power and then to re-transmit the first power in a first wake-up time corresponding to a first communication interval.

In operation S1703, the wireless power transmission device 2000 may suspend transmission of the first power, based on the first power control information. The first power is power capable of driving the communication interface 1030 of the cooking appliance 1000, and for example, the first power may be 200 W to 500 W, but the present disclosure is not limited thereto. When the wireless power transmission device 2000 suspends transmission of the first power, a temperature of the contents may naturally decrease.

In operation S1704, when the wireless power transmission device 2000 suspends transmission of the first power, communication between the wireless power transmission device 2000 and the cooking appliance 1000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

In operation S1705, the wireless power transmission device 2000 may determine whether the first wake-up time included in the first power control information has come. According to an embodiment of the present disclosure, the wireless power transmission device 2000 may suspend transmission of the first power for driving the communication interface 1030 of the cooking appliance 1000 until the first power control information is received and then the first wake-up time comes.

In operation S1706, when the first wake-up time has come, the wireless power transmission device 2000 may transmit, to the cooking appliance 1000, the first power to the cooking appliance 1000, based on first power control information.

In operation S1707, when the cooking appliance 1000 receives the first power from the wireless power transmission device 2000 via the pickup coil 1001, the cooking appliance 1000 may activate the communication interface 1030. In operation S1708, the wireless power transmission device 2000 and the cooking appliance 1000 may re-perform communication connection. For example, the wireless power transmission device 2000 and the cooking appliance 1000 may re-establish a short-range wireless communication channel (e.g., a BLE communication channel). As operation S1708 corresponds to S1508 of FIG. 15, detailed descriptions are not provided here.

In operation S1709, the cooking appliance 1000 may measure a first temperature of contents which corresponds to a first wake-up time. For example, when the first power is supplied from the wireless power transmission device 2000 in the first wake-up time, the cooking appliance 1000 may immediately measure a temperature of contents via the first temperature sensor 1006 as soon as the controller 1020 is activated. The temperature of contents which is immediately measured in the first wake-up time via the first temperature sensor 1006 as soon as the controller 1020 is activated may be defined as a first temperature of contents.

In operation S1710, the cooking appliance 1000 may determine a second communication interval, based on a difference between the first temperature of contents and the target heat retention temperature.

According to an embodiment of the present disclosure, when the difference between the first temperature of contents and the target heat retention temperature is equal to or greater than a first threshold value, the cooking appliance 1000 may determine the second communication interval to be shorter than the first communication interval, and when the difference between the first temperature of contents and the target heat retention temperature is equal to or less than a second threshold value, the cooking appliance 1000 may determine the second communication interval to be longer than the first communication interval. Here, the second threshold value may be a value smaller than the first threshold value.

For example, when the difference between the first temperature of contents and the target heat retention temperature is equal to or greater than 3° C., the cooking appliance 1000 may determine the second communication interval to be shorter than the first communication interval, when the difference between the first temperature of contents and the target heat retention temperature is equal to or less than 1° C., the cooking appliance 1000 may determine the second communication interval to be longer than the first communication interval, and when the difference between the first temperature of contents and the target heat retention temperature is greater than 1° C. and less than 3° C., the cooking appliance 1000 may determine the second communication interval to be equal to the first communication interval.

For example, in a case where the target heat retention temperature is 60° C., and the first communication interval is 300 seconds, when the first temperature of contents is 55° C., the cooking appliance 1000 may determine 270 seconds to be the second communication interval which is decreased by 10%, compared to the first communication interval.

In operation S1711, when the cooking appliance 1000 is connected to communicate with the wireless power transmission device 2000, the cooking appliance 1000 may monitor a temperature of contents, and may transmit information about the temperature of contents to the wireless power transmission device 2000.

According to an embodiment of the present disclosure, as transmission of the first power is suspended until the first wake-up time comes, a temperature of contents at a time when the cooking appliance 1000 is re-connected with the wireless power transmission device 2000 for communication, a temperature of contents may be less than the target heat retention temperature. When the first power is re-transmitted from the wireless power transmission device 2000, contents may be inductively heated by the first power, such that a temperature of contents may gradually increase.

According to an embodiment of the present disclosure, when the first power is re-transmitted from the wireless power transmission device 2000, the cooking appliance 1000 may monitor a temperature of contents via the first temperature sensor 1006. The cooking appliance 1000 may transmit data about a temperature of contents to the wireless power transmission device 2000 via the short-range wireless communication channel (e.g., the BLE communication channel).

In operation S1712, the cooking appliance 1000 may determine whether a temperature of contents is equal to or greater than the target heat retention temperature. When a temperature of contents is less than the target heat retention temperature, the cooking appliance 1000 may continuously monitor a temperature of contents.

In operation S1713, when a temperature of contents is equal to or greater than the target heat retention temperature, the cooking appliance 1000 may transmit second control power information indicating to re-transmit the first power in a second wake-up time corresponding to a second communication interval.

According to an embodiment of the present disclosure, when a temperature of contents increases by the first power transmitted from the wireless power transmission device 2000 and then becomes the target heat retention temperature or higher, the cooking appliance 1000 may request the wireless power transmission device 2000 for suspension of first power transmission so as to allow a temperature of contents not to be higher than a threshold range (e.g., ±3) of the target heat retention temperature. Then, the cooking appliance 1000 may transmit, to the wireless power transmission device 2000, the second power control information indicating to re-transmit the first power in the second wake-up time corresponding to the second communication interval so as to prevent a temperature of contents from falling below the threshold range of the target heat retention temperature.

In operation S1714, the wireless power transmission device 2000 may suspend transmission of the first power, according to the second power control information. When the wireless power transmission device 2000 suspends transmission of the first power, a temperature of contents in the cooking appliance 1000 may slowly decrease.

In operation S1715, communication between the cooking appliance 1000 and the wireless power transmission device 2000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

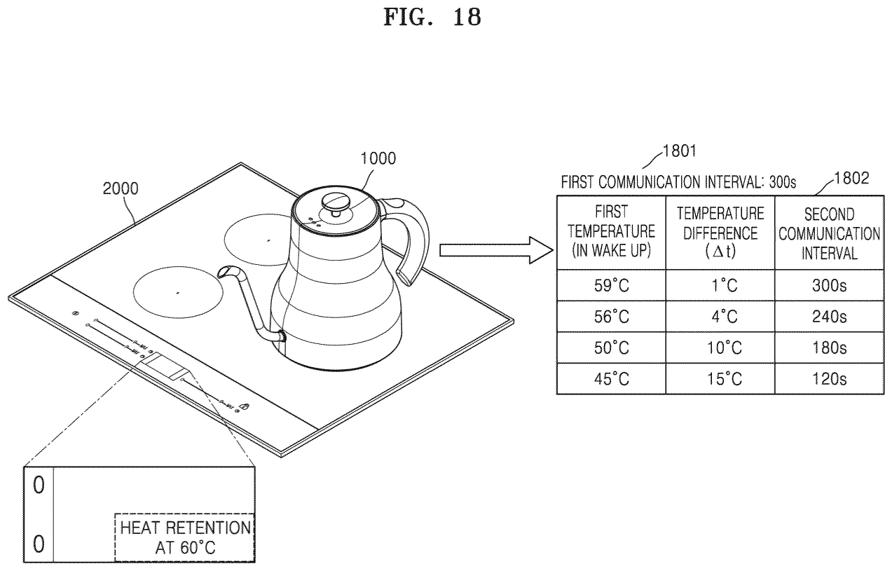

Hereinafter, with reference to FIG. 18, an operation in which the cooking appliance 1000 determines a next communication interval when re-connected with the wireless power transmission device 2000 for communication will be further described.

FIG. 18 is a diagram for describing an operation in which the cooking appliance 1000 determines a next communication interval, based on a difference between a temperature of contents in wake up and a target heat retention temperature, according to an embodiment of the present disclosure. With reference to FIG. 18, an example will be described, in which a first communication interval 1801 is 300 seconds, and a target heat retention temperature is 60° C.

As the wireless power transmission device 2000 outputs the first power in the first wake-up time corresponding to the first communication interval 1801, the cooking appliance 1000 and the wireless power transmission device 2000 may be re-connected for communication. Here, the cooking appliance 1000 may measure a first temperature of contents which corresponds to the first wake-up time, and may determine a second communication interval 1802 that is a next communication interval, according to a difference between the first temperature and the target heat retention temperature. For example, when the difference between the first temperature of contents and the target heat retention temperature is 2° C. that is within a threshold range, the cooking appliance 1000 may determine the second communication interval 1802 to be 300 seconds, equally to the first communication interval 1801.

When the difference between the first temperature of contents and the target heat retention temperature is greater than 3° C. that is the threshold range, the cooking appliance 1000 may determine the second communication interval 1802 to be shorter than the first communication interval 1801. For example, when the difference between the first temperature of contents and the target heat retention temperature is 4° C., the cooking appliance 1000 may determine the second communication interval to be 240 seconds, when the difference between the first temperature of contents and the target heat retention temperature is 10° C., the cooking appliance 1000 may determine the second communication interval to be 180 seconds, and when the difference between the first temperature of contents and the target heat retention temperature is 15° C., the cooking appliance 1000 may determine the second communication interval to be 120 seconds, but the present disclosure is not limited thereto.

When the cooking appliance 1000 receives the first power in the second wake-up time corresponding to the second communication interval 1802, the cooking appliance 1000 may determine a third communication interval that is a next communication interval. Here, the third communication interval may be determined by a difference between a second temperature of contents which is measured in the second wake-up time and the target heat retention temperature. For example, when the second temperature of contents is 55° C., the cooking appliance 1000 may determine the third communication interval to be a value which is decreased by 10%, compared to the second communication interval 1802. That is, when the second communication interval 1802 is 300 seconds, the third communication interval may be determined to be 270 seconds.

Also, when the first temperature of contents which is measured in the first wake-up time is 59° C., and the second temperature of contents which is measured in the second wake-up time is 59° C., the cooking appliance 1000 may determine the third communication interval to be a value which is increased by 10%, compared to the second communication interval 1802. That is, when the second communication interval 1802 is 300 seconds, the third communication interval may be determined to be 330 seconds.

According to an embodiment of the present disclosure, when the cooking appliance 1000 is re-connected with the wireless power transmission device 2000 for communication, the cooking appliance 1000 may determine a next communication interval, based on a difference between a temperature of contents and the target heat retention temperature, thereby allowing the temperature of the contents to be maintained within a threshold range of the target heat retention temperature.

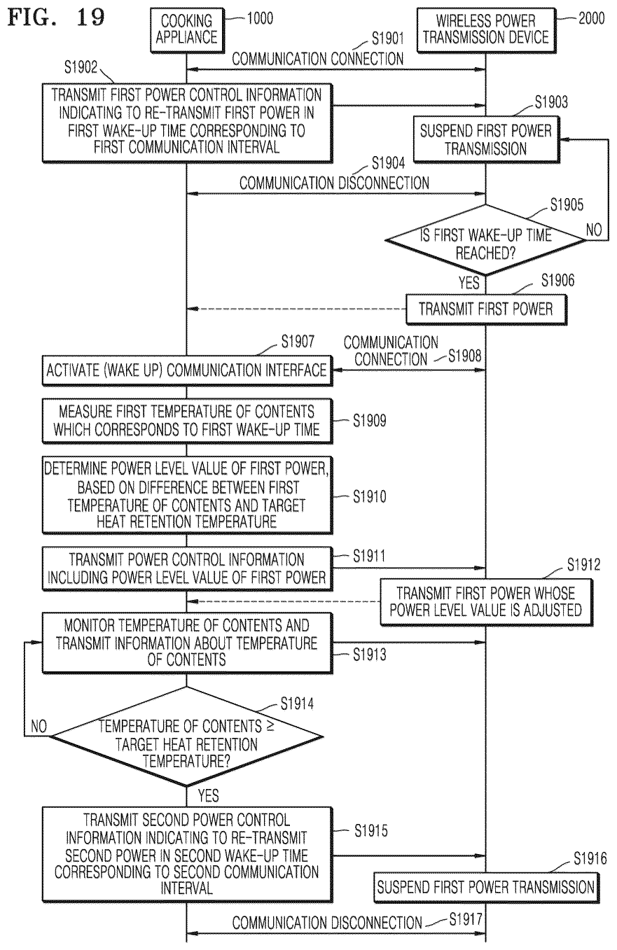

FIG. 19 is a flowchart for describing a method, performed by the cooking appliance 1000, of determining a power level value, based on a difference between a temperature of contents in wake up and a target heat retention temperature, according to an embodiment of the present disclosure.

In operation S1901, the cooking appliance 1000 and the wireless power transmission device 2000 may be connected for communication. For example, the cooking appliance 1000 and the wireless power transmission device 2000 may be connected for communication via short-range wireless communication (e.g., BLE communication).

According to an embodiment of the present disclosure, when a heat retention request is input from a user after the cooking appliance 1000 and the wireless power transmission device 2000 are connected for communication, the cooking appliance 1000 and the wireless power transmission device 2000 may operate in a heat retention mode.

When the wireless power transmission device 2000 transmits the first power (the heat retention power) to the cooking appliance 1000 so as to allow a temperature of contents to reach the target heat retention temperature, communication connection between the cooking appliance 1000 and the wireless power transmission device 2000 may be maintained, and the contents in the cooking appliance 1000 may be inductively heated.

In operation S1902, when a temperature of contents is equal to or greater than the target heat retention temperature, the cooking appliance 1000 may transmit, to the wireless power transmission device 2000, first power control information indicating to suspend transmission of the first power and then to re-transmit the first power in a first wake-up time corresponding to a first communication interval.

In operation S1903, the wireless power transmission device 2000 may suspend transmission of the first power, based on the first power control information. The first power is power capable of driving the communication interface 1030 of the cooking appliance 1000, and for example, the first power may be 200 W to 500 W, but the present disclosure is not limited thereto. When the wireless power transmission device 2000 suspends transmission of the first power, a temperature of the contents in the cooking appliance 1000 may naturally decrease.

In operation S1904, when the wireless power transmission device 2000 suspends transmission of the first power, communication between the wireless power transmission device 2000 and the cooking appliance 1000 may be disconnected.

In operation S1905, the wireless power transmission device 2000 may determine whether the first wake-up time included in the first power control information has come.

In operation S1906, when the first wake-up time has come, the wireless power transmission device 2000 may transmit, to the cooking appliance 1000, the first power to the cooking appliance 1000, based on the first power control information.

In operation S1907, when the cooking appliance 1000 receives the first power from the wireless power transmission device 2000 via the pickup coil 1001, the cooking appliance 1000 may activate the communication interface 1030. In operation S1908, the wireless power transmission device 2000 and the cooking appliance 1000 may re-perform communication connection. For example, the wireless power transmission device 2000 and the cooking appliance 1000 may re-establish a short-range wireless communication channel (e.g., a BLE communication channel).

In operation S1909, the cooking appliance 1000 may measure a first temperature of contents which corresponds to a first wake-up time. For example, when the first power is supplied from the wireless power transmission device 2000 in the first wake-up time, the cooking appliance 1000 may immediately measure a temperature of contents via the first temperature sensor 1006 as soon as the controller 1020 is activated. The temperature of contents which is immediately measured in the first wake-up time via the first temperature sensor 1006 as soon as the controller 1020 is activated may be defined as a first temperature of contents.

As operations S1901 to S1909 correspond to operations S1701 to S1709 of FIG. 17, detailed descriptions are not provided here.

In operation S1910, the cooking appliance 1000 may determine a power level value of first power, based on a difference between the first temperature of contents and the target heat retention temperature.

According to an embodiment of the present disclosure, when the difference between the first temperature of contents and the target heat retention temperature increases, the cooking appliance 1000 may determine the power level value of first power to be high, and when the difference between the first temperature of contents and the target heat retention temperature decreases, the cooking appliance 1000 may determine the power level value of first power to be low.

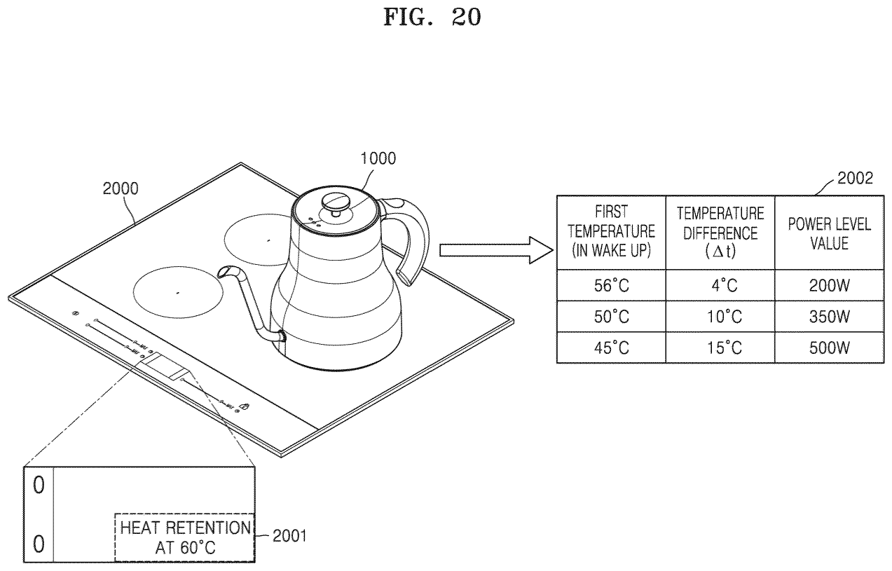

For example, referring to FIG. 20, when a difference between the first temperature of contents and the target heat retention temperature (60° C.) is 4° C., the cooking appliance 1000 may determine a power level value 2002 of first power to be 200 W, when a difference between the first temperature of contents and the target heat retention temperature (60° C.) is 10° C., the cooking appliance 1000 may determine the power level value 2002 of first power to be 350 W, and when a difference between the first temperature of contents and the target heat retention temperature (60° C.) is 15° C., the cooking appliance 1000 may determine the power level value 2002 of first power to be 500 W.

According to an embodiment of the present disclosure, when a difference between the first temperature of contents and the target heat retention temperature increases, the cooking appliance 1000 determines a power level value of the first power to be high, thereby allowing a temperature of contents to rapidly reach the target heat retention temperature.

In operation S1911, the cooking appliance 1000 may transmit power control information including the power level value of the first power. For example, the cooking appliance 1000 may transmit the power control information including the power level value of the first power to the wireless power transmission device 2000 via a short-range wireless communication channel.

In operation S1912, the wireless power transmission device 2000 may transmit first power whose power level value is adjusted, based on the power control information. Contents in the cooking appliance 1000 may be inductively heated by the first power whose power level value is adjusted, and a temperature of the contents may increase.

In operation S1913, the cooking appliance 1000 may monitor a temperature of contents, and may transmit information about the temperature of contents to the wireless power transmission device 2000. While communication connection with the wireless power transmission device 2000 is maintained, the cooking appliance 1000 may measure a temperature of contents via the first temperature sensor 1006, and may transmit data about the temperature of contents to the wireless power transmission device 2000 via the communication interface 1030.

In operation S1914, the cooking appliance 1000 may determine whether a temperature of contents is equal to or greater than the target heat retention temperature. When the temperature of contents is less than the target heat retention temperature, the cooking appliance 1000 may continuously monitor a temperature of contents.

In operation S1915, when the temperature of contents is equal to or greater than the target heat retention temperature, the cooking appliance 1000 may transmit second control power information indicating to re-transmit the first power in a second wake-up time corresponding to a second communication interval.

In operation S1916, the wireless power transmission device 2000 may suspend transmission of the first power, based on the second power control information. When the wireless power transmission device 2000 suspends transmission of the first power, a temperature of contents in the cooking appliance 1000 may slowly decrease.

In operation S1917, communication between the cooking appliance 1000 and the wireless power transmission device 2000 may be disconnected When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

FIG. 21 is a flowchart for describing a method, performed by the cooking appliance 1000, of adjusting a pan detection interval, based on a difference between a temperature of contents in wake up and a target heat retention temperature, according to an embodiment of the present disclosure.

In operation S2101, the cooking appliance 1000 and the wireless power transmission device 2000 may be connected for communication. For example, the cooking appliance 1000 and the wireless power transmission device 2000 may be connected for communication via short-range wireless communication (e.g., BLE communication).

According to an embodiment of the present disclosure, when a heat retention request is input from a user after the cooking appliance 1000 and the wireless power transmission device 2000 are connected for communication, the cooking appliance 1000 and the wireless power transmission device 2000 may operate in a heat retention mode.

When the wireless power transmission device 2000 transmits the first power (the heat retention power) to the cooking appliance 1000 so as to allow a temperature of contents to reach the target heat retention temperature, communication connection between the cooking appliance 1000 and the wireless power transmission device 2000 may be maintained, and the contents in the cooking appliance 1000 may be inductively heated.

In operation S2102, when a temperature of contents is equal to or greater than the target heat retention temperature, the cooking appliance 1000 may transmit, to the wireless power transmission device 2000, first power control information indicating to suspend transmission of the first power and then to re-transmit the first power in a first wake-up time corresponding to a first communication interval.

In operation S2103, the wireless power transmission device 2000 may suspend transmission of the first power, based on the first power control information. The first power is power capable of driving the communication interface 1030 of the cooking appliance 1000, and for example, the first power may be 200 W to 500 W, but the present disclosure is not limited thereto. When the wireless power transmission device 2000 suspends transmission of the first power, a temperature of the contents in the cooking appliance 1000 may naturally decrease.

In operation S2104, when the wireless power transmission device 2000 suspends transmission of the first power, communication between the wireless power transmission device 2000 and the cooking appliance 1000 may be disconnected.

In operation S2105, the wireless power transmission device 2000 may determine whether the first wake-up time included in the first power control information has come.

In operation S2106, when the first wake-up time has come, the wireless power transmission device 2000 may re-transmit, to the cooking appliance 1000, the first power to the cooking appliance 1000, based on the first power control information.

In operation S2107, when the cooking appliance 1000 receives the first power from the wireless power transmission device 2000 via the pickup coil 1001, the cooking appliance 1000 may activate the communication interface 1030. In operation S2108, the wireless power transmission device 2000 and the cooking appliance 1000 may re-perform communication connection. For example, the wireless power transmission device 2000 and the cooking appliance 1000 may re-establish a short-range wireless communication channel (e.g., a BLE communication channel).

In operation S2109, the cooking appliance 1000 may measure a first temperature of contents which corresponds to a first wake-up time. For example, when the first power is supplied from the wireless power transmission device 2000 in the first wake-up time, the cooking appliance 1000 may immediately measure a temperature of contents via the first temperature sensor 1006 as soon as the controller 1020 is activated. The temperature of contents which is immediately measured in the first wake-up time via the first temperature sensor 1006 as soon as the controller 1020 is activated may be defined as a first temperature of contents.

As operations S2101 to S2109 correspond to operations S1701 to S1709 of FIG. 17, detailed descriptions are not provided here.

In operation S2110, the cooking appliance 1000 may adjust a pan detection interval, based on a difference between the first temperature of contents and the target heat retention temperature.

According to an embodiment of the present disclosure, when the difference between the first temperature of contents and the target heat retention temperature increases, the cooking appliance 1000 may adjust the pan detection interval to be short. When the difference between the first temperature of contents and the target heat retention temperature decreases, the cooking appliance 1000 may adjust the pan detection interval to be long. For example, when the target heat retention temperature is 60° C., and a first temperature of contents is 59° C., the cooking appliance 1000 may determine a pan detection interval to be 70 seconds that is longer than a previous pan detection interval (e.g., 60 seconds). When the target heat retention temperature is 60° C., and a first temperature of contents is 56° C., the cooking appliance 1000 may determine the pan detection interval to be 50 seconds that is shorter than the previous pan detection interval (e.g., 60 seconds).

According to an embodiment of the present disclosure, when the difference between the first temperature of contents and the target heat retention temperature is within a preset range, the cooking appliance 1000 may changelessly maintain the previous pan detection interval. For example, when the target heat retention temperature is 60° C., and a first temperature of contents is 58° C., the cooking appliance 1000 may determine the pan detection interval as the previous pan detection interval (e.g., 60 seconds).

In operation S2111, the cooking appliance 1000 may monitor a temperature of contents, and may transmit information about the temperature of contents to the wireless power transmission device 2000. While communication connection with the wireless power transmission device 2000 is maintained, the cooking appliance 1000 may measure a temperature of contents via the first temperature sensor 1006, and may transmit data about the temperature of contents to the wireless power transmission device 2000 via the communication interface 1030.

In operation S2112, after the cooking appliance 1000 is re-connected with the wireless power transmission device 2000 for communication, the cooking appliance 1000 may determine whether a preset time elapses.

According to an embodiment of the present disclosure, the preset time may be a minimum time in which the cooking appliance 1000 is re-connected with the wireless power transmission device 2000 for communication, and measures a temperature of contents via the first temperature sensor 1006, but the present disclosure is not limited thereto. The preset time may be a time set by the cooking appliance 1000, may be a time set during manufacture of the cooking appliance 1000, or may be a time set by an administrator.

When the preset time is not elapsed, the cooking appliance 1000 may monitor a temperature of contents, and may transmit information about the temperature of contents to the wireless power transmission device 2000.

In operation S2113, when the preset time elapses after the cooking appliance 1000 is re-connected with the wireless power transmission device 2000 for communication, the cooking appliance 1000 may transmit second power control information including the pan detection interval and the second wake-up time to the wireless power transmission device 2000.

According to an embodiment of the present disclosure, when the preset time expires, the cooking appliance 1000 may transmit the second power control information including the pan detection interval and the second wake-up time to the wireless power transmission device 2000, regardless of whether a temperature of contents reaches the target heat retention temperature. Therefore, a communication duration time may be fixed within a single communication interval.

A delay may exist between an actual temperature of contents and a temperature of the contents which is detected by the controller 1020 via the first temperature sensor 1006. For example, a temperature of the contents which is detected by the controller 1020 via the first temperature sensor 1006 may not be a current temperature of the contents but may be a temperature of the contents before 1 second. Also, as it takes time that an influence of the first power transmitted from the wireless power transmission device 2000 is reflected on a temperature of contents, even when the wireless power transmission device 2000 suspends transmission of the first power, the temperature of contents does not immediately decrease but increases and then decreases. Therefore, in order to prevent a temperature of contents from exceeding a threshold range of the target heat retention temperature and being overheated, the cooking appliance 1000 may suspend transmission of the first power when the preset time elapses before a temperature of contents reaches the target heating temperature. Also, the cooking appliance 1000 may appropriately adjust the pan detection interval so as to prevent a temperature of contents from falling below the threshold range of the target heat retention temperature.

In operation S2114, the wireless power transmission device 2000 may suspend transmission (output) of the first power, based on the second power control information. When the wireless power transmission device 2000 suspends transmission of the first power, a temperature of contents in the cooking appliance 1000 may slowly decrease.

In operation S2115, communication between the cooking appliance 1000 and the wireless power transmission device 2000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

In operation S2116, while transmission of the first power for driving the communication interface 1030 of the cooking appliance 1000 is suspended, the wireless power transmission device 2000 may perform the pan detection operation according to the pan detection interval included in the first power control information. For example, the cooking appliance 1000 may periodically output power for detecting a pan, and may monitor variation in a current value (inductance) of a working coil. That is, the wireless power transmission device 2000 may monitor whether the cooking appliance 1000 is deleted from the wireless power transmission device 2000 while communication between the wireless power transmission device 2000 and the cooking appliance 1000 is disconnected.

When the wireless power transmission device 2000 outputs power for pan detection, contents in the cooking appliance 1000 may be inductively heated by the power for pan detection. Therefore, when the pan detection interval is short, a speed with which a temperature of contents decreases may become slow.

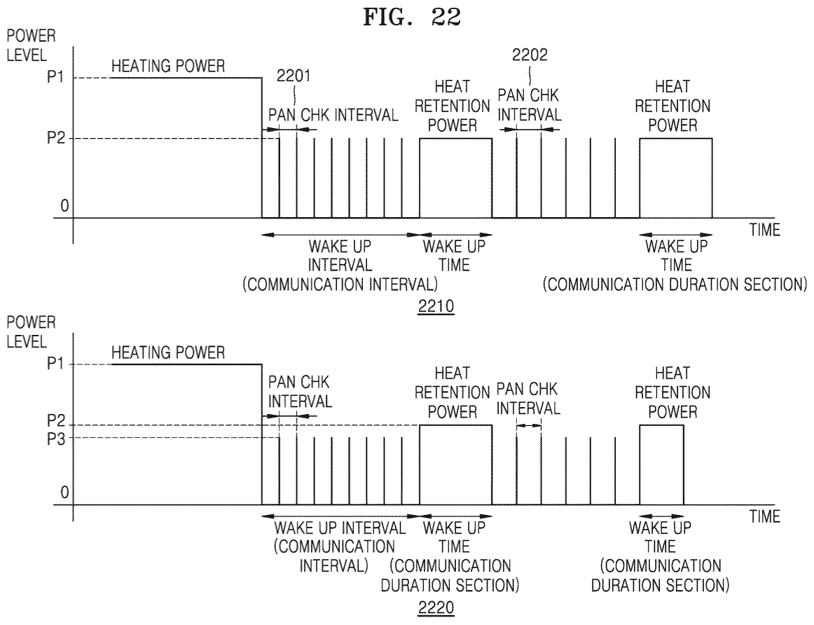

FIG. 22 is a diagram for describing a pan detection interval and a power level value, according to an embodiment of the present disclosure.

Referring to 2210 of FIG. 22, the wireless power transmission device 2000 may output heating power while contents in the cooking appliance 1000 are heated, and may output heat retention power at regular intervals (communication intervals) while the contents are in heat retention. A power level value P2 of the heat retention power may be less than a power level value P1 of the heating power. For example, the power level value P2 of the heat retention power may be between 200 W and 500 W, and the power level value P1 of the heating power may be equal to or greater than 1000 W.

When a target heating temperature is 100° C., and a target heat retention temperature is 60° C., the wireless power transmission device 2000 may output the heating power until a temperature of contents reaches the target heating temperature (100° C.). When a temperature of contents reaches the target heating temperature (100° C.), the wireless power transmission device 2000 may suspend output of the heating power. The wireless power transmission device 2000 does not output the heating power and the heat retention power and performs only a pan detection operation until a temperature of contents falls below the target heat retention temperature (60° C.).

The wireless power transmission device 2000 may output the heat retention power in a wake-up time corresponding to a communication interval. When the controller 1020 and the communication interface 1030 of the cooking appliance 1000 are woken up by the heat retention power, the cooking appliance 1000 may identify a temperature of contents. When a temperature of contents is less than the target heat retention temperature (60° C.), the cooking appliance 1000 may adjust the pan detection interval, based on a difference between a temperature of contents in wake up and the target heat retention temperature. For example, when the difference between a temperature of contents and the target heat retention temperature is small, the cooking appliance 1000 may increase the pan detection interval. For example, the pan detection interval may be adjusted from a first pan detection interval 2201 to a second pan detection interval 2202.

The cooking appliance 1000 may identify a temperature of contents and receive heat retention power only for a minimum preset time for adjustment of the pan detection interval, and then may transmit, to the wireless power transmission device 2000, power control information indicating to suspend transmission of the heat retention power.

According to an embodiment of the present disclosure, the cooking appliance 1000 may receive the heat retention power only for a fixed time so as to prevent a temperature of contents from exceeding a threshold range of the target heat retention temperature and being overheated. Instead, the cooking appliance 1000 may adjust the pan detection interval, thereby allowing a temperature of contents to be maintained within the threshold range of the target heat retention temperature by power for pan detection.

Referring to 2220 of FIG. 22, a power level value P3 of the power for pan detection may be different from a power level value P2 of the heat retention power. For example, the power level value P3 of the power for pan detection may be less than the power level value P2 of the heat retention power.

According to an embodiment of the present disclosure, a time (communication duration time) in which the wireless power transmission device 2000 outputs the heat retention power may vary. For example, when the cooking appliance 1000 transmits, to the wireless power transmission device 2000, a request for suspending transmission of the heat retention power when a temperature of contents reaches the target heat retention temperature, a time (communication duration time) in which the wireless power transmission device 2000 outputs the heat retention power may be changed.

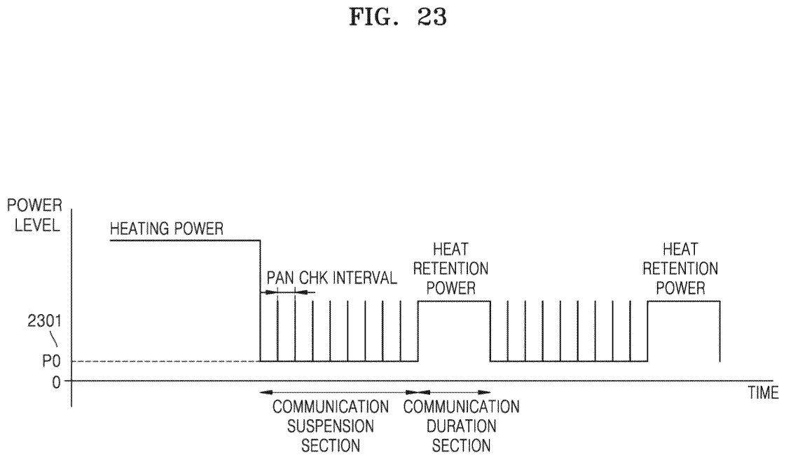

FIG. 23 is a diagram for describing an operation in which the wireless power transmission device 2000 transmits power equal to or less than a threshold power level in a communication suspension section, according to an embodiment of the present disclosure.

Referring to FIG. 23, in a section (communication suspension section) in which heating power and heat retention power are not output, a power level value may have a constant value (e.g., P0 2301), instead of having OW. For example, in a section in which communication connection to the cooking appliance 1000 is disconnected, the wireless power transmission device 2000 may constantly supply sufficiently-low power not to inductively heat contents in the cooking appliance 1000. For example, the wireless power transmission device 2000 may constantly supply power equal to or less than 100 W or power equal to or less than 50 W.

With reference to FIG. 23, an example is described, in which the wireless power transmission device 2000 constantly supplies, in the communication suspension section, sufficiently-low power (e.g., P0 2301) not to inductively heat contents in the cooking appliance 1000, but the present disclosure is not limited thereto. When the communication interface 1030 of the cooking appliance 1000 may be activated by the sufficiently-low power (e.g., P0 2301) not to inductively heat contents in the cooking appliance 1000, the cooking appliance 1000 may continuously maintain communication connection with the wireless power transmission device 2000, and may control the wireless power transmission device 2000 to perform outputting of power (e.g., P0 2301) and the heat retention power in a rotating manner.

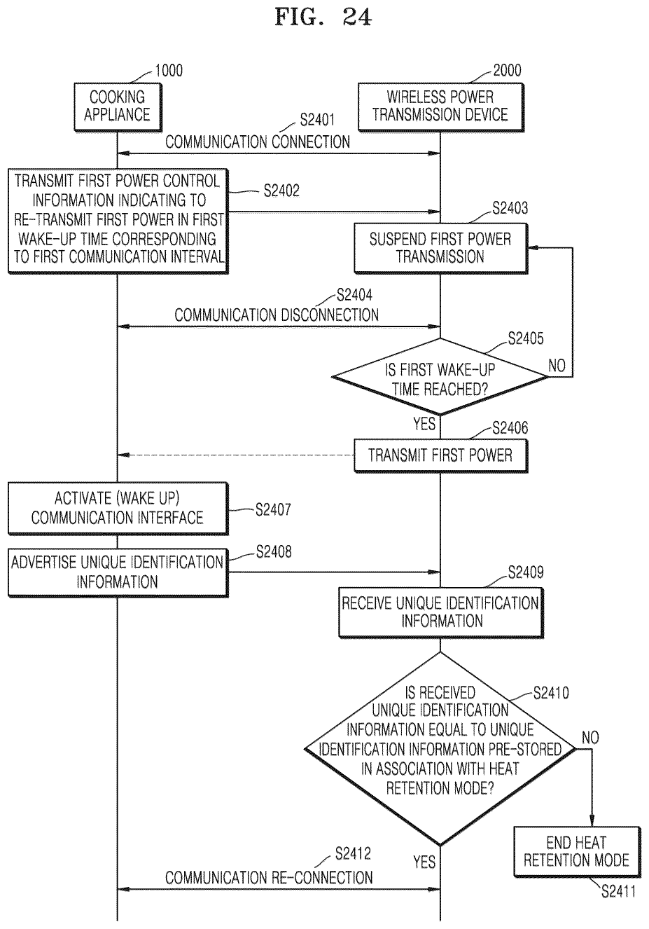

FIG. 24 is a flowchart for describing a method, performed by the wireless power transmission device 2000, of performing a heat retention mode, based on unique identification information of the cooking appliance 1000, according to an embodiment of the present disclosure.

In operation S2401, the cooking appliance 1000 and the wireless power transmission device 2000 may be connected for communication. For example, the cooking appliance 1000 and the wireless power transmission device 2000 may be connected for communication via short-range wireless communication (e.g., BLE communication).

According to an embodiment of the present disclosure, when a heat retention request is input from a user after the cooking appliance 1000 and the wireless power transmission device 2000 are connected for communication, the cooking appliance 1000 and the wireless power transmission device 2000 may operate in a heat retention mode. For example, the cooking appliance 1000 may store, in a memory, a heat retention flag indicating that an operation mode is the heat retention mode. The wireless power transmission device 2000 may store, in the memory 2600, unique identification information (e.g., MAC address) of the cooking appliance 1000 related to the heat retention mode.

When the wireless power transmission device 2000 transmits first power (heat retention power) to the cooking appliance 1000 so as to allow a temperature of contents to reach the target heat retention temperature, a communication connection between the cooking appliance 1000 and the wireless power transmission device 2000 may be maintained, and contents in the cooking appliance 1000 may be indicatively heated.

In operation S2402, when a temperature of contents is equal to or greater than the target heat retention temperature, the cooking appliance 1000 may transmit, to the wireless power transmission device 2000, first power control information indicating to suspend transmission of the first power and then to re-transmit the first power in a first wake-up time corresponding to a first communication interval.

In operation S2403, the wireless power transmission device 2000 may suspend transmission of the first power, based on the first power control information. The first power is power capable of driving the communication interface 1030 of the cooking appliance 1000, and for example, the first power may be 200 W to 500 W, but the present disclosure is not limited thereto. When the wireless power transmission device 2000 suspends transmission of the first power, a temperature of the contents in the cooking appliance 1000 may naturally decrease.

In operation S2404, when the wireless power transmission device 2000 suspends transmission of the first power, communication between the wireless power transmission device 2000 and the cooking appliance 1000 may be disconnected.

In operation S2405, the wireless power transmission device 2000 may determine whether the first wake-up time included in the first power control information has come.

In operation S2406, when the first wake-up time has come, the wireless power transmission device 2000 may re-transmit, to the cooking appliance 1000, the first power to the cooking appliance 1000, based on the first power control information.

In operation S2407, when the cooking appliance 1000 receives the first power from the wireless power transmission device 2000 via the pickup coil 1001, the cooking appliance 1000 may activate the communication interface 1030.

As operations S2401 to S2407 correspond to operations S1701 to S1709 of FIG. 17, detailed descriptions are not provided here.

In operation S2408, when the communication interface 1030 is activated, the cooking appliance 1000 may advertise unique identification information (e.g., MAC address) via the communication interface 1030.

In operation S2409, the wireless power transmission device 2000 may receive the unique identification information (e.g., MAC address) of the cooking appliance 1000 from the cooking appliance 1000.

In operation S2410, the wireless power transmission device 2000 may determine whether the received unique identification information is equal to unique identification information pre-stored in association with a heat retention mode. For example, the wireless power transmission device 2000 may compare the received unique identification information with the unique identification information pre-stored in the memory 2600 in association with a heat retention mode.

In operation S2411, when the received unique identification information is not equal to the unique identification information pre-stored in association with a heat retention mode, the wireless power transmission device 2000 may end the heat retention mode.

For example, a first cooking appliance may be placed in a left cooking zone of the wireless power transmission device 2000, for heat retention of contents. A user may put a second cooking appliance in the left cooking zone, instead of the first cooking appliance, in a time in which a communication connection between the first cooking appliance and the wireless power transmission device 2000 is disconnected. When the first cooking appliance reaches a set wake-up time, the wireless power transmission device 2000 may output first power. In this regard, the second cooking appliance may receive the first power, instead of the first cooking appliance, and may advertise second unique identification information of the second cooking appliance.

When the wireless power transmission device 2000 receives the second unique identification information from the second cooking appliance, the wireless power transmission device 2000 may determine that first unique identification information of the first cooking appliance pre-stored in association with a heat retention is different from the second unique identification information. As the first cooking appliance operating in a heat retention mode is removed from the wireless power transmission device 2000, the wireless power transmission device 2000 may end the heat retention mode and may operate in a standby mode.

In operation S2412, when the received unique identification information is equal to the unique identification information pre-stored in associated with a heat retention mode, the wireless power transmission device 2000 may perform re-connection of communication.

For example, the wireless power transmission device 2000 may transmit a communication connection request to the cooking appliance 1000. Here, when the cooking appliance 1000 accepts the communication connection request, the wireless power transmission device 2000 and the cooking appliance 1000 may be re-connected for communication.

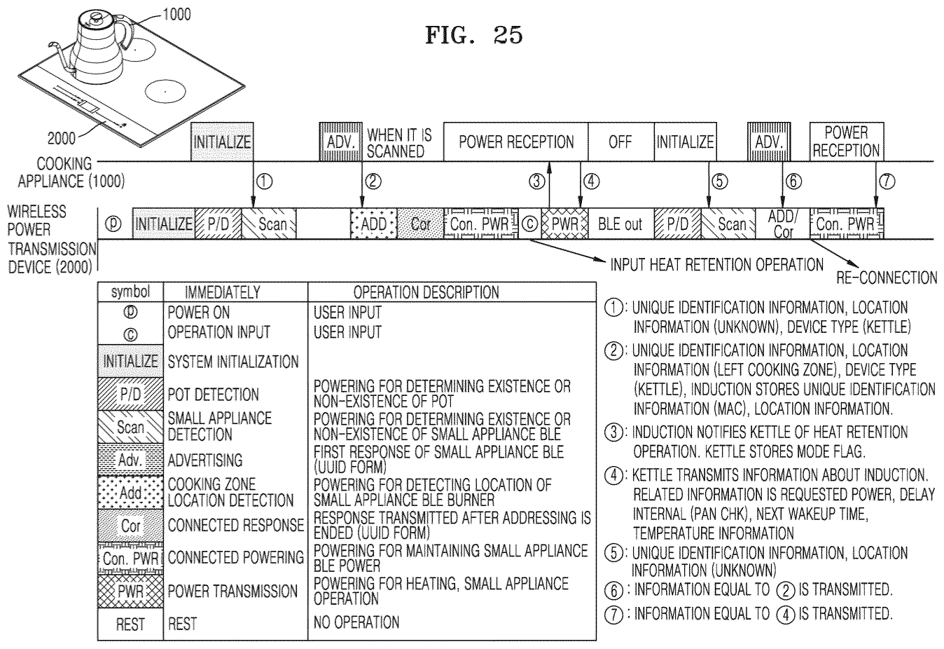

Hereinafter, with reference to FIGS. 25 to 27, an operation in which the wireless power transmission device 2000 and the cooking appliance 1000 are re-connected for communication will now be described.

FIG. 25 is a diagram for describing a communication re-connection operation between the cooking appliance 1000 and the wireless power transmission device 2000, according to an embodiment of the present disclosure. FIG. 25 will now be described with an example in which the cooking appliance 1000 is a kettle.

With reference to FIG. 25, [symbol] operation, [symbol] operation, and [symbol] operation may be operations for initial communication connection and heat retention mode setting, [symbol] operation and [symbol] operation may be operations for communication re-connection, and [symbol] operation and [symbol] operation may be operations for control of power transmission.

The wireless power transmission device 2000 may perform a small appliance detection operation (small object detection operation) after an IH container detection operation. For example, the wireless power transmission device 2000 may output first power (e.g., 200 W) for driving the communication interface 1030 of the cooking appliance 1000 via all cooking zones, and may operate in a scan mode [symbol] operation). When the cooking appliance 1000 receives the first power, the cooking appliance 1000 may drive the communication interface 1030, and may advertise a first packet including unique identification information (e.g., MAC address) and variable identification information of the cooking appliance 1000. Here, the variable identification information may include, in the form of a UUID, product type information (e.g., kettle) of the cooking appliance 1000 and information indicating that a cooking zone in which the cooking appliance 1000 is currently located is unknown.

The wireless power transmission device 2000 operating in the scan mode may identify that the cooking appliance 1000 is placed on the top, by receiving the first packet advertised by the cooking appliance 1000. When the first packet does not include information about a cooking zone in which the cooking appliance 1000 is located, the wireless power transmission device 2000 may operate in a cooking zone determination mode for checking a location of the cooking appliance 1000. For example, the wireless power transmission device 2000 may output (e.g., addressing) power according different power transmission patterns for respective cooking zones. For example, the wireless power transmission device 2000 may set a duration time of maintaining a low operating frequency (e.g., 55 kHz) and a duration time of maintaining a high operating frequency (e.g., 75 kHz) differently for the respective cooking zones. In this case, induced power may be large in a low operating frequency (e.g., 55 kHz) interval, and induced power may be small in a high operating frequency (e.g., 75 kHz) interval.

According to an embodiment of the present disclosure, as the cooking appliance 1000 is placed in the cooking zone in the lower left corner, the cooking appliance 1000 may detect a specific power transmission pattern corresponding to the cooking zone in the lower left corner. The cooking appliance 1000 may identify that the cooking appliance 1000 is located in the cooking zone in the lower left corner, by comparing the specific power transmission pattern with a plurality of pre-stored power transmission patterns of the cooking appliance 1000. In this case, the cooking appliance 1000 may transmit (e.g., advertise), to the wireless power transmission device 2000, a second packet including information indicating that the cooking appliance 1000 is located in the cooking zone in the lower left corner and product type information of the cooking appliance 1000 ( [symbol] operation). The variable identification information including current location information (e.g., cooking zone at the lower left) of the cooking appliance 1000 and product type information (e.g., kettle) of the cooking appliance 1000 may be inserted into the second packet, in the form of a UUID. Also, the second packet may further include the unique identification information (e.g., a MAC address) of the cooking appliance 1000. When receiving the second packet, the wireless power transmission device 2000 may store the unique identification information of the cooking appliance 1000 and the location information of the cooking appliance 1000, in the memory 2600.

After receiving the second packet, the wireless power transmission device 2000 may perform communication connection with the cooking appliance 1000. The wireless power transmission device 2000 may transmit a communication connection request to the cooking appliance 1000. When the cooking appliance 1000 accepts the communication connection request, the wireless power transmission device 2000 and the cooking appliance 1000 may be connected for communication.

When the wireless power transmission device 2000 is connected to be in communication with the cooking appliance 1000, the wireless power transmission device 2000 may control the inverter circuit 2113 to transmit first power (low power) for maintaining the communication connection with the cooking appliance 1000 to the pickup coil 1001 of the cooking appliance 1000. Here, the wireless power transmission device 2000 may receive an operation command with respect to the cooking appliance 1000 from a user. For example, the wireless power transmission device 2000 may receive a heat retention request input from the user ( [symbol] operation). According to the heat retention request input from the user, the wireless power transmission device 2000 may transmit heat retention request information to the cooking appliance 1000 via short-range wireless communication (e.g., BLE communication). When receiving the heat retention request information, the cooking appliance 1000 may switch an operation mode to a heat retention mode, and may store, in a memory, a heat retention flag indicating that a current operation mode is the heat retention mode.

The cooking appliance 1000 may receive supply of heat retention power from the wireless power transmission device 2000, thereby allowing a temperature of contents to be maintained within a threshold range of a target heat retention temperature. The heat retention power may be power for sufficiently driving the communication interface 1030 of the cooking appliance 1000 and inductively heating contents. For example, the heat retention power may be power equal to or greater than 200 W. The heat retention power may be equal to the first power (low power) for maintaining a communication connection or may be greater than the first power, however, for convenience of descriptions, an example in which the heat retention power is equal to the first power will now be described. While receiving supply of the heat retention power, the cooking appliance 1000 may monitor a temperature of contents via the first temperature sensor 1006, and may transmit information about the temperature of contents to the wireless power transmission device 2000.

When the temperature of contents is equal to or greater than the target heat retention temperature, the cooking appliance 1000 may transmit, to the wireless power transmission device 2000, power control information indicating to suspend transmission of the heat retention power (first power) and then to re-transmit the heat retention power (first power) after an elapse of a preset time ( [symbol] operation). The power control information may include a power level value of the heat retention power (first power), a pan detection interval, a next wake-up time, information about a temperature of contents, etc., but the present disclosure is not limited thereto.

The wireless power transmission device 2000 may suspend transmission of the first power until the next wake-up time. As the cooking appliance 1000 cannot drive the communication interface 1030, a communication connection between the wireless power transmission device 2000 and the cooking appliance 1000 may be suspended. During suspension of the communication connection, the wireless power transmission device 2000 may perform a pan detection operation according to a pan detection interval, thereby monitoring that the cooking appliance 1000 exits a cooking zone at the lower left.

When a wake-up time has come, the wireless power transmission device 2000 may be re-connected with the cooking appliance 1000 for communication. For example, the wireless power transmission device 2000 may re-output first power (e.g., 200 W) via all cooking zones, and may operate in a scan mode ( [symbol] operation).

When the cooking appliance 1000 receives the first power, the cooking appliance 1000 may drive the communication interface 1030, and may advertise a first packet including unique identification information (e.g., MAC address) and variable identification information of the cooking appliance 1000. Here, the variable identification information may include, in the form of a UUID, product type information (e.g., kettle) of the cooking appliance 1000 and information indicating that a cooking zone in which the cooking appliance 1000 is currently located is unknown.

When the first packet advertised by the cooking appliance 1000 does not include information about a cooking zone in which the cooking appliance 1000 is located, the wireless power transmission device 2000 operating in the scan mode may operate in a cooking zone determination mode for checking a location of the cooking appliance 1000. For example, the wireless power transmission device 2000 may output (e.g., addressing) power according different power transmission patterns for respective cooking zones.

According to an embodiment of the present disclosure, as the cooking appliance 1000 is placed in a cooking zone at the lower left, a particular power transmission pattern corresponding to the cooking zone at the lower left may be detected. In this case, the cooking appliance 1000 may transmit (e.g., advertising) a second packet to the wireless power transmission device 2000, the second packet including unique identification information of the cooking appliance 1000, location information (information indicating that it is located in the cooking zone at the lower left) of the cooking appliance 1000, and product type information (e.g., kettle) of the cooking appliance 1000 ( [symbol] operation).

When the unique identification information included in the second packet is equal to unique identification information of the cooking appliance 1000 pre-stored in association with a heat retention mode, the wireless power transmission device 2000 may transmit a communication connection request to the cooking appliance 1000. When the cooking appliance 1000 accepts the communication connection request, the wireless power transmission device 2000 and the cooking appliance 1000 may be re-connected for communication.

The wireless power transmission device 2000 may continuously transmit the first power until a temperature of contents in the cooking appliance 1000 reaches the target heat retention temperature. When the temperature of contents in the cooking appliance 1000 reaches the target heat retention temperature, the cooking appliance 1000 may transmit, to the wireless power transmission device 2000, power control information indicating to suspend transmission of the first power and then to re-transmit the first power after an elapse of a preset time ( [symbol] operation). The power control information may include a power level value of the first power, a pan detection interval, a next wake-up time, information about a temperature of contents, etc., but the present disclosure is not limited thereto.

Afterward, [symbol] operation to [symbol] operation may be repeated until a heat retention end condition is satisfied.

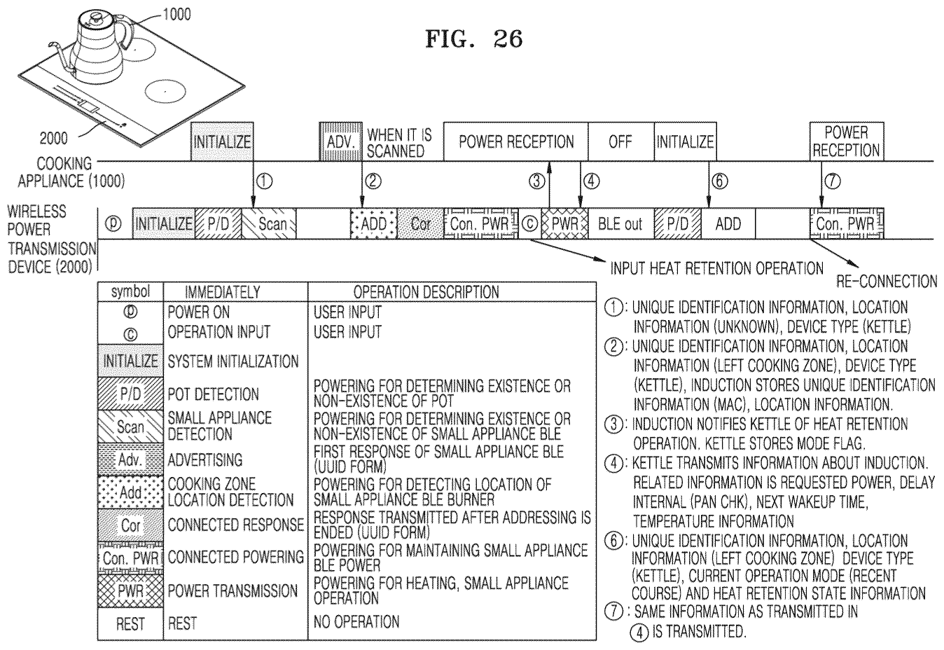

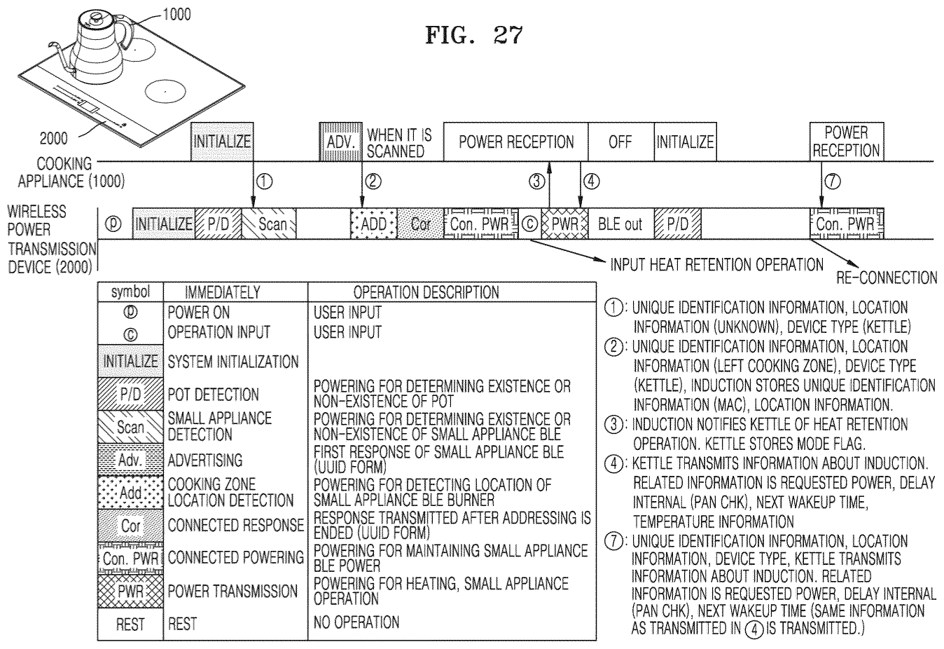

According to an embodiment of the present disclosure, some operations among operations for communication re-connection may be omitted. With reference to FIGS. 26 and 27, a case will now be described, in which some operations among operations for communication re-connection are omitted.

FIG. 26 is a diagram for describing a communication re-connection operation between the cooking appliance 1000 and the wireless power transmission device 2000, according to an embodiment of the present disclosure. As [symbol] operation to [symbol] operation of FIG. 26 correspond to [symbol] operation to [symbol] operation of FIG. 25, redundant descriptions are not provided here.

Referring to FIG. 26, an operation ( [symbol] operation) related to a scan mode in a communication re-connection may be omitted from among operations of FIG. 25. For example, when a wake-up time has come, the wireless power transmission device 2000 may output (e.g., addressing) power according to different power transmission patterns for respective cooking zones, instead of transmitting first power for small appliance detection, and thus, may operate in a cooking zone determination mode. As power transmitted in the cooking zone determination mode is sufficient power for driving the communication interface 1030 of the appliance 1000, the communication interface 1030 of the cooking appliance 1000 may be activated.

According to an embodiment of the present disclosure, as the cooking appliance 1000 is placed in a cooking zone at the lower left, the cooking appliance 1000 may detect a particular power transmission pattern corresponding to the cooking zone at the lower left. In this case, the cooking appliance 1000 may transmit (e.g., advertising) a packet to the wireless power transmission device 2000, the packet including unique identification information of the cooking appliance 1000, location information (information indicating that it is located in the cooking zone at the lower left) of the cooking appliance 1000, and product type information (e.g., kettle) of the cooking appliance 1000 ( [symbol] operation). The packet may further include information about a current operation mode (e.g., a heat retention mode, a recent cooking course), information (e.g., target heat retention temperature, etc.) related to a heat retention state, but the present disclosure is not limited thereto.

When the unique identification information included in the packet is equal to unique identification information of the cooking appliance 1000 pre-stored in association with a heat retention mode, the wireless power transmission device 2000 may transmit a communication connection request to the cooking appliance 1000. When the cooking appliance 1000 accepts the communication connection request, the wireless power transmission device 2000 and the cooking appliance 1000 may be re-connected for communication.

The wireless power transmission device 2000 may continuously transmit the first power until a temperature of contents in the cooking appliance 1000 reaches the target heat retention temperature. When the temperature of contents in the cooking appliance 1000 reaches the target heat retention temperature, the cooking appliance 1000 may transmit, to the wireless power transmission device 2000, power control information indicating to suspend transmission of the first power and then to re-transmit the first power after an elapse of a preset time ( [symbol] operation). The power control information may include a power level value of the first power, a pan detection interval, a next wake-up time, information about a temperature of contents, etc., but the present disclosure is not limited thereto.

Afterward, [symbol] operation and [symbol] operation may be repeated until a heat retention end condition is satisfied.

FIG. 27 is a diagram for describing a communication re-connection operation between the cooking appliance 1000 and the wireless power transmission device 2000, according to an embodiment of the present disclosure. As [symbol] operation to [symbol] operation of FIG. 27 correspond to [symbol] operation to [symbol] operation of FIG. 25, redundant descriptions are not provided here.

Referring to FIG. 27, an operation ( [symbol] operation) related to a scan mode in a communication re-connection and an operation ( [symbol] operation) related to a cooking zone determination mode may be omitted from among operations of FIG. 25.

For example, when a wake-up time has come, the wireless power transmission device 2000 may output first power (heat retention power). The wireless power transmission device 2000 does not output the first power via all cooking zones, but may identify a cooking zone in a heat retention mode and may output the first power to the cooking zone. For example, before communication connection is disconnected, the wireless power transmission device 2000 may store information indicating that the cooking appliance 1000 operating in the heat retention mode is located in a cooking zone at the lower left. Then, the wireless power transmission device 2000 may output the first power via the cooking zone at the lower left in the wake-up time.

The communication interface 1030 of the cooking appliance 1000 may be activated by the first power (heat retention power), and the cooking appliance 1000 may transmit a packet including unique identification information (e.g., MAC address), product type information (e.g., kettle) of the cooking appliance 1000, and information indicating that a cooking zone in which the cooking appliance 1000 is currently located is unknown.

When the unique identification information included in the packet is equal to unique identification information of the cooking appliance 1000 pre-stored in association with a heat retention mode, the wireless power transmission device 2000 may transmit a communication connection request to the cooking appliance 1000. When the cooking appliance 1000 accepts the communication connection request, the wireless power transmission device 2000 and the cooking appliance 1000 may be re-connected for communication.

The wireless power transmission device 2000 may continuously transmit the first power until a temperature of contents in the cooking appliance 1000 reaches the target heat retention temperature. When the temperature of contents in the cooking appliance 1000 reaches the target heat retention temperature, the cooking appliance 1000 may transmit, to the wireless power transmission device 2000, power control information indicating to suspend transmission of the first power and then to re-transmit the first power after an elapse of a preset time ( [symbol] operation). The power control information may include a power level value of the first power, a pan detection interval, a next wake-up time, information about a temperature of contents, etc., but the present disclosure is not limited thereto.

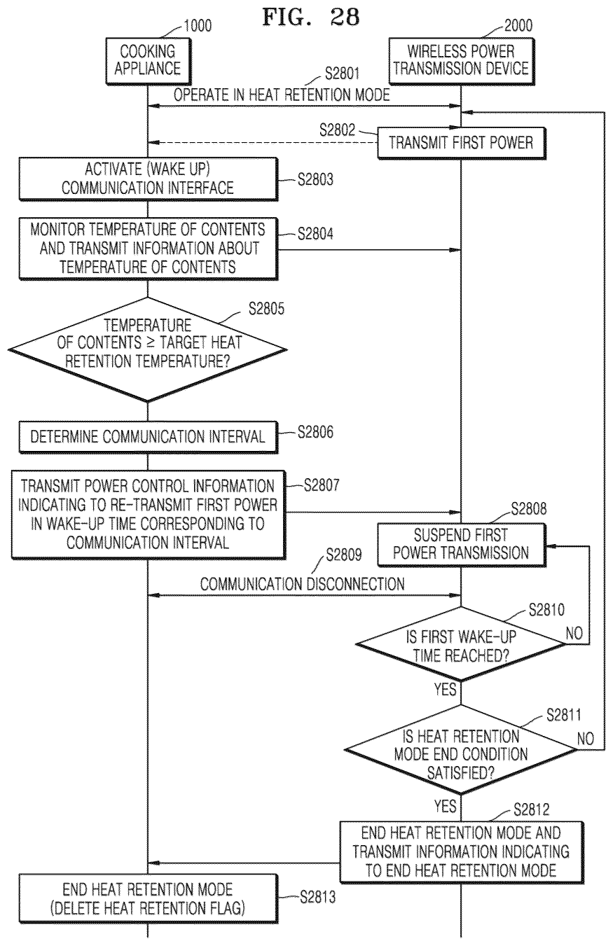

FIG. 28 is a flowchart for describing a method by which the cooking appliance 1000 ends a heat retention mode, according to an embodiment of the present disclosure.

In operation S2801, the cooking appliance 1000 and the wireless power transmission device 2000 may operate in a heat retention mode.

According to an embodiment of the present disclosure, the cooking appliance 1000 may receive heat retention request information including a target heat retention temperature selected by a user, from the wireless power transmission device 2000. For example, when the wireless power transmission device 2000 receives an input of a heat retention request for the cooking appliance 1000 from the user via the user interface 2500, the wireless power transmission device 2000 may transmit heat retention request information to the cooking appliance 1000 via short-range wireless communication (e.g., BLE communication).

According to an embodiment of the present disclosure, when the cooking appliance 1000 receives the heat retention request information from the wireless power transmission device 2000, the cooking appliance 1000 may switch an operation mode to a heat retention mode. Then, the cooking appliance 1000 may store, in a memory, information (e.g., a heat retention flag) indicating that the operation mode of the cooking appliance 1000 is the heat retention mode. Here, the wireless power transmission device 2000 may also operate in a heat retention mode, and may store mapping information with respect to the unique identification information of the cooking appliance 1000 and the heat retention mode, in the memory 2600.

In operation S2802, the wireless power transmission device 2000 may transmit (output) first power (heat retention power). According to an embodiment of the present disclosure, when a temperature of contents is less than the target heat retention temperature, the cooking appliance 1000 may inductively heat the contents by outputting the first power.

In operation S2803, while receiving the first power, the cooking appliance 1000 may activate the communication interface 1030. Here, the cooking appliance 1000 and the wireless power transmission device 2000 may maintain a communication connection.

In operation S2804, the cooking appliance 1000 may monitor a temperature of contents, and may transmit information about the contents to the wireless power transmission device 2000.

According to an embodiment of the present disclosure, a temperature of contents at a time when the cooking appliance 1000 is re-connected with the wireless power transmission device 2000 for communication may be less than the target heat retention temperature When the first power is re-transmitted from the wireless power transmission device 2000, contents are inductively heated by the first power, and thus, a temperature of contents may gradually increase.

According to an embodiment of the present disclosure, when the first power is received again from the wireless power transmission device 2000, the cooking appliance 1000 may monitor a temperature of contents via the first temperature sensor 1006. The cooking appliance 1000 may transmit information about a temperature of contents to the wireless power transmission device 2000 via a short-range wireless communication channel (e.g., a BLE communication channel).

In operation S2805, the cooking appliance 1000 may determine whether a temperature of contents is equal to or greater than the target heat retention temperature. When the temperature of contents is less than the target heat retention temperature, the cooking appliance 1000 may continuously monitor a temperature of contents.

In operation S2806, the cooking appliance 1000 may determine a communication interval. For example, the communication interval may be determined based on a difference between a first temperature of contents when the cooking appliance 1000 and the wireless power transmission device 2000 are re-connected for communication and the target heat retention temperature.

According to an embodiment of the present disclosure, when the difference between the first temperature of contents and the target heat retention temperature is equal to or greater than a first threshold value, the cooking appliance 1000 may determine a next communication interval to be shorter than a previous communication interval, and when the difference between the first temperature of contents and the target heat retention temperature is equal to or less than a second threshold value, the cooking appliance 1000 may determine the next communication interval to be longer than the previous communication interval. Here, the second threshold value may be a value smaller than the first threshold value.

For example, when the difference between the first temperature of contents and the target heat retention temperature is equal to or greater than 3° C., the cooking appliance 1000 may determine the next communication interval to be shorter than the previous communication interval, when the difference between the first temperature of contents and the target heat retention temperature is equal to or less than 1° C., the cooking appliance 1000 may determine the next communication interval to be longer than the previous communication interval, and when the difference between the first temperature of contents and the target heat retention temperature is greater than 1° C. and less than 3° C., the cooking appliance 1000 may determine the next communication interval to be equal to the previous communication interval.

In operation S2807, when the temperature of the contents is equal to or greater than the target heat retention temperature, the cooking appliance 1000 may transmit power control information indicating to suspend transmission of the first power and then to re-transmit the first power in a next wake-up time corresponding to the next communication interval.

According to an embodiment of the present disclosure, the cooking appliance 1000 may transmit power control information to the wireless power transmission device 2000 via short-range wireless communication (e.g., BLE communication).

In operation S2808, the wireless power transmission device 2000 may suspend transmission of the first power, based on the power control information. When the wireless power transmission device 2000 suspends transmission of the first power, a temperature of contents in the cooking appliance 1000 may slowly decrease.

In operation S2809, communication between the cooking appliance 1000 and the wireless power transmission device 2000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

In operation S2810, the wireless power transmission device 2000 may determine whether a wake-up time corresponding to the communication interval has come.

When the wake-up time corresponding to the communication interval has not come, the wireless power transmission device 2000 may suspend transmission of the first power, and may periodically perform a pan detection operation. A time in which power is transmitted for pan detection is about 60 ms, which may be insufficient for a communication connection. Therefore, even when the wireless power transmission device 2000 performs the pan detection operation, the communication connection between the wireless power transmission device 2000 and the cooking appliance 1000 may be in a disconnected state.

In operation S2811, when the wake-up time has come, the wireless power transmission device 2000 may determine whether a heat retention mode end condition is satisfied. Here, the heat retention mode end condition may include at least one of an expiry of a heat retention time input by a user, an expiry of a default-set heat retention time, a case in which it is determined that contents are not present in the cooking appliance 1000, and a case in which it is determined that the cooking appliance 1000 leaves a cooking zone, but the present disclosure is not limited thereto.

When the heat retention mode end condition is not satisfied, as the wake-up time has come, the wireless power transmission device 2000 may return to operation S2802 and may re-transmit (re-output) the first power.

In operation S2812, when the heat retention mode end condition is satisfied, the wireless power transmission device 2000 may end the heat retention mode and may transmit information indicating to end the heat retention mode to the cooking appliance 1000.

According to an embodiment of the present disclosure, in a case where the default-set heat retention time is 1 hour, when 1 hour has passed after the heat retention request input has been received, the wireless power transmission device 2000 may end the heat retention mode. However, when the user extends the heat retention mode, the wireless power transmission device 2000 may return to operation S2802 and may transmit the first power. Afterward, when the extended heat retention time expires, the wireless power transmission device 2000 may end the heat retention mode.

According to an embodiment of the present disclosure, even when the default-set heat retention time has not passed, when a heat retention time input by the user expires, the wireless power transmission device 2000 may end the heat retention mode. For example, in a case where the heat retention time input by the user is 20 minutes, when 20 minutes has passed after the heat retention request input was received, the wireless power transmission device 2000 may end the heat retention mode. However, when the user further extends the heat retention time by 20 minutes, the wireless power transmission device 2000 may return to operation S2802 and may transmit the first power. Afterward, when the extended heat retention time expires, the wireless power transmission device 2000 may end the heat retention mode.

According to an embodiment of the present disclosure, when it is determined that contents are not present in the cooking appliance 1000, the wireless power transmission device 2000 may end the heat retention mode. A state in which contents are not present in the cooking appliance 1000 may be defined as an empty heating state. When contents are not present in the cooking appliance 1000, operating in the heat retention mode is useless, and a safety problem may occur, and thus, the wireless power transmission device 2000 may end the heat retention mode.

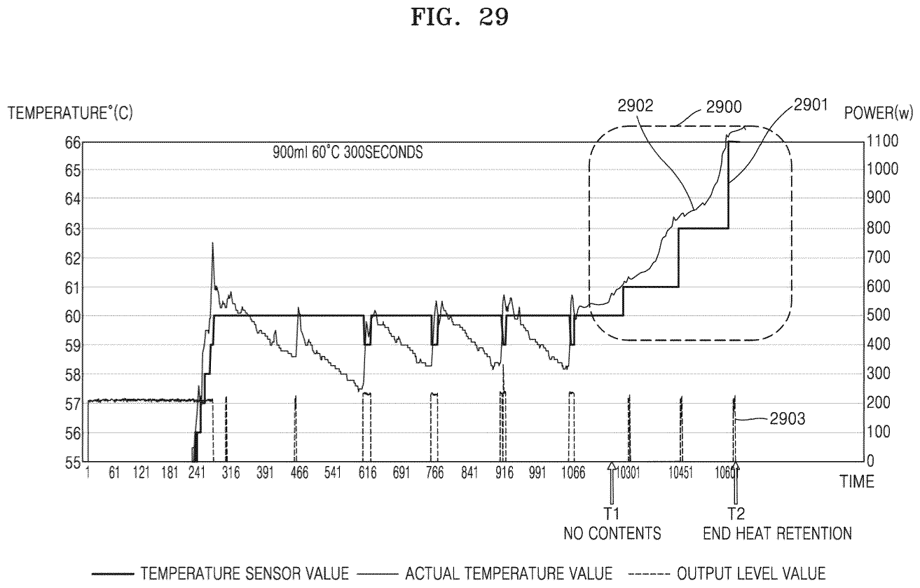

According to an embodiment of the present disclosure, the empty heating state may be determined based on temperature variation of contents which is measured via the first temperature sensor 1006. The cooking appliance 1000 may determine the empty heating state, or the wireless power transmission device 2000 may determine the empty heating state. For example, the cooking appliance 1000 may determine that it is now the empty heating state, based on temperature variation of contents which is measured via the first temperature sensor 1006, and may transmit information indicating that it is now the empty heating state, to the wireless power transmission device 2000. Alternatively, the wireless power transmission device 2000 may determine that the cooking appliance 1000 is currently in the empty heating state, based on information about a temperature of contents which is received from the cooking appliance 1000. An operation of determining the empty heating state, based on temperature variation of contents, will be further described below with reference to FIG. 29.

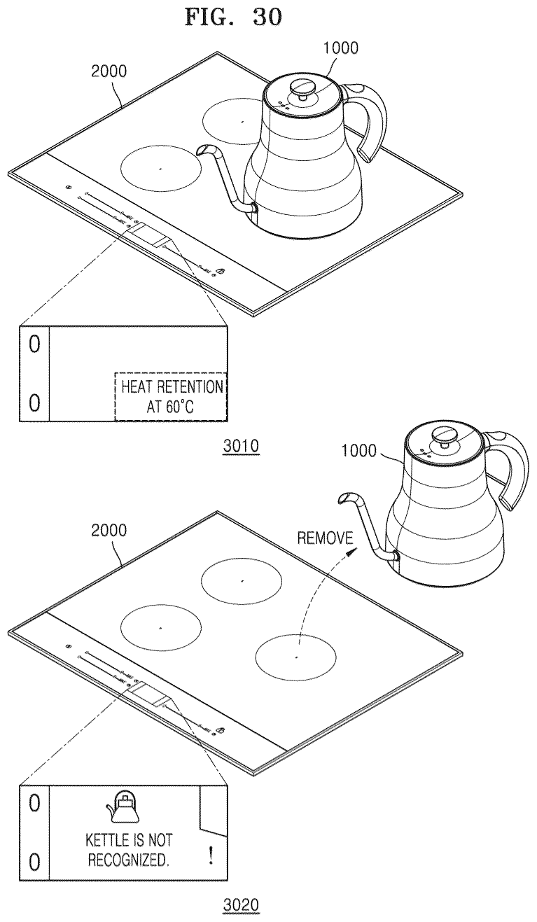

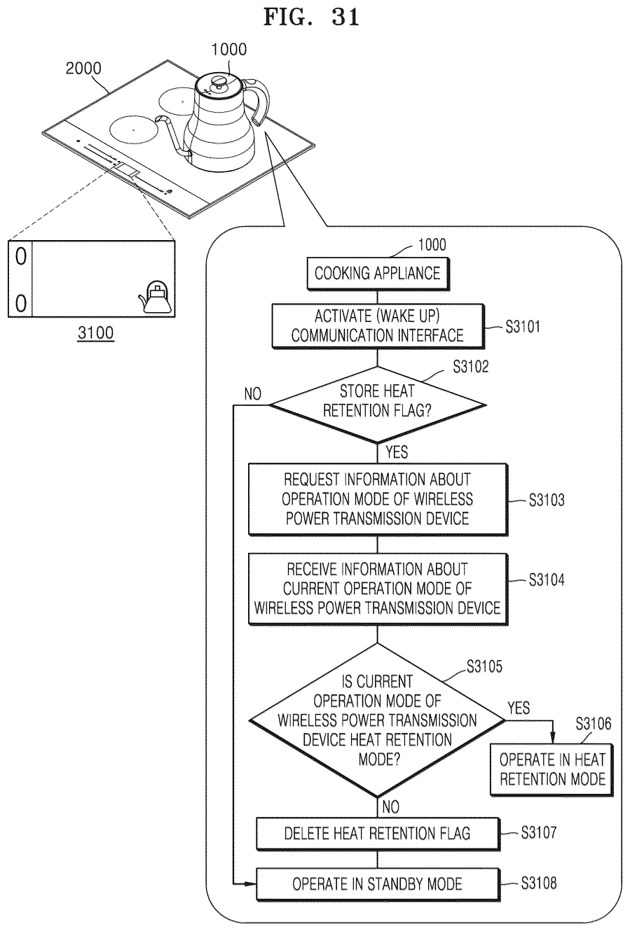

According to an embodiment of the present disclosure, the wireless power transmission device 2000 may detect that the cooking appliance 1000 has leaved a cooking zone, via a pan detection operation. In this regard, the wireless power transmission device 2000 may end the heat retention mode and may switch to a standby mode. As the cooking appliance 1000 has leaved a cooking zone, the wireless power transmission device 2000 cannot transmit information indicating to end the heat retention mode to the cooking appliance 1000. However, when a user places the cooking appliance 1000 on the wireless power transmission device 2000 so as to use it at a later time, the heat retention flag indicating that an operation mode is the heat retention mode has not been deleted, the cooking appliance 1000 may check an operation of the wireless power transmission device 2000. In this regard, as an operation mode of the wireless power transmission device 2000 is not the heat retention mode, the cooking appliance 1000 may end the heat retention mode. An operation of a case in which the cooking appliance 1000 has leaved a cooking zone while operating in the heat retention mode and then is placed back in a cooking zone will be described in detail below with reference to FIGS. 30 and 31.

According to an embodiment of the present disclosure, when the wireless power transmission device 2000 ends the heat retention mode, the wireless power transmission device 2000 may shortly transmit the first power for driving the communication interface 1030 of the cooking appliance 1000 so as to activate the communication interface 1030, and then may transmit information indicating to end the heat retention mode to the cooking appliance 1000. When the wireless power transmission device 2000 has transmitted the information indicating to end the heat retention mode to the cooking appliance 1000, the wireless power transmission device 2000 may suspend transmission of the first power and may operate in a standby mode. The wireless power transmission device 2000 may delete information stored in association with the heat retention mode.

In operation S2813, when the cooking appliance 1000 receives the information indicating to end the heat retention mode from the wireless power transmission device 2000, the cooking appliance 1000 may end the heat retention mode. For example, the cooking appliance 1000 may delete, from the memory, information (heat retention flag) indicating that the operation mode is the heat retention mode.

FIG. 29 is a diagram for describing an operation of identifying an empty heating state, according to an embodiment of the present disclosure. With reference to FIG. 29, an example will now be described, in which an amount of contents in the cooking appliance 1000 is 900 ml, a target heat retention temperature is 60° C., and a communication interval is 300 seconds.

A first graph 2901 is a graph indicating temperature values measured by the cooking appliance 1000 via the first temperature sensor 1006. A second graph 2902 is a graph indicating temperature values of actual contents. A third graph 2903 is a graph indicating a first power value output from the wireless power transmission device 2000.

Referring to the first graph 2901 and the second graph 2902, when there are contents of 900 ml, and a communication interval is determined as 300 seconds, a temperature of contents may be increased or decreased within a threshold range (60±3° C.) of a target heat retention temperature. However, when it is the empty heating state (T1 point in time), a temperature of contents does not fall below the target heat retention temperature but may continuously increase (2900).

Therefore, when there is a pattern in which a temperature of contents which is measured in a wake-up time does not decrease but continuously increase, or the temperature of contents increases by a preset temperature or higher than the target heat retention temperature, the cooking appliance 1000 or the wireless power transmission device 2000 may determine that the cooking appliance 1000 is in the empty heating state. For example, when a temperature of contents is equal to or greater than 66° C. (T2 point in time) that is higher than the target heating temperature (60° C.) by 10% the cooking appliance 1000 or the wireless power transmission device 2000 may determine that the cooking appliance 1000 is in the empty heating state.

When the cooking appliance 1000 is in the empty heating state, the wireless power transmission device 2000 and the cooking appliance 1000 may end a heat retention mode, and may delete information related to the heat retention mode.

FIG. 30 is a diagram for describing an operation performed when the cooking appliance 1000 operating in a heat retention mode is removed from the top plate of the wireless power transmission device 2000, according to an embodiment of the present disclosure.

Referring to 3010 of FIG. 30, a user may place the cooking appliance 1000 in a right cooking zone, and may set a target heat retention temperature to 60° C. The cooking appliance 1000 and the wireless power transmission device 2000 may operate in the heat retention mode, and a GUI indicating that contents in the cooking appliance 1000 are in heat retention at 60° C. may be displayed at a position of the display of the wireless power transmission device 2000 which corresponds to a right cooking zone.

The cooking appliance 1000 may adjust a communication interval (power transmission interval) with the wireless power transmission device 2000, thereby allowing a temperature of contents to be maintained within a threshold range (60±3° C.) of the target heat retention temperature.

Referring to 3020 of FIG. 30, a user may remove, from the right cooking zone, the cooking appliance 1000 that operates in the heat retention mode. The wireless power transmission device 2000 may detect leave of the cooking appliance 1000, via a pan detection operation, and may output a notification (e.g., A kettle is not recognized.) indicating that the cooking appliance 1000 is not recognized.

When the cooking appliance 1000 is not detected again in the right cooking zone within a preset time (e.g., 60 seconds), the wireless power transmission device 2000 may end the heat retention mode and may switch to a standby mode. An operation of a case in which, after the wireless power transmission device 2000 switches to the standby mode, the cooking appliance 1000 is placed again on the wireless power transmission device 2000 will now be described with reference to FIG. 31.

FIG. 31 is a flowchart for describing an operation of the cooking appliance 1000 in a case where the cooking appliance 1000 is placed on the wireless power transmission device 2000, according to an embodiment of the present disclosure.

Referring to 3100 of FIG. 31, an example of a case will now be described, in which, after a user removes the cooking appliance 1000 operating in a heat retention mode from the wireless power transmission device 2000 and thus a heat retention mode of the wireless power transmission device 2000 is ended, the user places again the cooking appliance 1000 on the wireless power transmission device 2000 and turns on power of the wireless power transmission device 2000.

In operation S3101, the cooking appliance 1000 may activate the communication interface 1030. When the user turns on power, the wireless power transmission device 2000 may perform a pan detection operation and a small appliance detection operation. When the wireless power transmission device 2000 transmits first power via all cooking zones so as to perform the small appliance detection operation, the cooking appliance 1000 may receive the first power to activate the controller 1020 and the communication interface 1030.

In operation S3102, the cooking appliance 1000 may determine whether a heat retention flag indicating that an operation mode is a heat retention mode is stored in the memory. When the heat retention flag is not stored, the cooking appliance 1000 may operate in a standby mode.

However, as the user removed the cooking appliance 1000 operating in the heat retention mode from the wireless power transmission device 2000, and thus, the heat retention mode of the cooking appliance 1000 was not normally ended, the heat retention flag may remain in the memory of the cooking appliance 1000.

In operation S3103, when the heat retention flag is stored in the memory, the cooking appliance 1000 may request the wireless power transmission device 2000 for information about an operation mode of the wireless power transmission device 2000. In operation S3104, in response to the request, the cooking appliance 1000 may receive information about a current operation mode of the wireless power transmission device 2000.

In operation S3105, the cooking appliance 1000 may identify whether the current operation mode of the wireless power transmission device 2000 is a heat retention mode, based on the information about the current operation mode of the wireless power transmission device 2000.

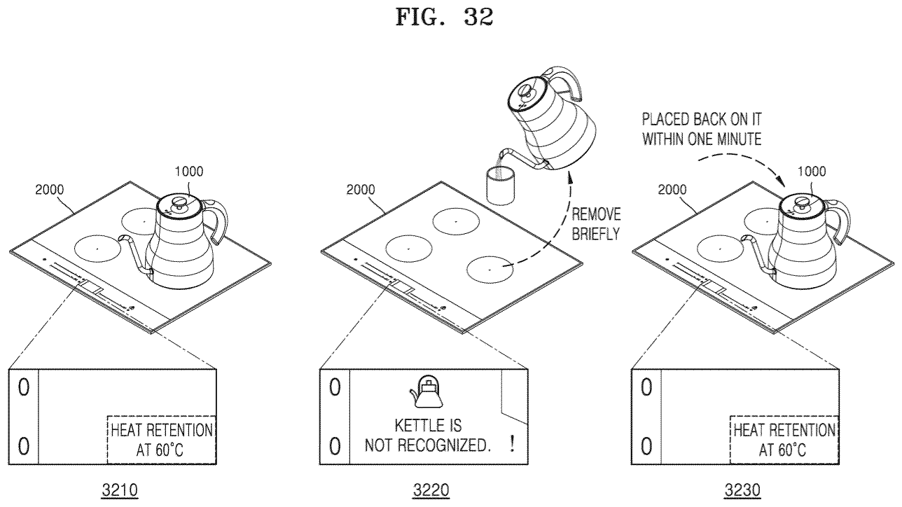

In operation S3106, when the current operation mode of the wireless power transmission device 2000 is the heat retention mode, the cooking appliance 1000 may operate in the heat retention mode. For example, in a case where the cooking appliance 1000 has left for a while from a right cooking zone of the wireless power transmission device 2000 but the cooking appliance 1000 is detected again from the right cooking zone in a preset time, the wireless power transmission device 2000 may not end the heat retention mode. Therefore, the cooking appliance 1000 may identify that the operation mode of the wireless power transmission device 2000 is the heat retention mode, and may maintain the heat retention mode. Operation S3106 will be further described below with reference to FIG. 32.

In operation S3107, when the current operation mode of the wireless power transmission device 2000 is not the heat retention mode, the cooking appliance 1000 may normally end the heat retention mode by deleting the heat retention flag from the memory. In operation S3108, when the operation mode of the wireless power transmission device 2000 is the standby mode, the cooking appliance 1000 may operate in a standby mode.

FIG. 32 is a diagram for describing an operation of the wireless power transmission device 2000 in a case where, after the cooking appliance 1000 is removed from the wireless power transmission device 2000, the cooking appliance 1000 is placed again on the wireless power transmission device 2000 within a preset time, according to an embodiment of the present disclosure.

Referring to 3210 of FIG. 32, a user may place the cooking appliance 1000 in a right cooking zone, and may set a target heat retention temperature to 60° C. The cooking appliance 1000 and the wireless power transmission device 2000 may operate in a heat retention mode, and a GUI indicating that contents in the cooking appliance 1000 are in heat retention at 60° C. may be displayed at a position of the display of the wireless power transmission device 2000 which corresponds to a right cooking zone. The cooking appliance 1000 may adjust a communication interval (power transmission interval) with the wireless power transmission device 2000, thereby allowing a temperature of contents to be maintained within a threshold range (60±3° C.) of the target heat retention temperature. The wireless power transmission device 2000 may periodically transmit first power under the control of the cooking appliance 1000.

Referring to 3220 of FIG. 32, the user may remove the cooking appliance 1000 operating in the heat retention mode from the right cooking zone. For example, the user may briefly lift up the cooking appliance 1000 from the right cooking zone so as to pour contents into a cup. In this regard, the wireless power transmission device 2000 may detect the leave of the cooking appliance 1000 via a pan detection operation, and may output a notification (e.g., A kettle is not recognized.) indicating that the cooking appliance 1000 is not recognized.

When the cooking appliance 1000 is re-detected in the right cooking zone within a preset time (e.g., 1 minute), the wireless power transmission device 2000 may not end the heat retention mode. For example, when the user uses and puts down the cooking appliance 1000 in the right cooking zone within 1 minute, the wireless power transmission device 2000 may maintain the heat retention mode. Even when the leave of the cooking appliance 1000 is detected, the wireless power transmission device 2000 may perform the pan detection operation for a while, and thus, may detect that the cooking appliance 1000 is placed again.

When a wake-up time comes, and thus, the wireless power transmission device 2000 transmits the first power via the right cooking zone, the cooking appliance 1000 may wake up and check a heat retention flag from the memory, and may identify an operation mode of the wireless power transmission device 2000.

Here, as the operation mode of the wireless power transmission device 2000 is also the heat retention mode, the cooking appliance 1000 may maintain the heat retention mode.

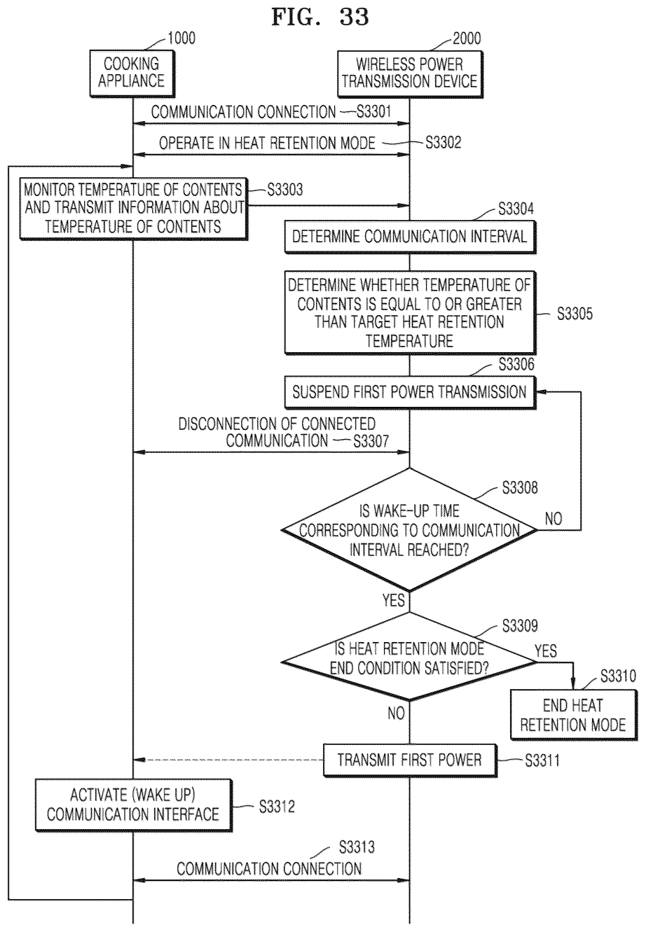

FIG. 33 is a flowchart for describing a method by which the wireless power transmission device 2000 adjusts power transmission to the cooking appliance 1000 by determining a communication interval, according to an embodiment of the present disclosure.

In operation S3301, the cooking appliance 1000 and the wireless power transmission device 2000 may be connected for communication. For example, when the wireless power transmission device 2000 transmits first power for driving the PCB 1005 of the cooking appliance 1000, the cooking appliance 1000 may establish a short-range wireless communication channel (e.g., a BLE communication channel) with the wireless power transmission device 2000.

In operation S3302, the cooking appliance 1000 and the wireless power transmission device 2000 may operate in a heat retention mode.

According to an embodiment of the present disclosure, when the wireless power transmission device 2000 receives an input of a heat retention request for the cooking appliance 1000 from a user via the user interface 2500, the wireless power transmission device 2000 may transmit heat retention request information to the cooking appliance 1000 via short-range wireless communication (e.g., BLE communication). The cooking appliance 1000 may receive the heat retention request information including a target heat retention temperature selected by the user, from the wireless power transmission device 2000.

According to an embodiment of the present disclosure, when the cooking appliance 1000 receives the heat retention request information from the wireless power transmission device 2000, the cooking appliance 1000 may switch an operation mode of the cooking appliance 1000 to the heat retention mode. The cooking appliance 1000 may store, in the memory, information (e.g., a heat retention flag) indicating that the operation mode of the cooking appliance 1000 is the heat retention mode. In this regard, the wireless power transmission device 2000 may also operate in the heat retention mode, and may store mapping information with respect to unique identification information of the cooking appliance 1000 and the heat retention mode, in the memory 2600.

In operation S3303, the cooking appliance 1000 may monitor a temperature of contents, and may transmit information about the temperature of contents to the wireless power transmission device 2000.

According to an embodiment of the present disclosure, when the cooking appliance 1000 is re-connected with the wireless power transmission device 2000 for communication, a temperature of contents may be less than the target heat retention temperature. When the first power is re-transmitted from the wireless power transmission device 2000, contents may be inductively heated by the first power, such that a temperature of contents may gradually increase.

According to an embodiment of the present disclosure, when the first power is re-transmitted from the wireless power transmission device 2000, the cooking appliance 1000 may monitor a temperature of contents via the first temperature sensor 1006. The cooking appliance 1000 may transmit data about a temperature of contents to the wireless power transmission device 2000 via the short-range wireless communication channel (e.g., the BLE communication channel).

In operation S3304, the wireless power transmission device 2000 may determine a communication interval (power transmission interval). According to an embodiment of the present disclosure, the wireless power transmission device 2000 may determine the communication interval, based on at least one of an amount of contents in the cooking appliance 1000, the target heat retention temperature, and a difference between a first temperature of contents measured in a wake-up time and the target heat retention temperature.

According to an embodiment of the present disclosure, the wireless power transmission device 2000 may obtain information about the amount of contents in the cooking appliance 1000, and may determine the communication interval, based on the amount of contents. The wireless power transmission device 2000 may calculate a temperature variation rate of contents, based on the information about the temperature of contents which is received from the cooking appliance 1000 in a heating operation, and may identify an amount of contents in the cooking appliance 1000, by comparing the temperature variation rate of contents with a pre-stored table or graph. Alternatively, the wireless power transmission device 2000 may receive the information about the amount of contents from the cooking appliance 1000.

The wireless power transmission device 2000 may determine a long communication interval when the amount of contents is great, and may determine a short communication interval when the amount of contents is small. As a temperature variation rate decreases when the amount of contents increases, even when a section in which power transmission is suspended is long, a temperature of contents does not significantly fall below the target heat retention temperature. On the other hand, as a temperature variation rate increases when the amount of contents decreases, when a section in which power transmission is suspended is long, a temperature of contents may significantly fall below the target heat retention temperature. Therefore, the wireless power transmission device 2000 may determine the communication interval, based on the amount of contents, so that the temperature of contents may be maintained around the target heat retention temperature.

According to an embodiment of the present disclosure, the wireless power transmission device 2000 may determine a short communication interval when the target heat retention temperature is high, and may determine a long communication interval when the target heat retention temperature is low. When the wireless power transmission device 2000 suspends first power transmission to the cooking appliance 1000, a speed that a temperature of contents exceeds a threshold range of the target heat retention temperature may increase as the target heat retention temperature is high. For example, a time taken to fall from 90° C. by 3° C. may be shorter than a time taken to fall from 90° C. by 3° C. Therefore, the wireless power transmission device 2000 may determine the communication interval according to a temperature value of the target heat retention temperature, so that a temperature of contents may be maintained within the threshold range of the target heat retention temperature.

According to an embodiment of the present disclosure, when the difference between the first temperature of contents and the target heat retention temperature is equal to or greater than a first threshold value, the wireless power transmission device 2000 may determine a next communication interval to be shorter than a previous communication interval, and when the difference between the first temperature of contents and the target heat retention temperature is equal to or less than a second threshold value, the wireless power transmission device 2000 may determine the next communication interval to be longer than the previous communication interval. Here, the second threshold value may be a value smaller than the first threshold value.

For example, when the difference between the first temperature of contents and the target heat retention temperature is equal to or greater than 3° C., the wireless power transmission device 2000 may determine the next communication interval to be shorter than the previous communication interval, when the difference between the first temperature of contents and the target heat retention temperature is equal to or less than 1° C., the wireless power transmission device 2000 may determine the next communication interval to be longer than the previous communication interval, and when the difference between the first temperature of contents and the target heat retention temperature is greater than 1° C. and less than 3° C., the wireless power transmission device 2000 may determine the next communication interval to be equal to the previous communication interval.

For example, in a case where the target heat retention temperature is 60° C., and the previous communication interval is 300 seconds, when the first temperature of contents is 55° C., the wireless power transmission device 2000 may determine 270 seconds to be the next communication interval which is decreased by 10%, compared to the previous communication interval.

In operation S3305, the wireless power transmission device 2000 may determine whether a temperature of contents is equal to or greater than the target heat retention temperature. For example, while the wireless power transmission device 2000 is connected with the cooking appliance 1000 for communication, the wireless power transmission device 2000 may determine whether a temperature of contents is equal to or greater than the target heat retention temperature, based on information about a temperature of contents which is periodically received.

In operation S3306, when a temperature of contents is equal to or greater than the target heat retention temperature, the wireless power transmission device 2000 may suspend transmission of the first power.

According to an embodiment of the present disclosure, when a temperature of contents increases by the first power transmitted from the wireless power transmission device 2000 and then becomes the target heat retention temperature or higher, wireless power transmission device 2000 may suspend transmission of the first power so as to allow a temperature of contents not to be higher than a threshold range (e.g., ±3) of the target heat retention temperature. When the wireless power transmission device 2000 suspends transmission of the first power, a temperature of contents in the cooking appliance 1000 may slowly decrease.

In operation S3307, communication between the wireless power transmission device 2000 and the cooking appliance 1000 may be disconnected. When the wireless power transmission device 2000 suspends transmission of the first power, an operation of the communication interface 1030 of the cooking appliance 1000 is stopped, and thus, communication between the wireless power transmission device 2000 and the cooking appliance 1000 may be disconnected.

Even when communication connection with the cooking appliance 1000 is suspended, the wireless power transmission device 2000 may perform a pan detection operation. The wireless power transmission device 2000 may adjust a pan detection interval, based on the difference between the first temperature of contents measured in a wake-up time and the target heat retention temperature.

A time in which power is transmitted for pan detection is about 60 ms, which may be insufficient for a communication connection. Therefore, even when the wireless power transmission device 2000 performs the pan detection operation, a communication connection between the wireless power transmission device 2000 and the cooking appliance 1000 may be in a suspension state.

In operation S3308, the wireless power transmission device 2000 may determine whether a wake-up time corresponding to the communication interval has come. When the wake-up time corresponding to the communication interval has not come, the wireless power transmission device 2000 may maintain suspension of transmission of the first power, and may periodically perform the pan detection operation.

In operation S3309, when the wake-up time has come, the wireless power transmission device 2000 may determine whether a heat retention end condition is satisfied. Here, the heat retention mode end condition may include at least one of an expiry of a heat retention time input by a user, an expiry of a default-set heat retention time, a case in which it is determined that contents are not present in the cooking appliance 1000, and a case in which it is determined that the cooking appliance 1000 leaves a cooking zone, but the present disclosure is not limited thereto.

In operation S3310, when the heat retention mode end condition is satisfied, the wireless power transmission device 2000 may end the heat retention mode.

According to an embodiment of the present disclosure, the wireless power transmission device 2000 may delete information stored in associated with the heat retention mode, from the memory 2600. For example, the unique identification information of the cooking appliance 1000 which is stored in associated with the heat retention mode may be deleted.

According to an embodiment of the present disclosure, when the wireless power transmission device 2000 ends the heat retention mode, the wireless power transmission device 2000 may shortly transmit the first power for driving the communication interface 1030 of the cooking appliance 1000 so as to activate the communication interface 1030, and then may transmit information indicating to end the heat retention mode to the cooking appliance 1000. When the wireless power transmission device 2000 has transmitted the information indicating to end the heat retention mode to the cooking appliance 1000, the wireless power transmission device 2000 may suspend transmission of the first power and may operate in a standby mode.

As operation S3310 corresponds to operation S2812 of FIG. 28, redundant descriptions are not provided here.

In operation S3311, when the heat retention mode end condition is not satisfied, as the wake-up time has come, the wireless power transmission device 2000 may transmit the first power. In operation S3312, when the cooking appliance 1000 receives the first power from the wireless power transmission device 2000 via the pickup coil 1001, the cooking appliance 1000 may activate the communication interface 1030.

In operation S3313, the cooking appliance 1000 and the wireless power transmission device 2000 may be re-connected for transmission.

According to an embodiment of the present disclosure, the wireless power transmission device 2000 may appropriately determine the communication interval and the pan detection interval, thereby allowing a temperature of contents to be maintained within the threshold range of the target heat retention temperature.

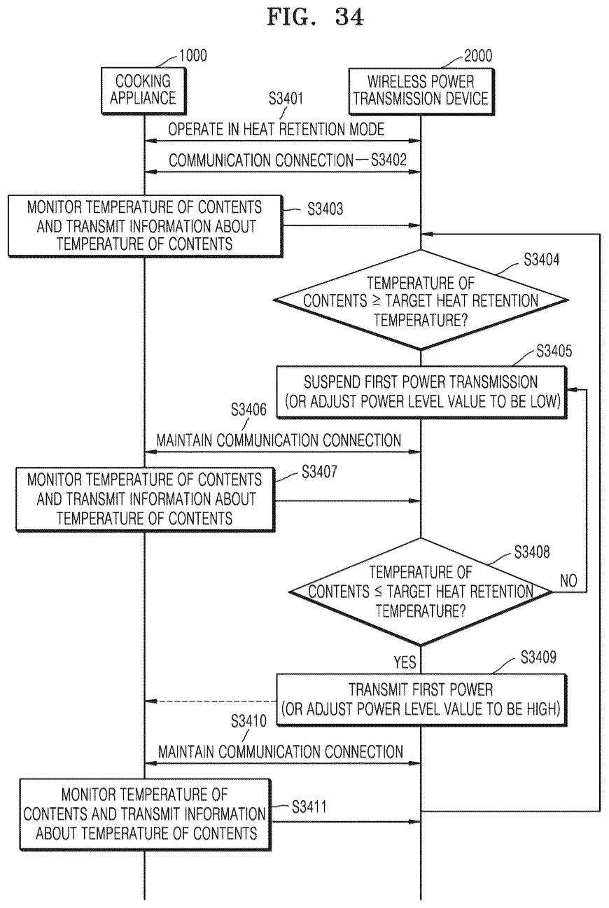

FIG. 34 is a flowchart for describing a method by which the wireless power transmission device 2000 adjusts power transmission to the cooking appliance 1000 including a battery, based on a temperature of contents and a target heat retention temperature, according to an embodiment of the present disclosure.

In operation S3401, the cooking appliance 1000 and the wireless power transmission device 2000 may operate in a heat retention mode. As operation S3401 corresponds to operation S3301 of FIG. 33, redundant descriptions are not provided here.

In operation S3402, the cooking appliance 1000 and the wireless power transmission device 2000 may be connected for communication. For example, when the wireless power transmission device 2000 transmits first power for driving the PCB 1005 of the cooking appliance 1000, the cooking appliance 1000 may establish a short-range wireless communication channel (e.g., a BLE communication channel) with the wireless power transmission device 2000.

In operation S3403, the cooking appliance 1000 may monitor a temperature of contents, and may transmit information about the temperature of contents to the wireless power transmission device 2000. For example, when the first power is supplied, the cooking appliance 1000 may monitor a temperature of contents via the first temperature sensor 1006, and may periodically transmit information about the temperature of contents to the wireless power transmission device 2000.

In operation S3404, the wireless power transmission device 2000 may determine whether a temperature of contents is equal to or greater than the target heat retention temperature. For example, the wireless power transmission device 2000 may determine whether a temperature of contents is equal to or greater than the target heat retention temperature, based on information about a temperature of contents which is periodically received.

In operation S3405, when a temperature of contents is equal to or greater than the target heat retention temperature, the wireless power transmission device 2000 may suspend transmission of the first power. Alternatively, the wireless power transmission device 2000 may adjust a power level value of the first power to be sufficiently low, so that contents in the cooking appliance 1000 are not inductively heated.

According to an embodiment of the present disclosure, when a temperature of contents increases by the first power transmitted from the wireless power transmission device 2000 and then becomes the target heat retention temperature or higher, the wireless power transmission device 2000 may adjust suspension (or adjust the power level value of the first power to be low) of first power transmission so as to allow a temperature of contents not to be higher than a threshold range (e.g., ±3) of the target heat retention temperature. When the wireless power transmission device 2000 suspends (or adjusts the power level value of the first power to be low) transmission of the first power, a temperature of contents in the cooking appliance 1000 may slowly decrease.

In operation S3406, even when the first power is not supplied from the wireless power transmission device 2000, the cooking appliance 1000 and the wireless power transmission device 2000 may maintain a communication connection. According to an embodiment of the present disclosure, when the first power is not supplied from the wireless power transmission device 2000, the cooking appliance 1000 may drive the controller 1020 and the communication interface 1030 by using power of the battery. Therefore, a communication connection between the cooking appliance 1000 and the wireless power transmission device 2000 may be maintained.

In operation S3407, even when supply of the first power is suspended, the cooking appliance 1000 may drive the controller 1020 and the communication interface 1030 by using power of the battery, and thus, is capable of monitoring a temperature of contents and transmitting information about contents to the wireless power transmission device 2000.

In operation S3408, the wireless power transmission device 2000 may determine whether a temperature of contents is equal to or less than a threshold heat retention temperature. The threshold heat retention temperature may indicate a lowest temperature of a threshold range of the target heat retention temperature. For example, when the target heat retention temperature is 60° C., and the threshold range is 3° C., the threshold heat retention temperature may be 57° C.

According to an embodiment of the present disclosure, when a temperature of contents is greater than the threshold heat retention temperature, the wireless power transmission device 2000 may maintain suspension of first power transmission.

In operation S3409, when the temperature of contents is equal to or less than the threshold heat retention temperature, the wireless power transmission device 2000 may supply again the first power to the cooking appliance 1000. Alternatively, when the power level value of the first power has been adjusted to be low, the wireless power transmission device 2000 may adjust the power level value of the first power to be high again.

In operation S3410, the cooking appliance 1000 and the wireless power transmission device 2000 may maintain a communication connection.

For example, when the wireless power transmission device 2000 re-supplies the first power, the cooking appliance 1000 may drive the communication interface 1030 by the first power received via the pickup coil 1001. Then, the cooking appliance 1000 may charge the battery by the first power received via the pickup coil 1001.

In operation S3411, the cooking appliance 1000 may monitor a temperature of contents via the first temperature sensor 1006, and may transmit information about the temperature of contents to the wireless power transmission device 2000. Back to operation S3404, the wireless power transmission device 2000 may monitor a temperature of contents until the temperature of contents reaches the target heat retention temperature. When the temperature of contents is equal to or greater than the target heat retention temperature, the wireless power transmission device 2000 may suspend again transmission of the first power.

According to an embodiment of the present disclosure, when the cooking appliance 1000 includes the battery, the cooking appliance 1000 may maintain the communication connection by using power of the battery in a section in which power supply from the wireless power transmission device 2000 is suspended. In this regard, the wireless power transmission device 2000 may periodically receive information about a temperature of contents from the cooking appliance 1000 via short-range wireless connection. Therefore, the wireless power transmission device 2000 may adjust whether to transmit the first power for inductively heating contents and the power level value of the first power, based on the temperature of contents, thereby allowing the temperature of contents to be maintained within a threshold range of a target heating temperature.

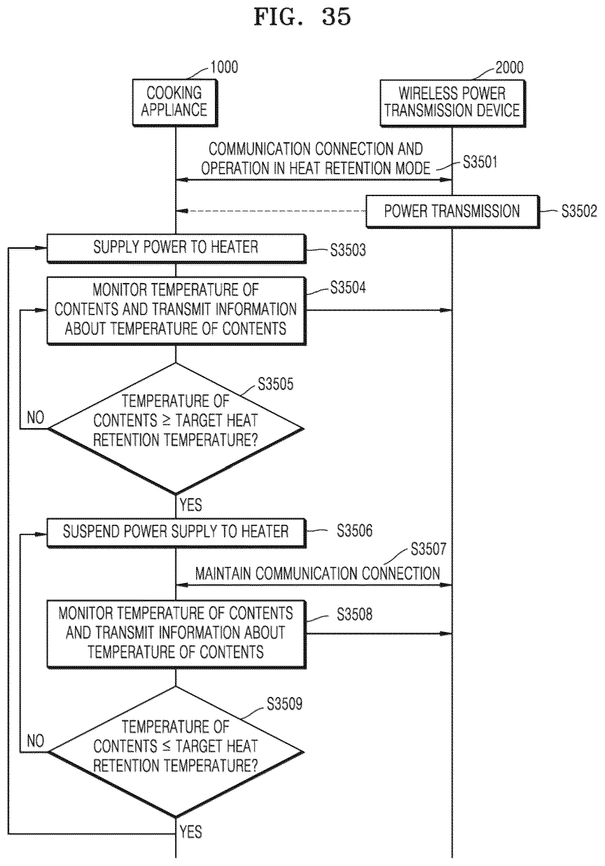

FIG. 35 is a flowchart for describing a method by which the cooking appliance 1000 adjusts power supply to a heater, according to an embodiment of the present disclosure.

In operation S3501, the cooking appliance 1000 and the wireless power transmission device 2000 may perform a communication connection and may operate in a heat retention mode.

The cooking appliance 1000 and the wireless power transmission device 2000 may be connected for communication. For example, when the wireless power transmission device 2000 transmits first power for driving the PCB 1005 of the cooking appliance 1000, the cooking appliance 1000 may establish a short-range wireless communication channel (e.g., a BLE communication channel) with the wireless power transmission device 2000.

According to an embodiment of the present disclosure, when the wireless power transmission device 2000 receives an input of a heat retention request for the cooking appliance 1000 from a user via the user interface 2500, the wireless power transmission device 2000 may transmit heat retention request information to the cooking appliance 1000 via short-range wireless communication (e.g., BLE communication). The cooking appliance 1000 may receive the heat retention request information including a target heat retention temperature selected by the user, from the wireless power transmission device 2000.

According to an embodiment of the present disclosure, when the cooking appliance 1000 receives the heat retention request information from the wireless power transmission device 2000, the cooking appliance 1000 may switch an operation mode of the cooking appliance 1000 to the heat retention mode. The cooking appliance 1000 may store, in the memory, information (e.g., a heat retention flag) indicating that the operation mode of the cooking appliance 1000 is the heat retention mode. In this regard, the wireless power transmission device 2000 may also operate in the heat retention mode, and may store mapping information with respect to unique identification information of the cooking appliance 1000 and the heat retention mode, in the memory 2600.

In operation S3502, the wireless power transmission device 2000 may transmit, to the cooking appliance 1000, power for inductively heating contents. The communication interface 1030 of the cooking appliance 1000 may maintain an activated state by the power received from the wireless power transmission device 2000.

In operation S3503, the cooking appliance 1000 may receive the power via the reception coil 1003, and may supply the received power to a heater. For example, the controller 1020 of the cooking appliance 1000 may turn on a switch configured to supply power to the heater. At this time, contents in the cooking appliance 1000 may be heated.

In operation S3504, the cooking appliance 1000 may monitor a temperature of contents via the first temperature sensor 1006, and may transmit information about the temperature of contents to the wireless power transmission device 2000.

In operation S3505, the cooking appliance 1000 may determine whether the temperature of contents is equal to or greater than a target heat retention temperature. The cooking appliance 1000 may determine whether the temperature of contents is equal to or greater than the target heat retention temperature, based on the temperature of contents which is measured via the first temperature sensor 1006.

When the temperature of contents is less than the target heat retention temperature, the cooking appliance 1000 may periodically measure a temperature of contents via the first temperature sensor 1006, and may transmit information about the temperature of contents to the wireless power transmission device 2000.

In operation S3506, when the temperature of contents is equal to or greater than the target heat retention temperature, the cooking appliance 1000 may suspend power supply to the heater.

According to an embodiment of the present disclosure, in order to prevent a temperature of contents from exceeding a threshold range of the target heat retention temperature and being overheated, when the temperature of contents reaches the target heat retention temperature, the cooking appliance 1000 may suspend power supply to the heater. For example, the cooking appliance 1000 may turn off the switch supplying power to the heater.

In operation S3507, even when the cooking appliance 1000 suspends power supply to the heater, the cooking appliance 1000 may maintain a communication connection with the wireless power transmission device 2000.

As power supply from the wireless power transmission device 2000 is not suspended, the communication interface 1030 of the cooking appliance 1000 may maintain an activated state.

In operation S3507, the cooking appliance 1000 may monitor a temperature of contents, and may transmit information about the temperature of contents to the wireless power transmission device 2000. As power supply to the heater is suspended, a temperature of contents may slowly decrease.

As power supply from the wireless power transmission device 2000 is not suspended, the controller 1020 and the communication interface 1030 of the cooking appliance 1000 may maintain an activated state. Therefore, the controller 1020 of the cooking appliance 1000 may monitor a temperature of contents via the first temperature sensor 1006, and may transmit information about the temperature of contents to the wireless power transmission device 2000 via the communication interface 1030.

In operation S3508, the cooking appliance 1000 may determine whether a temperature of contents is equal to or less than a threshold heat retention temperature. The threshold heat retention temperature may indicate a lowest temperature of a threshold range of the target heat retention temperature. For example, when the target heat retention temperature is 60° C., and the threshold range is 3° C., the threshold heat retention temperature may be 57° C.

According to an embodiment of the present disclosure, when the temperature of contents is greater than the threshold heat retention temperature, the cooking appliance 1000 may maintain suspension of power supply to the heater.

According to an embodiment of the present disclosure, when the temperature of contents is equal to or less than the threshold heat retention temperature, the cooking appliance 1000 may return to operation S3503 and may re-supply power to the heater. In this case, a temperature of contents in the cooking appliance 1000 may re-increase.

According to an embodiment of the present disclosure, when the cooking appliance 1000 is a small appliance including a heater, and the wireless power transmission device 2000 continuously supplies power (e.g., 200 W) to the cooking appliance 1000, the cooking appliance 1000 may control power supply to the heater, thereby allowing a temperature of contents to be maintained within the threshold range of the target heat retention temperature.

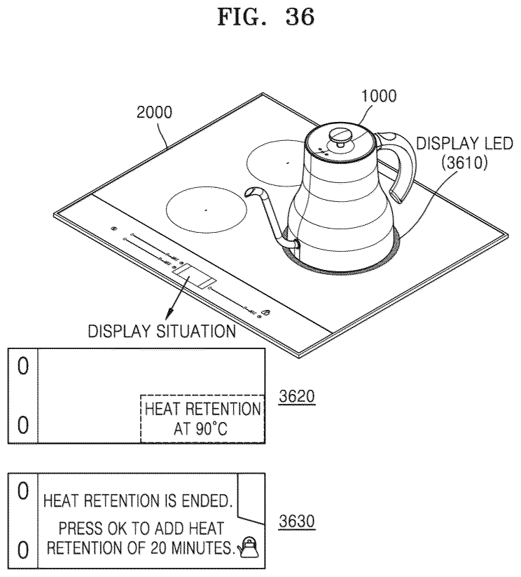

FIG. 36 is a diagram for describing an operation in which the wireless power transmission device 2000 outputs information related to the cooking appliance 1000, according to an embodiment of the present disclosure.

Referring to 3610 of FIG. 36, while the wireless power transmission device 2000 operates in a heating mode or a heat retention mode, the wireless power transmission device 2000 may display a color or a flickering pattern indicating an operation state of the cooking appliance 1000, via an LED display provided around the working coil 2120. For example, when the wireless power transmission device 2000 operates in the heating mode for heating contents in the cooking appliance 1000, the wireless power transmission device 2000 may display a first color (e.g., an orange color) corresponding to the heating mode or a first flickering pattern (e.g., flickering at intervals of 0.1 second). On the other hand, when the wireless power transmission device 2000 operates in the heat retention mode for maintaining contents in the cooking appliance 1000 at a constant temperature (target heat retention temperature), the wireless power transmission device 2000 may display a second color (e.g., a green color) corresponding to the heating mode or a second flickering pattern (e.g., flickering at intervals of 2 seconds).

According to an embodiment of the present disclosure, the wireless power transmission device 2000 operating in the heat retention mode may display different colors or different flickering patterns for cases when a communication connection between the cooking appliance 1000 and the wireless power transmission device 2000 is maintained and when the communication connection between the cooking appliance 1000 and the wireless power transmission device 2000 is disconnected. For example, when the communication connection between the cooking appliance 1000 and the wireless power transmission device 2000 is maintained, all LEDs around the working coil 2120 are flickering with a green color, and when the communication connection between the cooking appliance 1000 and the wireless power transmission device 2000 is disconnected, only some of the LEDs around the working coil 2120 are flickering with the green color.

Referring to 3620 of FIG. 36, the wireless power transmission device 2000 may output a notification indicating that the cooking appliance 1000 operates in the heat retention mode. For example, when the cooking appliance 1000 operates in the heat retention mode in a right cooking zone, the wireless power transmission device 2000 may display information indicating “heat retention at 90° C.” at a position of the display which corresponds to the right cooking zone.

Referring to 3630 of FIG. 36, when a heat retention time input by a user or a default-set heat retention time expires, the wireless power transmission device 2000 may output a notification (e.g., Heat retention is ended.) indicating that heat retention is ended. Also, the wireless power transmission device 2000 may output a message asking whether to maintain the heat retention mode. For example, the wireless power transmission device 2000 may output a message indicating “Press OK to add heat retention of 20 minutes”. When the user checks the message and selects an OK button, a heat retention time may be extended.

FIG. 37 is a diagram for describing an operation in which the cooking appliance 1000 and the wireless power transmission device 2000 interoperate with the server device 3000, according to an embodiment of the present disclosure.

Referring to FIG. 37, the cooking system 100 according to an embodiment of the present disclosure may further include the server device 3000 and the user terminal 4000, in addition to the cooking appliance 1000 and the wireless power transmission device 2000. As the cooking system 100 including the cooking appliance 1000 and the wireless power transmission device 2000 is described with reference to FIG. 1, the server device 3000 and the user terminal 4000 will now be described herein.

According to an embodiment of the present disclosure, the server device 3000 may include a communication interface configured to perform communication with an external device. The server device 3000 may perform communication with the cooking appliance 1000, the wireless power transmission device 2000, or the user terminal 4000 via the communication interface. According to an embodiment of the present disclosure, the cooking appliance 1000 may transmit identification information of the cooking appliance 1000 or identification information (log-in information, account information) of a user to the server device 3000, and may be authenticated, by the server device 3000, with respect to the identification information of the cooking appliance 1000 or the identification information (log-in information, account information) of the user, thereby accessing the server device 3000. Also, the wireless power transmission device 2000 may transmit identification information of the wireless power transmission device 2000 or identification information (log-in information, account information) of a user to the server device 3000, and may be authenticated, by the server device 3000, with respect to the identification information of the wireless power transmission device 2000 or the identification information (log-in information, account information) of the user, thereby accessing the server device 3000.

According to an embodiment of the present disclosure, the server device 3000 may include an AI processor. The AI processor may generate an artificial intelligence model by training an artificial intelligence network. “Training” the artificial intelligence network may indicate that a mathematical model by which neurons constituting the artificial intelligence network can perform optimal decision making is generated while appropriately changing weights, based on data.

The user terminal 4000 according to an embodiment of the present disclosure may be a device connected to the server device 3000 so as to display information provided from the server device 3000. According to an embodiment of the present disclosure, the user terminal 4000 may transmit and receive information to and from the server device 3000 via a particular application (e.g., a home appliance management application) installed in the user terminal 4000.

According to an embodiment of the present disclosure, the user terminal 4000 may be a device connected with the cooking appliance 1000 and the wireless power transmission device 2000 with the same account information. The user terminal 4000 may be directly connected with the cooking appliance 1000 and the wireless power transmission device 2000 via a short-range wireless communication channel, or may be indirectly connected with the cooking appliance 1000 and the wireless power transmission device 2000 via the server device 3000.

According to an embodiment of the present disclosure, the user terminal 4000 may be implemented in various forms. For example, the user terminal 4000 described in the present disclosure may include a mobile terminal, a refrigerator including a display, a TV, a computer, or an oven including a display, but the present disclosure is not limited thereto. Also, the mobile terminal may include a smartphone, a laptop computer, a tablet personal computer (PC), a digital camera, an E-book terminal, a digital broadcasting terminal, a personal digital assistant (PDA), a portable multimedia player (PMP), a navigation device, or an MP3 player, but the present disclosure is not limited thereto. For example, the mobile terminal may include a wearable device that may be worn by a user. Hereinafter, for convenience of descriptions, a case in which the user terminal 4000 is a smartphone is described as an example.

According to an embodiment of the present disclosure, the user terminal 4000 or the wireless power transmission device 2000 may receive a speech signal, which is an analog signal, through a microphone and may convert a speech part into computer-readable text by using an ASR model. The user terminal 4000 or the wireless power transmission device 2000 may obtain a user's intention to speak by interpreting the converted text by using an NLU model. In this case, the ASR model or the NLU model may be an AI model. The AI model may be processed by an AI-dedicated processor designed in a hardware structure specialized for processing the AI model. The AI model may be generated through learning. According to the present disclosure, such learning may be achieved by a device itself (e.g., the user terminal 4000 or the wireless power transmission device 2000) on which AI is performed, or may be achieved through a separate server device 3000 and/or a separate system. Examples of learning algorithms include supervised learning, unsupervised learning, semi-supervised learning, or reinforcement learning, but the present disclosure is not limited to the aforementioned examples.

The AI model may include a plurality of neural network layers. Each of the plurality of neural network layers has a plurality of weight values, and may perform a neural network operation by using an operation result of a previous layer and an operation between the plurality of weight values. The plurality of weight values of the plurality of neural network layers may be optimized based on a learning result of the AI model. For example, the plurality of weight values may be updated to reduce or minimize a loss value or a cost value obtained from the AI model during a learning process. The artificial neural network may include, for example, a deep neural network (DNN), e.g., a convolutional neural network (CNN), a deep neural network (DNN), a recurrent neural network (RNN), a restricted Boltzmann machine (RBM), a deep belief network (DBM), a bidirectional recurrent deep neural network (BRDNN), or deep Q-networks, but the present disclosure is not limited to the aforementioned examples.

According to an embodiment of the present disclosure, the user terminal 4000 may execute, based on a user input, a specific application (e.g., a home appliance management application) provided from the server device 3000. In this case, the user may identify an operation state of the wireless power transmission device 2000 and an operation state of the cooking appliance 1000 via an application execution window.

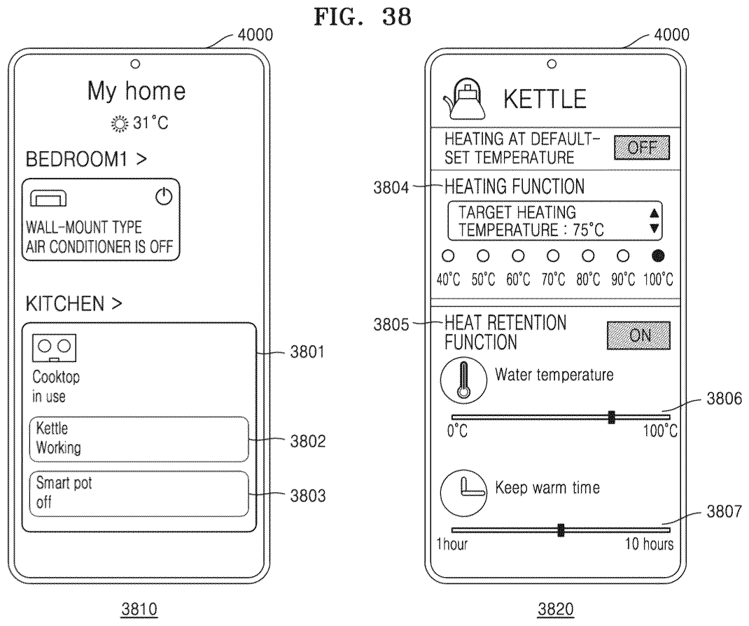

FIG. 38 is a diagram for describing an operation in which the server device 3000 provides information about the cooking appliance 1000 via the user terminal 4000, according to an embodiment of the present disclosure.

When a user executes an application for managing the user's home appliances on the user terminal 4000, the user terminal 4000 may receive information from the server device 3000 and display a list of home appliances on an application execution window. The user's home appliances may be registered in the server device 3000 with the same account. The home appliances may include the cooking appliance 1000 and the wireless power transmission device 2000.

FIG. 38 will now be described with an example in which the wireless power transmission device 2000 (cooktop), the kettle 1000a, and the smart pot 1000b are registered in the server device 3000, and the kettle 1000a operates on the wireless power transmission device 2000 (cooktop).

Referring to a screen 3810 of FIG. 38, the user terminal 4000 may display, on an application execution screen, a first GUI 3801 indicating the wireless power transmission device 2000 (cooktop), a second GUI 3802 indicating the kettle 1000a, and a third GUI 3803 indicating the smart pot 1000b. In this regard, the first GUI 3801 may include a state (e.g., during an operation, etc.) of the wireless power transmission device 2000, the second GUI 3802 may include an operation state (e.g., working) of the kettle 1000a, and the third GUI 3803 may include an operation state (e.g., off) of the smart pot 1000b. Therefore, a user may easily identify an operation of the wireless power transmission device 2000 and/or the cooking appliance 1000 via the application execution screen.

According to an embodiment of the present disclosure, the user terminal 4000 may receive a user input of selecting the second GUI 3802 indicating the kettle 1000a.

Referring to a screen 3820 of FIG. 38, the user terminal 4000 may display, on the application execution screen, a setting screen related to the kettle 1000a, in response to the user input of selecting the second GUI 3802. For example, the user terminal 4000 may display a setting screen including a first field 3804 related to a heating function and a second field 3805 related to a heat retention function.

The first field 3804 may include a window for an input of a target heat retention temperature or a plurality of temperature icons (40° C., 50° C., 60° C., 70° C., 80° C., 90° C., 100° C.) for selecting the target heat retention temperature, but the present disclosure is not limited thereto. The user may directly input the target heat retention temperature to the window, or may set the target heat retention temperature by selecting one of the plurality of temperature icons.

According to an embodiment of the present disclosure, the user may activate (ON) the heat retention function of the cooking appliance 1000 via the second field 3805. Then, the user may set the heat retention and a heat retention time, on a second field 3805. For example, the user may move a location of an adjustment button on a first slide bar 3806, thereby setting the target heat retention temperature to 70° C. The user may set the heat retention time to 4 hours by moving a location of an adjustment button on a second slide bar 3807.

Information set by the user via the user terminal 4000 may be transmitted to the wireless power transmission device 2000 or the cooking appliance 1000 via the server device 3000.

According to an embodiment of the present disclosure, provided is the cooking appliance 1000 configured to appropriately maintain a temperature of contents according to a target heat retention temperature by controlling power transmission of the wireless power transmission device 2000.

According to an embodiment of the present disclosure, the cooking appliance configured to maintain heat retention of contents may include: the wireless power receiver 1100 configured to receive power transmitted from the wireless power transmission device 2000; the communication interface 1030 configured to communicate with the wireless power transmission device 2000; the first temperature sensor 1006 configured to measure a temperature of the contents; and at least one processor. The least one processor may be configured to, when entering a heat retention mode, compare the temperature of the contents measured via the first temperature sensor 1006 with a target heat retention temperature. The least one processor may be configured to, when the temperature of the contents is equal to or greater than the target heat retention temperature, transmit power control information to the wireless power transmission device 2000, the power control information indicating to suspend transmission of first power for driving the communication interface 1030 and then to re-transmit the first power for driving the communication interface 1030 after an elapse of a preset time.

According to an embodiment of the present disclosure, the at least one processor may be configured to receive heat retention request information from the wireless power transmission device 2000 via the communication interface 1030, the heat retention request information indicating that a heat retention request has been received from a user. The at least one processor may be configured to enter the heat retention mode, based on the received heat retention request information. The at least one processor may be configured to store, in the memory, information indicating that an operation mode of the cooking appliance 1000 is the heat retention mode.

The at least one processor may be configured to determine a first communication interval for communication with the wireless power transmission device 2000, based on at least one of an amount of the contents and the target heat retention temperature. The at least one processor may be configured to transmit first power control information to the wireless power transmission device 2000 via the communication interface 1030, the first power control information indicating to suspend transmission of the first power and then to re-transmit the first power in a first wake-up time corresponding to the determined first communication interval.

The at least one processor may be configured to determine the first communication interval to be short when the target heat retention temperature increases, and determine the first communication interval to be long when the target heat retention temperature decreases.

The at least one processor may be configured to determine the first communication interval to be long when the amount of the contents increases, and determine the first communication interval to be short when the amount of the contents decreases. The at least one processor may be configured to identify the amount of the contents, based on a temperature variation rate when the contents are heated;

The at least one processor may be configured to determine a pan detection interval for checking whether the cooking appliance is located on a top plate of the wireless power transmission device 2000 while transmission of the first power to the cooking appliance 1000 is suspended. The at least one processor may be configured to transmit the power control information including information of the determined pan detection interval to the wireless power transmission device 2000 via the communication interface 1030.

The at least one processor may be configured to determine a power level value of first power for driving the communication interface 1030. The at least one processor may be configured to transmit power control information including the power level value of first power to the wireless power transmission device 2000 via the communication interface 1030.

The at least one processor may be configured to transmit, to the wireless power transmission device 2000, information about the temperature of the contents which is measured via the first temperature sensor while the communication interface 1030 is driven.

The information about the temperature of the contents may include at least one of the amount of the contents, and a temperature change velocity of the contents, which are identified based on temperature data, temperature variation of the contents, and temperature variation of the contents due to heating.

The at least one processor may be configured to advertise variable identification information of the cooking appliance 1000 and unique identification information of the cooking appliance 1000 via the communication interface 1030, according to the first power being received from the wireless power transmission device 2000 in the first wake-up time. The variable identification information of the cooking appliance 1000 may include product type information of the cooking appliance 1000 and information indicating that a cooking zone in which the cooking appliance is currently located is unknown.

The at least one processor may be configured to transmit the variable identification information of the cooking appliance 1000 and the unique identification information of the cooking appliance 1000, and then identify a first power transmission pattern from among a plurality of different power transmission patterns transmitted from the wireless power transmission device 2000 via a plurality of cooking zones. The at least one processor may be configured to determine a first cooking zone as a current location of the cooking appliance 1000, the first cooking zone corresponding to the first power transmission pattern from among the plurality of cooking zones. The at least one processor may be configured to modify the variable identification information of the cooking appliance 1000 so as to include information about the first cooking zone. The at least one processor may be configured to transmit the modified variable identification information and the unique identification information of the cooking appliance 1000 to the wireless power transmission device 2000 via the communication interface 1030.

The at least one processor may be configured to compare a first temperature of the contents with the target heat retention temperature, the first temperature being measured in the first wake-up time according to the first power being received from the wireless power transmission device 2000.

The at least one processor may be configured to, when the first temperature of the contents is less than the target heat retention temperature, control the wireless power transmission device 2000 to maintain transmission of the first power from the wireless power transmission device 2000 until a current temperature of the contents reaches the target heat retention temperature.

The at least one processor may be configured to determine a power level value of the first power, based on a difference between the first temperature of the contents and the target heat retention temperature, the first temperature being measured in the first wake-up time. The at least one processor may be configured to control the wireless power transmission device 2000 to maintain transmission of the first power, by transmitting power control information including the power level value of the first power to the wireless power transmission device 2000.

The at least one processor may be configured to determine a second communication interval for communication with the wireless power transmission device 2000, based on the amount of the contents, the target heat retention temperature, and the difference between the first temperature of the contents and the target heat retention temperature. The at least one processor may be configured to transmit second power control information to the wireless power transmission device 2000 via the communication interface 1030, the second power control information indicating to suspend transmission of the first power when the current temperature of the contents reaches the target heat retention temperature and then to re-transmit the first power in a second wake-up time corresponding to the determined second communication interval.

The at least one processor may be configured to determine the second communication interval to be shorter than the first communication interval, when the difference between the first temperature and the target heat retention temperature of the contents is equal to or greater than a first threshold value. The at least one processor may be configured to determine the second communication interval to be longer than the first communication interval, when the difference between the first temperature and the target heat retention temperature of the contents is equal to or less than a second threshold value. The second threshold value may be less than the first communication interval.

The at least one processor may be configured to compare the first temperature of the contents with the target heat retention temperature, the first temperature being measured in the first wake-up time according to the first power being received from the wireless power transmission device 2000 in the first wake-up time. The at least one processor may be configured to adjust the pan detection interval, based on a result of the comparison between the first temperature of the contents and the target heat retention temperature. The at least one processor may be configured to, after an elapse of a preset time from the first wake-up time, transmit second power control information to the wireless power transmission device 2000 via the communication interface 1030, the second power control information including the determined pan detection interval and a second wake-up time for re-transmission of the first power.

The at least one processor may be configured to adjust the pan detection interval to be shorter, when the difference between the first temperature and the target heat retention temperature increases. The at least one processor may be configured to adjust the pan detection interval to be longer, when the difference between the first temperature and the target heat retention temperature decreases.

The at least one processor may be configured to receive information indicating to end the heat retention mode from the wireless power transmission device 2000 via the communication interface 1030, according to a heat retention end condition being satisfied. The at least one processor may be configured to end the heat retention mode by deleting, from the memory, the information indicating that the operation mode of the cooking appliance 1000 is the heat retention mode, according to the information indicating to end the heat retention mode.

The heat retention mode end condition may include at least one of an elapse of a heat retention time input by a user, an elapse of a default heat retention time, and a case in which contents are not present in the cooking appliance 1000.

When the communication interface 1030 is driven again, the least one processor may request the wireless power transmission device 2000 for information about an operation mode of the wireless power transmission device 2000. The at least one overvoltage may receive information about a current operation mode of the wireless power transmission device 2000 from the wireless power transmission device 2000 via the communication interface 1030. When the current operation mode of the wireless power transmission device 2000 is not the heat retention mode, the at least one processor may end the heat retention mode by deleting, from a memory, information indicating that an operation mode of the cooking appliance 1000 is the heat retention mode.

According to an embodiment of the present disclosure, a method of maintaining heat retention of the cooking appliance 1000 may include comparing a temperature of contents which is measured by the first temperature sensor 1006 with a target heat retention temperature, based on entering a heat retention mode; and transmitting, to the wireless power transmission device 2000, power control information indicating to suspend transmission of first power for driving the communication interface 1030 of the cooking appliance 1000 and then to transmit again the first power for driving the communication interface 1030 of the cooking appliance 1000 to the cooking appliance 1000 after an elapse of a preset time.

According to an embodiment of the present disclosure, the wireless power transmission device 2000 may include the communication interface 2300 configured to communicate with the cooking appliance 1000; the wireless power transmitter 2100 including a plurality of working coils corresponding to a plurality of cooking zones, and the inverter circuit 2113 configured to drive the plurality of working coils; and the at least one processor 2200. The at least one processor 2200 of the wireless power transmission device 2000 may determine a communication interval for communication with the cooking appliance 1000. When a temperature of contents which is received from the cooking appliance 1000 is equal to or greater than a target heat retention temperature, the at least one processor 2200 may control the inverter circuit 2113 to suspend transmission of the first power for driving the communication interface 1030 of the cooking appliance 1000. When a wake up time corresponding to the determined communication interval reaches, the at least one processor 2200 may control the inverter circuit 2113 to transmit again the first power to the cooking appliance 1000.

A machine-readable storage medium may be provided in the form of a non-transitory storage medium. In this regard, the term “non-transitory storage medium” merely means that the storage medium is a tangible device, and does not include a signal (e.g., an electromagnetic wave), and this term does not differentiate between a case where data is semi-permanently stored in the storage medium and a case where the data is temporarily stored in the storage medium. For example, the non-transitory storage medium may include a buffer in which data is temporarily stored.

According to an embodiment of the present disclosure, the method according to one or more embodiments disclosed in the present specification may be included and provided in a computer program product. The computer program product may be traded as a product between a seller and a buyer. The computer program product may be distributed in the form of a machine-readable storage medium (e.g., a compact disc read only memory (CD-ROM) or a universal serial bus (USB) flash drive), or be distributed (e.g., downloaded or uploaded) online via an application store, or between two user devices (e.g., smart phones) directly. For electronic distribution, at least a part of the computer program product (e.g., a downloadable app) may be temporarily generated or be at least temporarily stored in a machine-readable storage medium, e.g., a server of a manufacturer, a server of an application store, or a memory of a relay server.

What is claimed is:

1. A cooking appliance configured to maintain heat retention of contents, the cooking appliance comprising:
a wireless power receiver configured to receive power transmitted from a wireless power transmission device;
a communication interface configured to communicate with the wireless power transmission device;
a first temperature sensor configured to measure a temperature of the contents;
at least one memory storing one or more instructions; and
at least one processor configured to execute the one or more instructions, wherein the one or more instructions, when executed by the at least one processor, cause the cooking appliance to:
based on entering a heat retention mode, compare the temperature of the contents measured via the first temperature sensor with a target heat retention temperature, and
based on the temperature of the contents being equal to or greater than the target heat retention temperature, cause power control information to be transmitted to the wireless power transmission device, wherein the power control information is configured to cause the wireless power transmission device to suspend transmission of first power for driving the communication interface and to resume transmission of the first power after a preset time elapses.

2. The cooking appliance of claim 1, wherein the one or more instructions, when executed by the at least one processor, cause the cooking appliance to:
receive heat retention request information from the wireless power transmission device via the communication interface, wherein the heat retention request information indicates that a heat retention request has been received from a user,
enter the heat retention mode based on the received heat retention request information, and
store, in the at least one memory, information indicating that an operation mode of the cooking appliance is the heat retention mode.

3. The cooking appliance of claim 1, wherein the one or more instructions, when executed by the at least one processor, cause the cooking appliance to:
determine a first communication interval, for communication with the wireless power transmission device, based on at least one of an amount of the contents and the target heat retention temperature, and
transmit first power control information to the wireless power transmission device via the communication interface, wherein the first power control information causes the wireless power transmission device to suspend transmission of the first power and to resume transmission of the first power in a first wake-up time corresponding to the first communication interval.

4. The cooking appliance of claim 3,
wherein the one or more instructions, when executed by the at least one processor, cause the cooking appliance to:
determine the first communication interval to be a first duration when the target heat retention temperature increases, and
determine the first communication interval to be a second duration when the target heat retention temperature decreases, and
wherein the first duration is less than the second duration.

5. The cooking appliance of claim 3,
wherein the one or more instructions, when executed by the at least one processor, cause the cooking appliance to:
determine the first communication interval to be a first duration when the amount of the contents increases, and
determine the first communication interval to be a second duration when the amount of the contents decreases, and
wherein the first duration is greater than the second duration.

6. The cooking appliance of claim 3, wherein the one or more instructions, when executed by the at least one processor, cause the cooking appliance to:
identify the amount of the contents, based on a temperature variation rate when the contents are heated.

7. The cooking appliance of claim 3,
wherein the one or more instructions, when executed by the at least one processor, cause the cooking appliance to:
determine a pan detection interval for checking whether the cooking appliance is located on a top plate of the wireless power transmission device while transmission of the first power is suspended, and
wherein the power control information comprises the pan detection interval.

8. The cooking appliance of claim 1, wherein the one or more instructions, when executed by the at least one processor, cause the cooking appliance to:
transmit, to the wireless power transmission device, information about the temperature of the contents obtained via the first temperature sensor while the communication interface is driven.

9. The cooking appliance of claim 3,
wherein the one or more instructions, when executed by the at least one processor, cause the cooking appliance to:
based on the first power being received from the wireless power transmission device in the first wake-up time, advertise variable identification information of the cooking appliance and unique identification information of the cooking appliance via the communication interface,
wherein the variable identification information of the cooking appliance comprises product type information of the cooking appliance and information indicating that a cooking zone in which the cooking appliance is currently located is unknown.

10. The cooking appliance of claim 9, wherein the one or more instructions, when executed by the at least one processor, cause the cooking appliance to:
after advertising the variable identification information of the cooking appliance and the unique identification information of the cooking appliance, identify a first power transmission pattern from among a plurality of different power transmission patterns transmitted from the wireless power transmission device via a plurality of cooking zones,
determine a first cooking zone as a current location of the cooking appliance, wherein the first cooking zone corresponds to the first power transmission pattern,
modify the variable identification information of the cooking appliance so as to include information about the first cooking zone, and
transmit the modified variable identification information and the unique identification information of the cooking appliance to the wireless power transmission device via the communication interface.

11. The cooking appliance of claim 3, wherein the one or more instructions, when executed by the at least one processor, cause the cooking appliance to:
based on the first power being received from the wireless power transmission device, compare a first temperature of the contents with the target heat retention temperature, wherein the first temperature is measured by the first temperature sensor during the first wake-up time, and
based on the first temperature being less than the target heat retention temperature, control the wireless power transmission device to maintain transmission of the first power until a current temperature of the contents reaches the target heat retention temperature.

12. The cooking appliance of claim 3, wherein the one or more instructions, when executed by the at least one processor, cause the cooking appliance to:
determine a power level value of the first power based on a difference between a first temperature of the contents and the target heat retention temperature, wherein the first temperature is measured by the first temperature sensor during the first wake-up time, and
control the wireless power transmission device to maintain transmission of the first power, by transmitting second power control information comprising the power level value to the wireless power transmission device.

13. The cooking appliance of claim 3, wherein the one or more instructions, when executed by the at least one processor, cause the cooking appliance to:
determine a second communication interval for communication with the wireless power transmission device, based on the amount of the contents, the target heat retention temperature, and a difference between a first temperature of the contents and the target heat retention temperature, and
transmit second power control information to the wireless power transmission device via the communication interface, wherein the second power control information causes the wireless power transmission device to suspend transmission of the first power when a current temperature of the contents reaches the target heat retention temperature and to resume transmission of the first power in a second wake-up time corresponding to the second communication interval.

14. The cooking appliance of claim 7, wherein the one or more instructions, when executed by the at least one processor, cause the cooking appliance to:
based on the first power being received from the wireless power transmission device in the first wake-up time, compare a first temperature of the contents with the target heat retention temperature, wherein the first temperature is measured by the first temperature sensor during the first wake-up time,
adjust the pan detection interval based on a result of the comparison between the first temperature and the target heat retention temperature, and
after an elapse of a preset time from the first wake-up time, transmit second power control information to the wireless power transmission device via the communication interface, wherein the second power control information comprises the adjusted pan detection interval and a second wake-up time for re-transmission of the first power.

15. The cooking appliance of claim 2, wherein the one or more instructions, when executed by the at least one processor, cause the cooking appliance to:
based on a heat retention end condition being satisfied, receive information from the wireless power transmission device via the communication interface indicating to end the heat retention mode, and
based on receiving the information indicating to end the heat retention mode, end the heat retention mode by deleting, from the at least one memory, the information indicating that the operation mode of the cooking appliance is the heat retention mode.
